(19) United States
(12) Patent Application Publication
(10) Pub. No.: US 2026/0068914 A1
(43) Pub. Date: Mar. 12, 2026

(54) PROCESS FOR CONVERTING POMACE DERIVED FROM WINERIES INTO A FOOD INGREDIENT AND PRODUCT

(71) Applicant: CRUSH DYNAMICS INC., Summerland (CA)

(72) Inventors: GARY EDWARD STRACHAN, Summerland (CA); WILLIAM LESLIE BRODDY, Summerland (CA); MICHELLE CORDEIRO, Summerland (CA)

(21) Appl. No.: 19/110,065

(22) PCT Filed: Sep. 29, 2023
(86) PCT No.: PCT/CA2023/051300

§ 371 Date: Mar. 8, 2025

Related U.S. Application Data
(60) Provisional application No. 63/411,575, filed on Sep. 29, 2022.

(51) Int. Cl. A23L 19/00; A23B 2/733; A23G 1/48; A23L 27/00; A23L 27/12

(52) U.S. Cl. CPC A23L 19/09; A23B 2/733; A23G 1/48; A23L 27/12; A23L 27/86

(57) ABSTRACT

A process for converting pomace derived from the production of fruit wine into a nutrient-rich food product, and a product made by said process. The process comprises milling the pomace, carrying out an anaerobic ethanolic fermentation in an anaerobic fermenter by adding yeast and optionally sugars to produce ethanol; carrying out an aerobic acetic acid fermentation in an aerobic fermenter by adding acetic acid bacteria to produce acetic acid, shearing the acetic acid pomace to produce a raw puree; and further processing the raw puree into a puree or powder. The process can be used to produce a product that qualifies for Kosher certification. The nutrient-rich product can be used as an ingredient in foods as a flavour, texture and color enhancer, to mask bitter flavours or off-notes, as a preservative, to fortify processed foods.

### FIELD OF THE INVENTION

This disclosure pertains to the field of fermenting fruit wine derivatives into useful food products and/or food ingredients.

### SUMMARY

Described herein is a system and process for the bioconversion of pomace derived from wineries into a food ingredient, and a product made by the process. In some embodiments, the process renders a product that qualifies for Kosher certification. The pomace can come from a winery that makes fruit wines. These nutrient-rich products can be used as natural flavour, texture and color enhancers, in addition to nutritional ingredients to fortify processed foods and consumer recipes.

Disclosed herein is a process for converting pomace derived from fruit wine production into a nutrient-rich food product, comprising (a) receiving the pomace at a processing facility; (b) milling the pomace; (c) transferring the milled pomace into an anaerobic fermenter; (d) inoculating the milled pomace with yeast; (e) carrying out an ethanolic fermentation step in the anaerobic fermenter by fermenting sugars in the inoculated milled pomace under anaerobic conditions into ethanol; (f) transferring the ethanolic pomace into an aerobic fermenter; (g) inoculating the ethanolic pomace with acetic acid bacteria; (h) carrying out an acetic acid fermentation step in the aerobic fermenter by fermenting the inoculated ethanolic pomace under aerobic conditions into acetic acid; (i) shearing the acetic acid pomace to generate a raw puree; and (j) stabilizing the raw puree to generate a stabilized raw puree.

In some aspects, a wet processing step is applied to the stabilized the raw puree, involving fine grinding the stabilized raw puree according to desired specifications to generate a puree product.

In yet other aspects, a dry processing step is applied to the stabilized the raw puree, involving fine grinding the stabilized raw puree according to desired specifications; and drying the stabilized raw puree to a desired specification in order to generate a powder product.

In yet other aspects, the step of fine grinding involves grinding the stabilized raw puree to a particle size where 94%-100% of the particles of the stabilized raw puree pass through an 80-mesh screen.

In some aspects, the step of drying the stabilized raw puree is done by one or more of: freeze drying; spray drying; microwave vacuum drying; and immobilization onto a solid substrate.

In some aspects, the fruit wine is any one or more of: (grape wine; red wine; white wine; rose wine; champagne-style wine; sparkling wine; fortified wine; port; brandy; fruit wines; ciders; perry; and fruit brandy), and the type of fruit may be any one or more of: (grapes; berries; blackberry; elderberry; strawberry; blueberry; raspberry; red currant; black currant; white currant; cranberry; mulberry; seaberry; apples; pears; cherries; plums; pineapples; rose hips; lychee; bananas cantaloupe; watermelon; mango; pumpkins, pomegranates, pumpkin and honeydew).

Also disclosed herein is a process for extracting polyphenol compounds from pomace derived from fruit wine production, and incorporating such polyphenol compounds into a nutrient-rich food product, comprising (a) receiving the pomace at a processing facility; (b) milling the pomace; (c) transferring the milled pomace into an anaerobic fermenter; (d) inoculating the milled pomace with yeast; (e) carrying out an ethanolic fermentation step in the anaerobic fermenter by fermenting sugars in the inoculated milled pomace under anaerobic conditions into ethanol; (f) transferring the ethanolic pomace into an aerobic fermenter; (g) inoculating the ethanolic pomace with acetic acid bacteria; (h) carrying out an acetic acid fermentation step in the aerobic fermenter by fermenting the inoculated ethanolic pomace under aerobic conditions into acetic acid; (i) shearing the acetic acid pomace to generate a raw puree; and (j) stabilizing the raw puree to generate a stabilized raw puree.

In some aspects, a transport container is delivered to a winery to collect the pomace and transport it to the processing facility.

In some aspects, the pomace is washed until it is rendered Kosher.

In some aspects, the pomace is handled and processed at each step such that the nutrient-rich product qualifies for Kosher certification.

In some aspects, the milled pomace may be blended with milled pomace from other varietals before carrying out the ethanolic fermentation step.

In some aspects, the ethanolic pomace may be blended with ethanolic pomace from other varietals before carrying out the acetic acid fermentation step.

In yet other aspects, the acetic acid fermentation may be carried out until the acetic acid pomace reaches a titratable acidity of 2.2%-5%.

Also disclosed herein is a nutrient-rich food product produced by the foregoing processes.

Also disclosed herein is the use of the nutrient-rich food product as a natural flavour, texture and/or colour enhancer in food products.

In other aspect, the nutrient-rich food product may be used as a flavour enhancer in chocolate or other confectionery products, in order to allow for sugar reduction in recipes.

In other aspect, the nutrient-rich food product may be used as an ingredient for masking bitter flavours or off-notes in food products.

In other aspects, the nutrient-rich food product may be used as a preservative for meats, condiments, dairy products, cereal products or other foods.

In other aspects, the nutrient-rich food product may be used as an ingredient for fortifying processed foods.

In other aspects, the nutrient-rich food product may be used as an ingredient in food products, as a source of antioxidants.

Also disclosed herein is a nutrient-rich product derived from processing pomace derived from fruit wine production, for use as a ingredient in a food product, wherein incorporating the nutrient-rich product (in puree or powder form) in the amount of less than 5% by weight to the food product provides a plurality of cross-functional benefits in the food product selected from: flavor enhancement; masking of bitterness or off-notes; deep sodium reduction; significant sugar reduction; moisture and lipid binding; improved texture and mouthfeel; lipid oxidation prevention; and shelf-life extension.

### BACKGROUND

Presented below is background information regarding certain aspects of the present invention as they may relate to technical features referred to in the detailed description, but not necessarily described in detail. The subject matter discussed in this section should not be assumed to be prior art merely as a result of its mention in this section. Similarly, a problem mentioned in this section or associated with the subject matter provided as background should not be assumed to have been previously recognized in the prior art. That is, individual compositions or methods used in the present invention may be described in greater detail in the publications and patents discussed below, which may provide further guidance to those skilled in the art for making or using certain aspects of the present invention as claimed. The discussion below should not be construed as an admission as to the relevance or the prior art effect of the patents or publications described.

The application incorporates all documents referenced herein.

The winemaking industry produces millions of tons of leftovers and residues, which represent an ecological and economical waste management issue for the wineries. The leftovers and residues include organic wastes, inorganic wastes, wastewater, and emission of greenhouse gases (CO₂, volatile organic compounds, etc.) Due to growing issues around groundwater and soil contamination, wineries send most of it to the landfill or compost, costing the winery fees for bin drop-off, removal, haulage and tipping fees in addition to winery management costs. Addressing these issues in an appropriate manner places a financial burden on most of the wineries, especially the smaller ones.

The winemaking process generates two major residues, which can potentially be harvested. The major residues from the winemaking process after the de-stemming and crush steps are known as derivatives. Derivatives comprise grape pomace (pomace) and lees. For every two bottles of wine made, typically the equivalent of one bottle of derivatives is produced. Winery derivatives may comprise:
a) pomace consisting of grape skin, grape pulp and grape seed derived from varietal grapes, which have been crushed and pressed as part of the winemaking process; and
b) lees consisting mainly of spent wine yeast, tartaric acid, malic acid, lactic acid, grape skin pigment, and grape pulp sediment, which has been separated from the wine after fermentation and again after aging.

Grape pomace provides substantial nutritional potential for supplements and to fortify food. For example, 15 grams (˜1 tbsp.) of powdered derivative may contain up to 900 mg of phenols, 150 mg of tannins (catechin), 2000 mg of protein, 180 mg of potassium, 120 mg of magnesium, 4 mg of iron, 4% DV of riboflavin, 125% DV of vitamin E and 3% DV of vitamin K).

In general, wine lees is residue that forms at the bottom of wine containers consisting of: 1) first and second-fermentation lees, which are formed during the alcoholic and malolactic fermentations, respectively (herein, lees); 2) during storage or after treatments (herein, first-rack lees); and 3) aging wine lees formed during wine aging in wood barrels collected after the filtration or centrifugation of the wine (herein, second-rack lees), The main characteristics of wine lees are acidic pH (between 3 and 6), a chemical oxygen demand above 30,000 mg/L, potassium levels around 2500 mg/L, and phenolic compounds in amounts up to 1000 mg/L Approximately 30% of red wine lees is protein that is produced from yeast cell wall material, which contains 30-60% 3-b-D-glucan in dry weight.

Derivatives are sometimes used in livestock and poultry feed to extend the shelf-life of milk, nutrient-rich dairy by-products, and meat. There is extensive research on the anti-microbial benefits as a replacement for antibiotics for poultry and livestock. There is even research showing that it can cut bovine methane emissions by 30%

Although there is an identified market for these derivatives, the current processes used to transform it into shelf-stable nutrient-rich products creates a carbon footprint, is prohibitively expensive and causes significant loss in the quality in the derivatives.

The extraction of useful nutrient-rich products from wine derivatives is known in the art. However, most of these processes seek to isolate a specific compound, require multiple steps, and/or require drying the nutrient-rich product into a powder that can be easily sold in capsule, tablet, powder form, etc. Drying the nutrient-rich product and/or using chemical processes to isolate nutrient-rich products therefrom can diminish the bioavailability of the biomolecules desired in the final nutrient-rich products.

It is widely recognized that the nutrient value of foods has been diminishing since at least the 1950's, such that a need has developed for cost effective strategies to fortifying foods in the food supply, incorporating the resources of a winery to make adaptation easily accessible for the business.

There is tremendous potential value in monetizing these derivatives. One key issue today is economics; finding a cost-effective way to process derivatives in an ecological manner, without losing flavour and nutrition.

### BRIEF DESCRIPTION OF THE FIGURES

FIG. 1 is a flow diagram showing the steps of bio-converting fruit pomace derived from a winery into a packaged product, according to some embodiments.

FIG. 2 is a flow diagram, showing the steps of bio-converting fruit pomace derived from a winery into a packaged product, according to some embodiments.

FIG. 3A is process diagram, outlining the overall process steps, according to some embodiments.

FIG. 3B is diagram, indicating some of the parameters that are measured in the process of FIG. 3A.

FIG. 4 is a flow diagram, according some embodiments, showing the steps for pomace receipt and fermentation.

FIG. 5 is a process diagram, according to some embodiments, showing the steps for blending and maceration.

FIG. 6 is a process diagram, according to some embodiments, showing the steps for shearing, heat treatment and puree packaging.

FIG. 7 is a process diagram, according to some embodiments, showing the steps for drying, milling and powder packaging.

FIG. 8 is a process diagram, according to some embodiments, showing the steps for pomace receipt and fermentation for Kosher certification.

FIG. 9 is a process diagram, according to some embodiments, showing the steps for blending and maceration for Kosher certification.

FIG. 10 is a process diagram, according to some embodiments, showing the steps for shearing, heat treatment and puree packaging for Kosher certification.

FIG. 11 is a process diagram, according to some embodiments, showing the steps for drying, milling and powder packaging for Kosher certification.

FIG. 12 is a process diagram, according to some embodiments, outlining the raw material collection steps.

FIG. 13 is process diagram, according to some embodiments, outlining the raw material processing steps.

FIG. 14 is process diagram, according to some embodiments, illustrating the foregoing raw material processing steps in more detail.

FIG. 15 is process diagram, according to some embodiments, outlining the fermentation steps.

FIG. 16 is process diagram, according to some embodiments, outlining the blending steps.

FIG. 17 is process diagram, according to some embodiments, outlining the puree production steps.

FIG. 18 is process diagram, according to some embodiments, outlining the powder production steps.

FIG. 19 is a process diagram illustrating the puree and powder production steps, according to some embodiments.

FIGS. 20A, 20B and 20C are flow diagrams showing in more detail, the steps of bio-converting fruit pomace into a product, according to an embodiment.

FIGS. 21A, 21B and 21C are flow diagrams showing in more detail, the steps of bio-converting fruit pomace into a product with kosher certification, according to an embodiment.

FIGS. 22A, 22B and 22C are flow diagrams showing in more detail, the steps of bio-converting fruit pomace using a lactic acid fermentation step into a product with kosher certification, according to an embodiment

FIGS. 23A and 23B show the Specification Sheet of a White Grape Puree, according to an embodiment.

FIGS. 23C and 23D show the Specification Sheet of a second White Grape Puree, according to an embodiment.

FIGS. 24A and 24B show the Specification Sheet of a White Grape Powder, according to an embodiment.

FIGS. 25A and 25B show the Specification Sheet of a Red Grape Puree, according to an embodiment.

FIGS. 25C and 25D show the Specification Sheet of a second Red Grape Puree, according to an embodiment.

FIGS. 26A ad 26B show the Specification Sheet of a Red Grape Powder, according to an embodiment.

FIGS. 27A and 27B show the Certificate of Analysis for a White Grape Puree, according to an embodiment.

FIGS. 28A and 28B show the Certificate of Analysis for a Red Grape Puree, according to an embodiment.

FIG. 29 are tables showing the sensory results of certain puree blends.

FIG. 30 is a chart showing the antioxidant capacity of some of certain red grape/white grape powder blends.

FIG. 31A is a table showing (from a taste comparison test) the reduction (−30%) in required sugar for a chocolate spread, when a white grape puree blend is added (2%) to chocolate spread.

FIG. 31B is a table showing (from a taste comparison test) the reduction in required sugar/salt for a BBQ sauce, when a white grape puree/powder blend is added (2%) to a BBQ sauce.

FIG. 32 is a chart showing (from a panelist taste study) the reduction in required sodium for a patty, when a red grape puree blend is added.

FIG. 33 is a chart showing the polyphenol levels linked with antioxidant capacity.

FIG. 34 is a chart showing the improvements to Oxidative Stability Index for canola oil and soybean oil with the addition of a red grape puree blend.

FIG. 35 is a chart showing the sensory attributes comparison test, when a puree blend is added to a tomato olive pate.

FIG. 36 is a chart showing the sensory attributes comparison test, when a puree blend is added to a herb pate.

FIG. 37 is a chart showing the sensory attributes comparison test, when a puree blend is added to a chili garlic pate.

FIG. 38 is a chart showing the comparison of sensory attributes, when a red grape puree blend (2.5%) is added to a plant-based patty.

### DETAILED DESCRIPTION

All publications and patents mentioned herein are hereby incorporated herein by reference for the purpose of describing and disclosing, for example, the constructs and methodologies that are described in the publications which might be used in connection with the presently described invention. The publications discussed above and throughout the text are provided solely for their disclosure prior to the filing date of the present application. Nothing herein is to be construed as an admission that the inventors are not entitled to antedate such disclosure by virtue of prior invention.

The description set forth below in combination with the appended drawings is intended as a description of various embodiments of the described subject matter and is not necessarily intended to represent the only embodiment(s). In certain instances, the description includes specific details for the purpose of providing an understanding of the described subject matter. However, it will be apparent to those skilled in the art that embodiments may be practiced without these specific details. In some instances, structures and components may be shown in block diagram form in order to avoid obscuring the concepts of the described subject matter. Wherever possible, the same reference numbers will be used throughout the drawings to refer to the same or the like parts.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition is expressly set forth in the specification in a definitional manner that directly and unequivocally provides the special definition for the term or phrase.

The term comprising means “including but not limited to,” unless expressly specified otherwise. When used in the appended claims, in original and amended form, the term “comprising” is intended to be inclusive or open-ended and does not exclude any additional, unrecited element, method, step or material. The term “consisting of” excludes any element, step or material other than those specified in the claim. As used herein, “up to” includes zero, meaning no amount is added in some embodiments.

The term “about” generally refers to a range of numerical values (e.g., +/−1-3% of the recited value) that one of ordinary skill in the art would consider equivalent to the recited value (e.g., having the same function or result). In some instances, the term “about” includes the values disclosed and may include numerical values that are rounded to the nearest significant figure. Moreover, all numerical ranges herein should be understood to include all integer, whole or fractions, within the range recited.

It should be noted that, as used in the specification, appended claims and abstract, the singular forms “a,” “an,” and “the” include plural referents unless the context clearly dictates otherwise. That is, unless clearly specified otherwise, as used herein the words “a” and “an” and the like carry the meaning of “one or more” or “at least one.” The phrases “at least one.” “one or more,” “or,” and “and/or” are open-ended expressions that can be both conjunctive and disjunctive in operation. For example, each of the expressions “at least one of A, B and C.” “at least one of A, B, or C,” “one or more of A, B, and C,” “one or more of A, B, or C,” “A, B, and/or C,” and “A, B, or C” can mean A alone, B alone, C alone, A and B together, A and C together, B and C together, or A, B and C together. It is also to be noted that the terms “comprising.” “including,” and “having” can be used interchangeably.

Described herein is a system, methods and processes for converting winery derivatives into nutritionally beneficial food ingredients, products and/or supplements in an ecological manner, and various nutrient-rich products which are generated by such system, methods and processes. Integration of this system into a winery assists the winery to manage its previously-considered waste products in an ecological manner, which can optionally provide a novel revenue stream. The system, methods, and processes are used to convert winemaking derivatives into bioactive nutrient-rich products comprising antioxidants and other bioactive molecules that reside within the pomace and lees. These nutrient-rich products can be used as natural flavour, texture and color enhancers, in addition to nutritional ingredients to fortify processed foods and consumer recipes. They can also be used as health supplements.

It should be appreciated that the disclosed system, methods, and processes, and the resultant nutrient-rich products made thereby, could be adapted for wineries producing specific types of fruit wine, other than grape. In some embodiments, the system is integrated with a winery that produces fruit wine other than grape-based wine. In some embodiments, the system is integrated with a winery that produces both grape wine and other specific-type of fruit wine. In some embodiments, the system, processes, nutrient-rich products made thereby and use thereof include the derivatives produced by both the grape winemaking process and the non-grape fruit winemaking process. If a distinction is not made, descriptions pertaining to fruit winemaking are intended to include grape winemaking.

The term, “pomace” is used to denote pressed fruit residue, which may include stems, seeds, skins and some pulp.

### The Source of the Pomace

The term “fruit wine” as used herein generally refers to a natural fluid that is directly extracted or expressed from a fruit and then fermented so that some of the natural sugars in the juice are transformed into ethanol. Thus, the term “fruit wine” as used herein can refer to wine (i.e., grape wine, including red, white, rose, and champagne-style or sparkling wines), fortified wines (e.g., port or brandy), fruit wines, ciders, perry, or fruit brandy. Accordingly, the fruit wine can be fermented juice from fruit including, but not limited to, grapes, various berries (e.g., blackberry, elderberry, strawberry, blueberry, raspberry, currant (e.g., red currant, black currant, white currant), cranberry, mulberry, seaberry, etc.), apples, pears, cherries, plums, pineapples, rose hips, lychee, bananas cantaloupe, watermelon, mango and less traditional seasonal fruits, such as pumpkins, pomegranates, pumpkin, honeydew, among other sources not explicitly listed herein or combinations thereof. In some embodiments, the fermented fruit juice is wine. The present invention is generally illustrated and described herein as utilising pomace derived as a by-product from the production of grape wine; however, it should be appreciated that the disclosed invention may also utilise (or be adapted for) pomace derived as a by-product from the production of other fruit wines.

Grapes, botanically the berry which grows on the vines of the Vitis plant, are classified as red or white, but actually range in color from crimson, black, dark blue, yellow, green, orange, and pink. Grapes, which are referred to as white are actually green in color. Phenolic compounds such as anthocyanins and other pigments give rise to the varying shades of purple in red grapes; genetic mutations in the purple grape turn off the production of anthocyanins, resulting in the color of white grapes. Phenolic content of grape skin varies with the type of grape, the composition of the soil, climate, etc. Purple grapes have a higher total phenolic content than white grapes and the color is almost entirely due to the concentration of anthocyanins versus white grapes where the most abundant polyphenols are flavan-3-ols (i.e., catechins). The flesh of grapes from pale to color is dependent upon the anthocyanin content. Some grape seeds, such as muscadine contain about twice the amount of total polyphenol content as their skins.

A winemaker extracts the juice from grapes by crushing or pressing the berries during a process known as “crush”. As grape skin varies in color due to the varying composition of phenolic compounds (pigments, tannins, antioxidants, etc.) present in the different varieties of grapes, a winemaker will decide how long to leave the grape juice (juice) in the presence of the pressed grape material (skin, flesh and seeds) to extract phenolic compounds from the skins to impart color and flavor to the juice to be fermented. In general, red wines are made by fermenting the juice in the presence of pressed red grapes and white wines are made by fermenting the juice in the absence of pressed grapes, which can be either white or red grapes. For example, some champagnes are made by pressing Pinot noir grapes, which skins are deep red in color and the flesh lacks pigment, to make a sparkling white wine that is slightly colored. There are a number of variations, however, for making wines such as a rosé or an “orange wine,” where the winemaker will decide to ferment the juice in the presence of the pressed grape material for a limited amount of time in order to extract a relatively smaller proportion of the phenolic compounds. In some cases, a winemaker may add enzymes to assist in releasing some of the compounds from the grape material.

Once the juice (fermented, non-fermented or partially fermented) is separated from the pressed grape material, which is termed “pomace” (or marc), the pomace will range in color, from crimson to dark blue to yellow to pink, etc. The pomace will be transferred from the press/crush station to a transport container 702 for transport to a processing site/location.

### Commercial-Scale Bioconversion Process

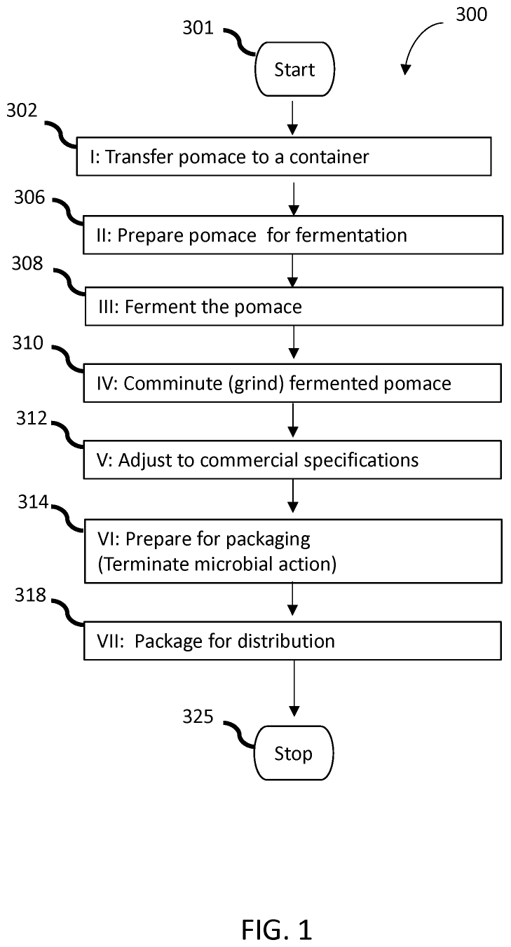

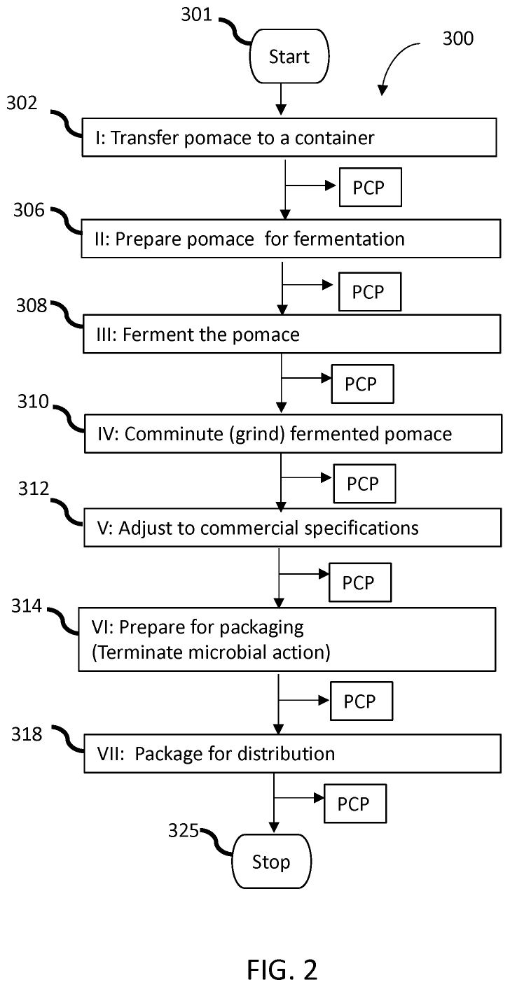

The General Process as described in FIGS. 1 and 2 describes steps that are performed in the conversion process, which may be applied to the pomace that results from fruit winemaking (e.g., grapes), according to some embodiments.

The General Process can be used to make a product which can be adjusted to result in a number of edible forms. As illustrated herein, the product may for example be in the form of a nutrient-rich puree or a powder. The product may be used in or incorporated into a number of food-related products (some examples of which are described herein). For example the product can be used as a: flavor enhancer, generally at about 5% (w/w); as a flavor and texture enhancer. In other use cases, the product can be used generally at about up to or less than approximately 50% (w/w) in meat and dairy analogues, sauces, breads, etc.; as a flavor and texture enhancer up to approximately 90% in some sauces; and as a confection up to approximately 100%, with the addition of sugar, which can be crystalized into a hard candy or combined with a gum such as pectin to make a gummy-candy (e.g., gummy bear).

According to some embodiments, an general overview of a bioconversion process for winery derivatives is provided and described in FIGS. 1 & 2. The general steps, which are described in greater detail below, are:
I: Transfer pomace to a container 302
II: Prepare pomace for fermentation 306
III: Ferment the pomace 308
IV: Comminute (grind) fermented pomace 310
V: Adjust to commercial specifications 312
VI: Prepare for packaging 314.
VII: Package for distribution 318

There are multiple options for the particular adjustments that can be made to the pomace as it is being converted throughout the process, wherein the objective is to transform a variable fruit biomass generated during the process of winemaking with an initial biochemical composition to a “final” product with a commercially specified biochemical composition (standardized output) in a stepwise targeted process optimized manner, in order to meet commercial specifications for a product, while maintaining appropriate sanitary conditions (e.g., cGMP)

The commercial-scale biotransformation process seeks to optimize the conversion of the biochemical composition of the winery-derived fruit pomace into the biochemical composition of the final product, in which the optimized process is designed to minimize the number of adjustments to the composition (to as few steps as possible). The objective of each step is to achieve the largest adjustments possible towards the final target composition, with the highest conversion efficiency possible, in each step, in order to minimize the cost of production (time, energy, risk management, waste, people resources, etc.).

In some embodiments, the objective is to achieve the largest adjustments early in the process, to attain an “intermediate” product, which can then be refined into a product that meets commercial specifications. In laymen's terms, in order to achieve a commercial-scale cost effective and high yield output, the design of the process is to front-load the efforts-so you don't have to back-load more effort, with loss of control and efficiency.

One critical distinction between small-scale and commercial-scale production entails the “granularity” of each biochemical analysis process. For example, the small-scale process generally might only measure a few variables such as pH and Brix, whereas the commercial-scale production uses a set of chemical and biochemical markers to have greater insight into the biochemical conversion at each stage. Moreover, adherence to high standards of quality control is emphasized. This point is emphasized in FIG. 2, which shows multiple process control points, (PCP)s, some of which include Prevention Control, such as testing for microbes, toxins, etc.

Another critical distinction between small-scale and commercial-scale production entails the management of risk of loss.

According to some embodiments, a commercial-scale process would be expected to have the following features/considerations:
Standardized ingredients/additives for use with the pomace
The generation and adherence to Standard Operating Procedures (SOP)
Regular testing throughout (e.g., PCP points)
Independence from fluctuations annual agricultural conditions (e.g. blending multiple sources of pomace)
Identify and control all the steps that can fail
Minimizing risk
Everything is documented and recorded, variation in results also documented (success, failure and error)
Documented in a manner that all the source ingredients are recorded (e.g., easy to identify a “bad input”)
Searchable records, for if/when a regulatory inspector wants to review records to determine compliance with regulatory standards-Extensive, organized and accessible documentation
Optimized processes-efficient and effective as possible.

In some embodiments, the process will be performed in a manner such that the final product can be certified as being Kosher.

### Commercial Scale Quality Analysis and Food Safety Processes

Quality Analysis can be conducted at any stage and/or step in the process as deemed appropriate. In general, at least the pH and the levels of acetic acid will be measured (if sensors are used, this can be more continuous monitoring). Additional points of analysis can include: in the headspace, ethanol and acetic acid could be monitored. Other parameters or categories of molecules that could be monitored; aldehydes, such as acetaldehyde; esters, such as ethyl acetate; pH; minerals, such as potassium, sodium, calcium, magnesium; microbial content, yeast, mold and bacteria content and possibly subsets thereof (not species—it will likely be general levels, not specific species, unless a commercial specification indicates a coliform test); organic acids, such as tartaric acid, malic acid, lactic acid and acetic acid. There can also be trace amounts of other organic acids.

The Global Food Safety Initiative (GFSI) provides a platform for collaboration between food safety experts associated with the food supply chain, international organizations, academia, and government. GFSI's work in benchmarking and harmonisation fosters mutual acceptance of GFSI-recognised certification programmes across the industry and enables a simplified “once certified, recognised everywhere approach. The GFSI Benchmarking process is now the most-widely recognised in the food industry worldwide.

SQFI is a division of the Food Industry Association (FMI). SQF is a GFSI recognized standard (benchmark) that commercial scale food manufacturers follow to ensure food safety. Details of procedures and processes can be found in SQF Food Safety Code: Food Manufacturing, Edition 9, 2020 and the SQF Quality Code, Edition 9, edition 2020.

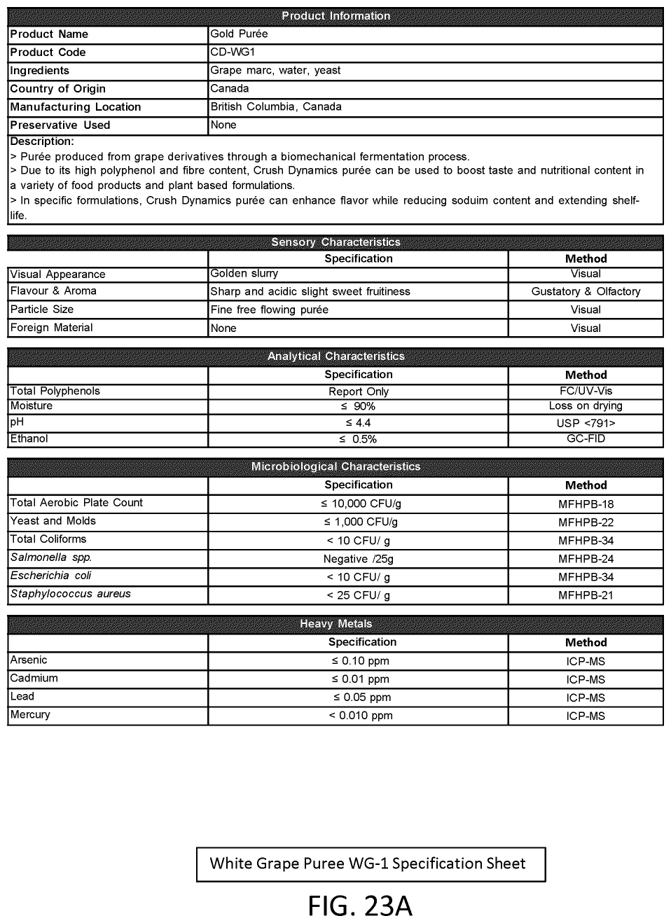

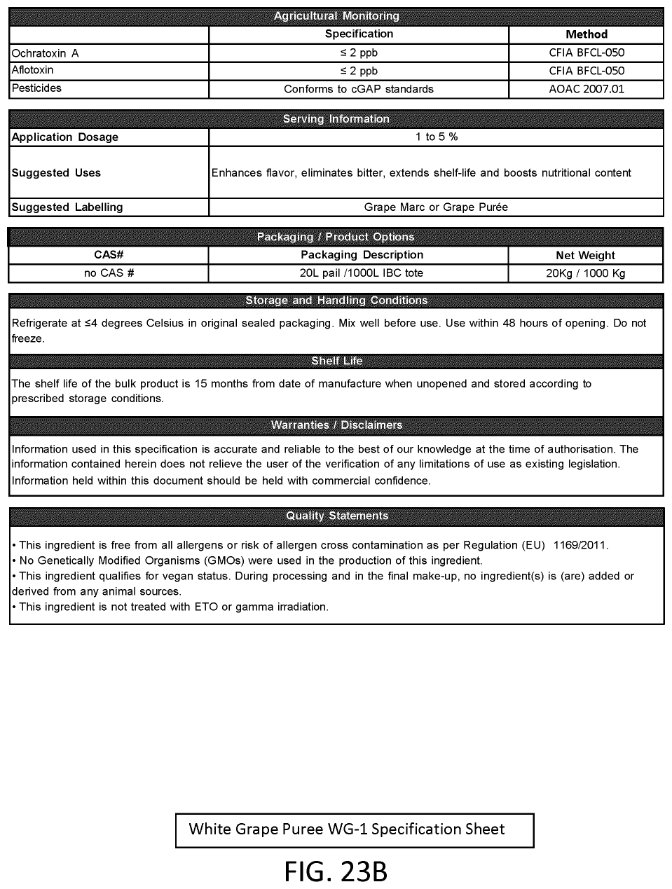

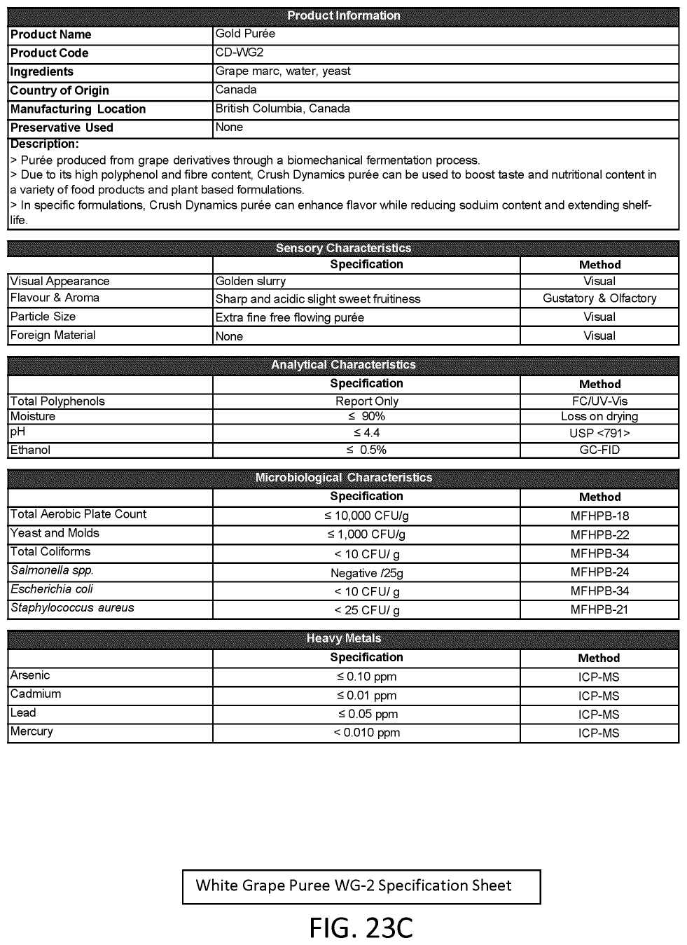

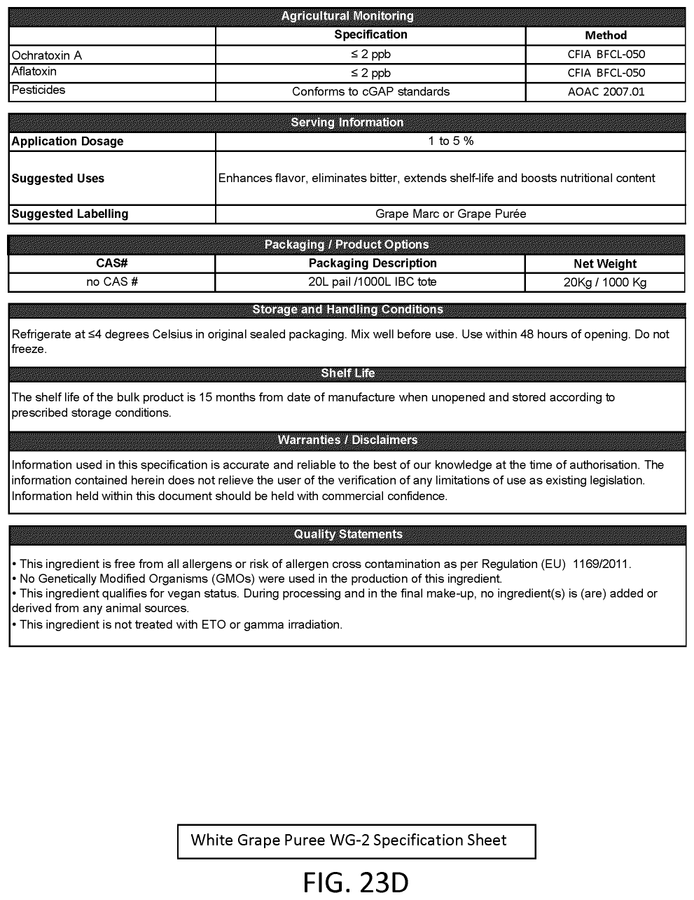

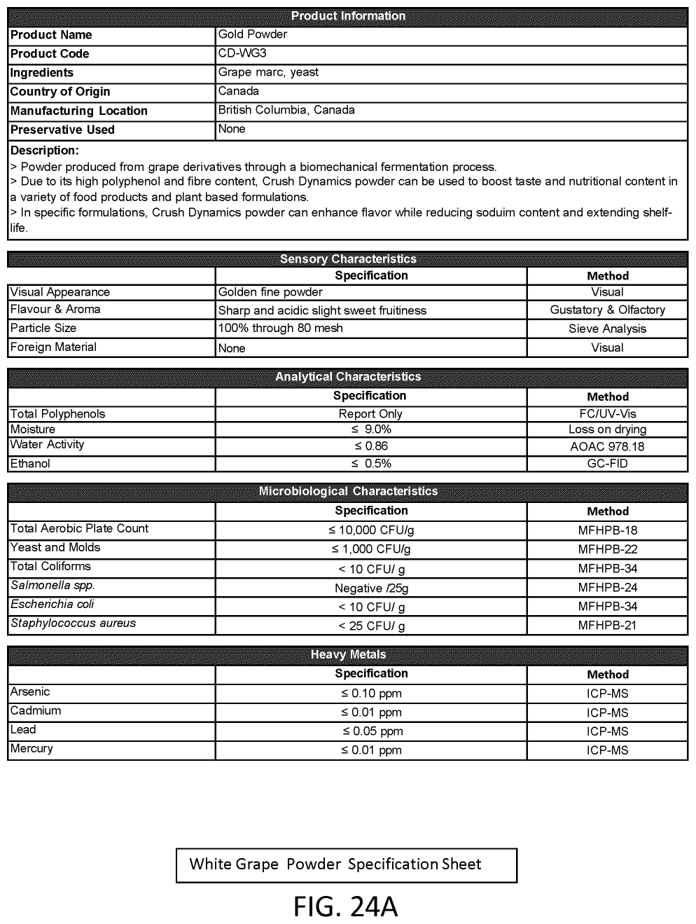

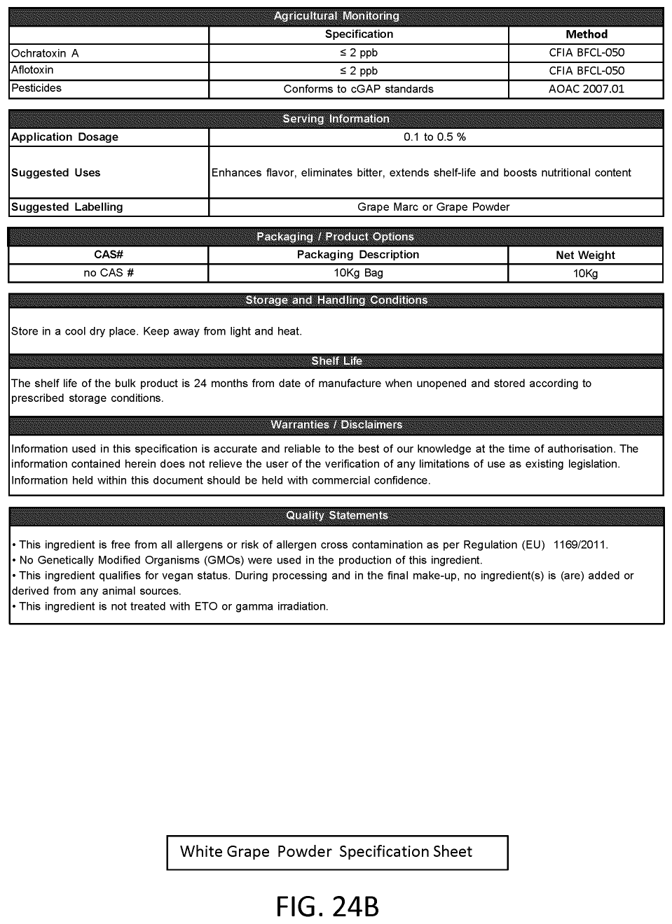

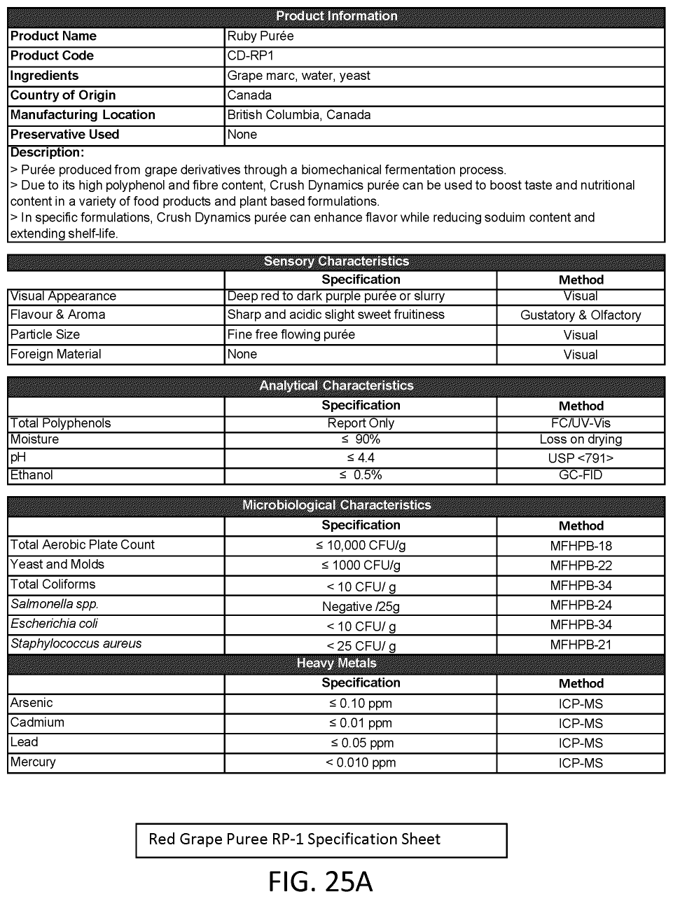

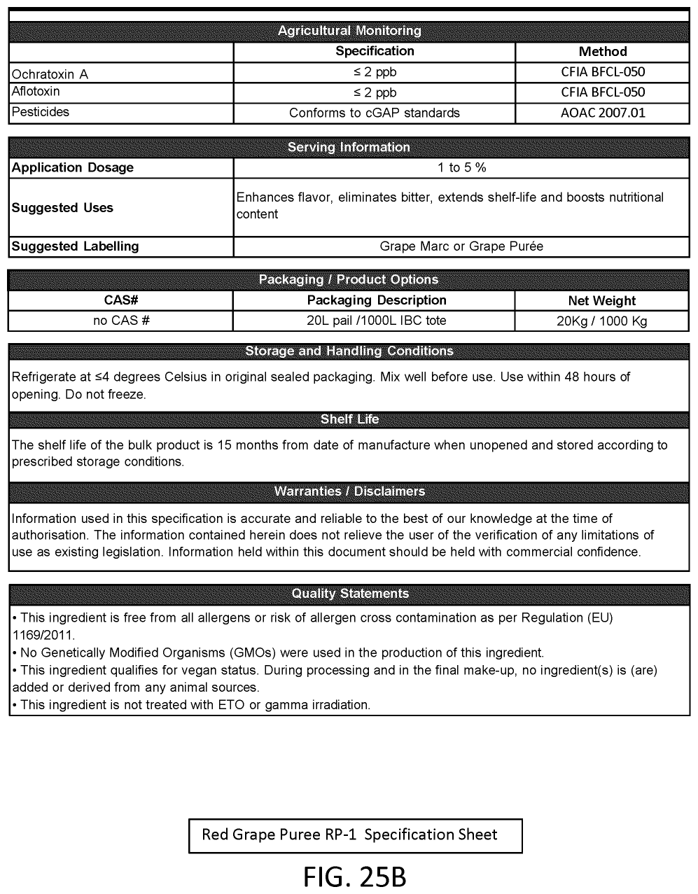

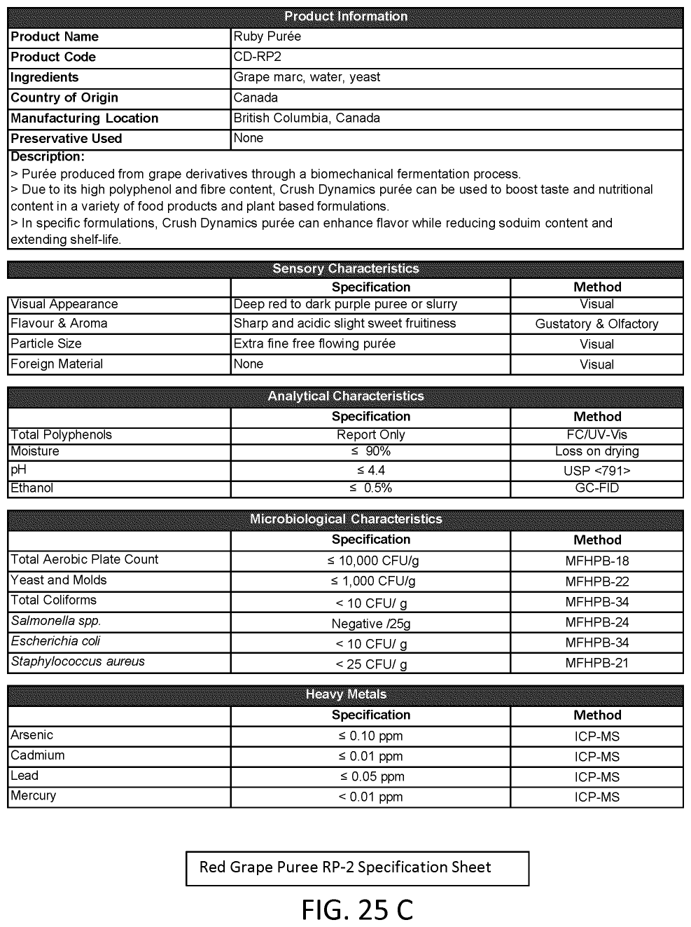

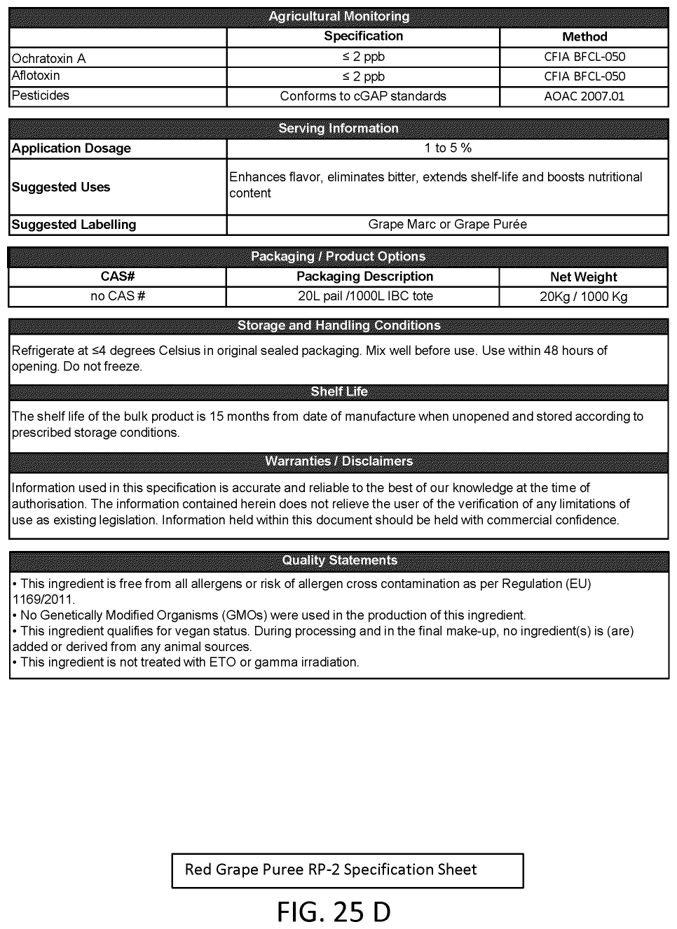

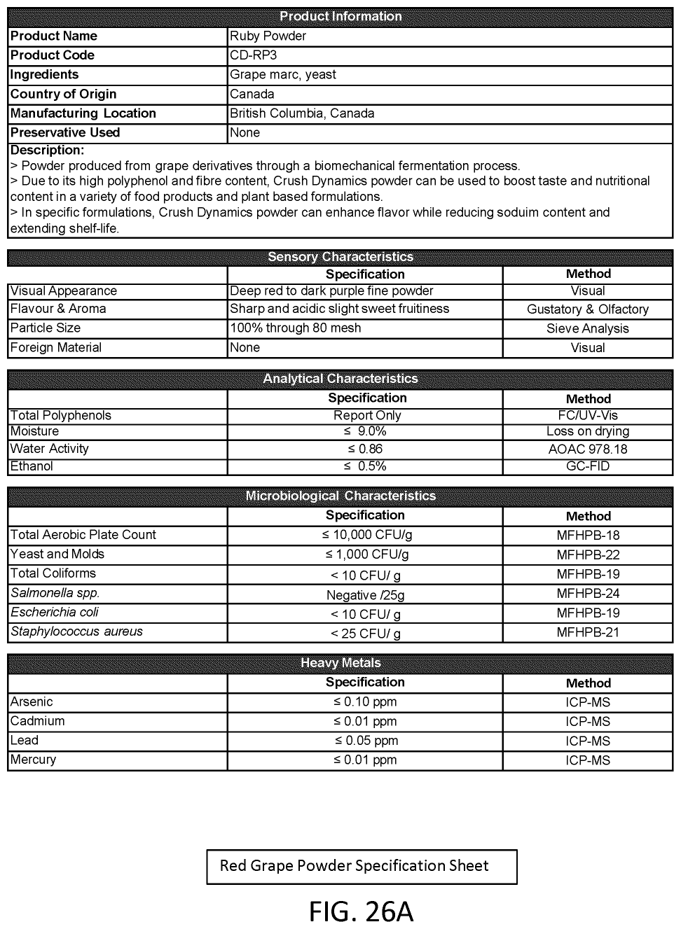

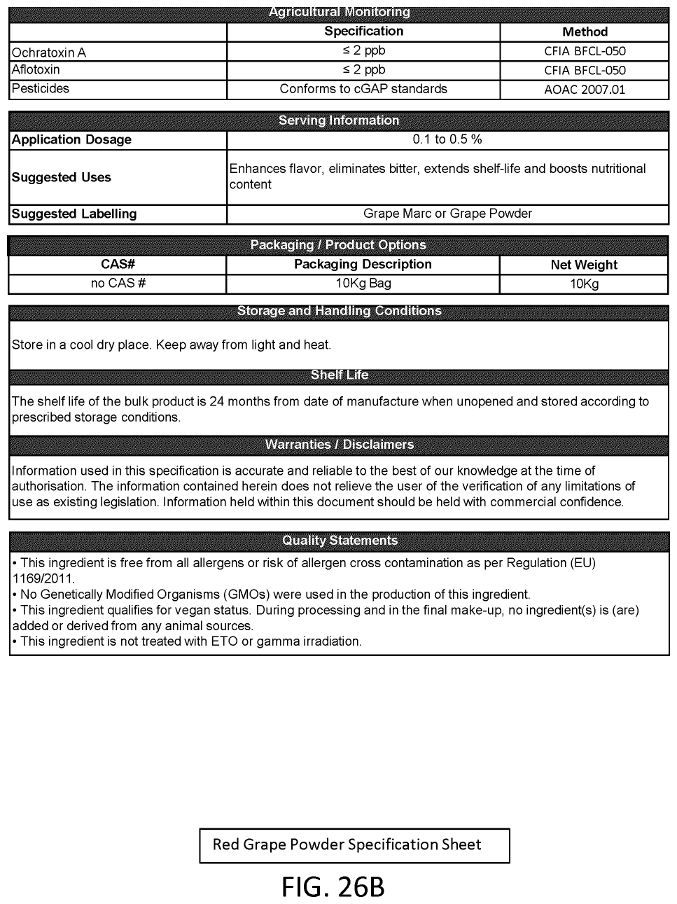

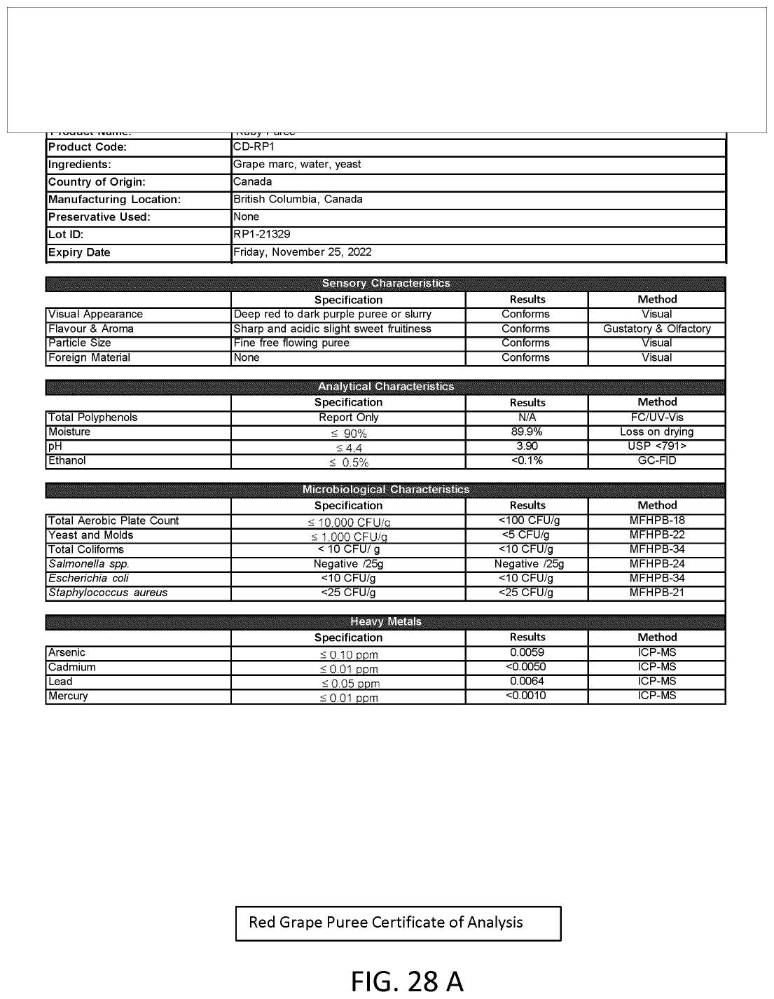

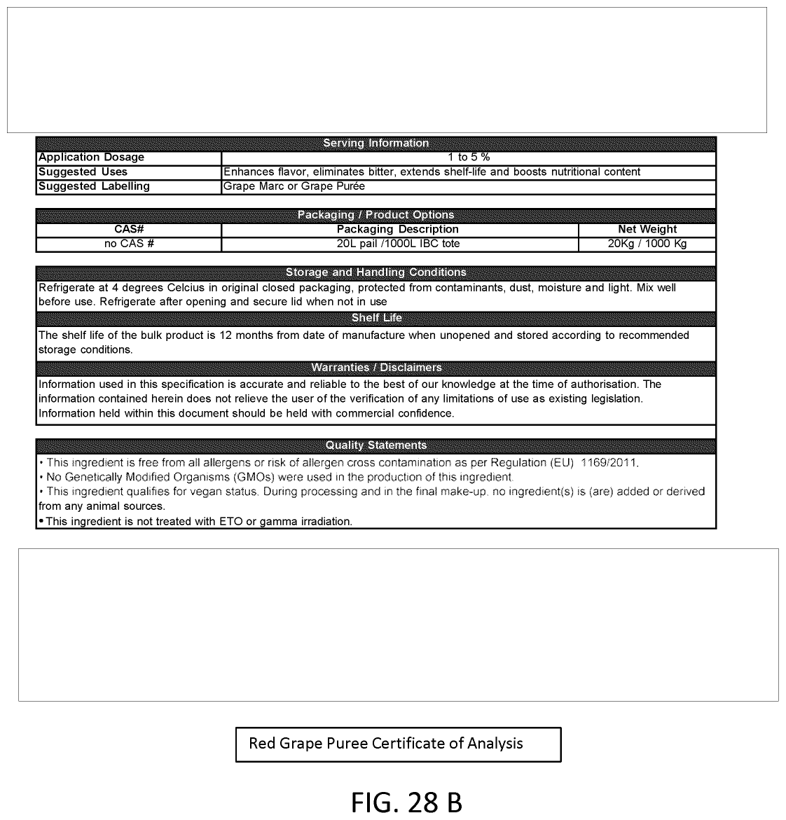

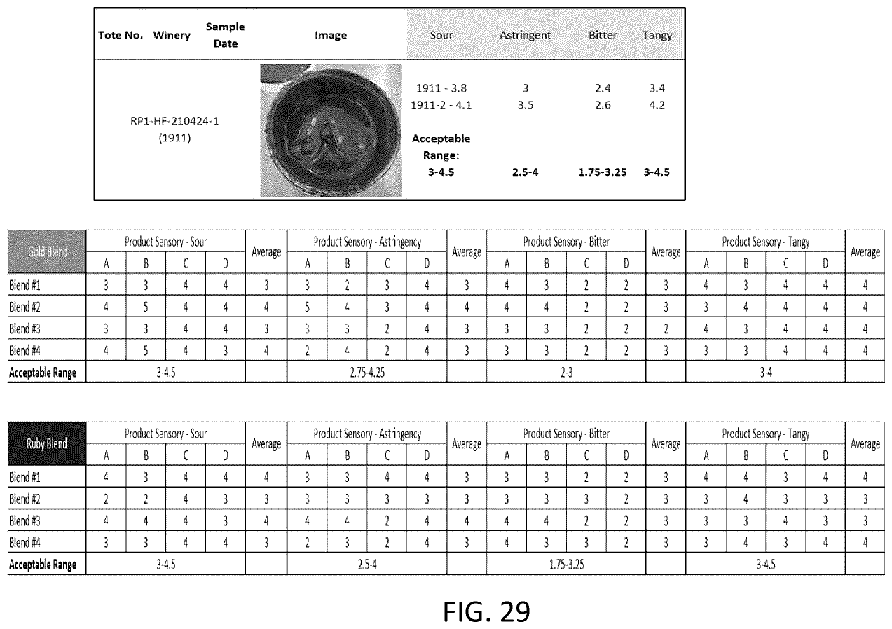

In general, the pomace, the fermented pomace, the puree, and the powder will be sampled and analyzed at various points throughout the process to ensure that appropriate standards of food safety are met. For example, upon receipt of the pomace from the wineries, a visual inspection will be conducted to ensure that there are no pests, mold, and foreign material present, in addition to taking a sample and analyzing for heavy metals, mycotoxins, and pesticides. If these types of toxic substances exceed a regulatory threshold, then the batch of pomace will likely be rejected. Samples will also be taken at appropriate spots throughout processing and prior to shipping the product to customers to ensure that the biomass has not been contaminated or adulterated. For Example. FIGS. 23A-28B provide example Product Specifications and Certificate of Analysis (CoA) documentation, reflective of the types of tests that can be performed, according to embodiments.

Ethanolic and Acetic Acid Fermentation without Kosher Washing

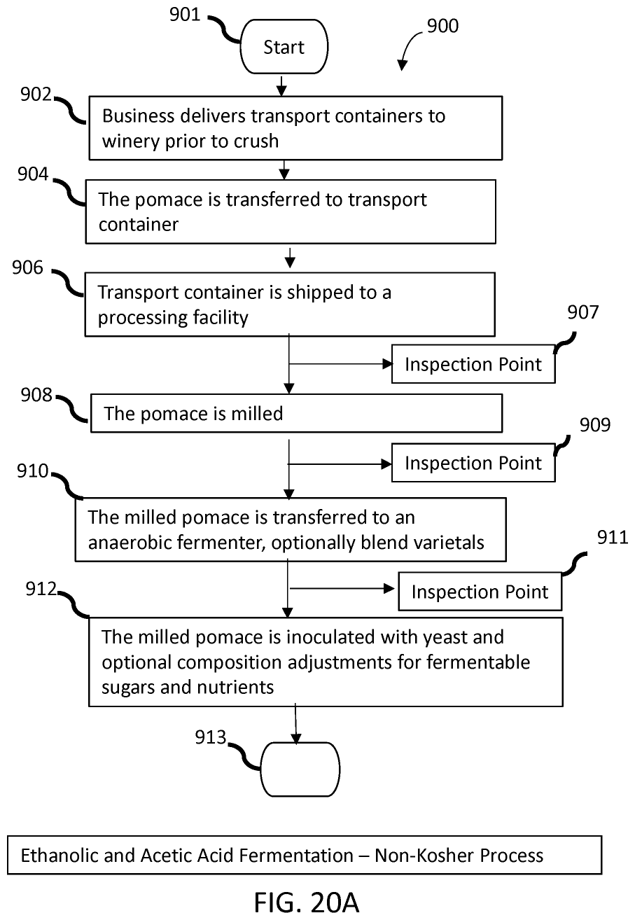

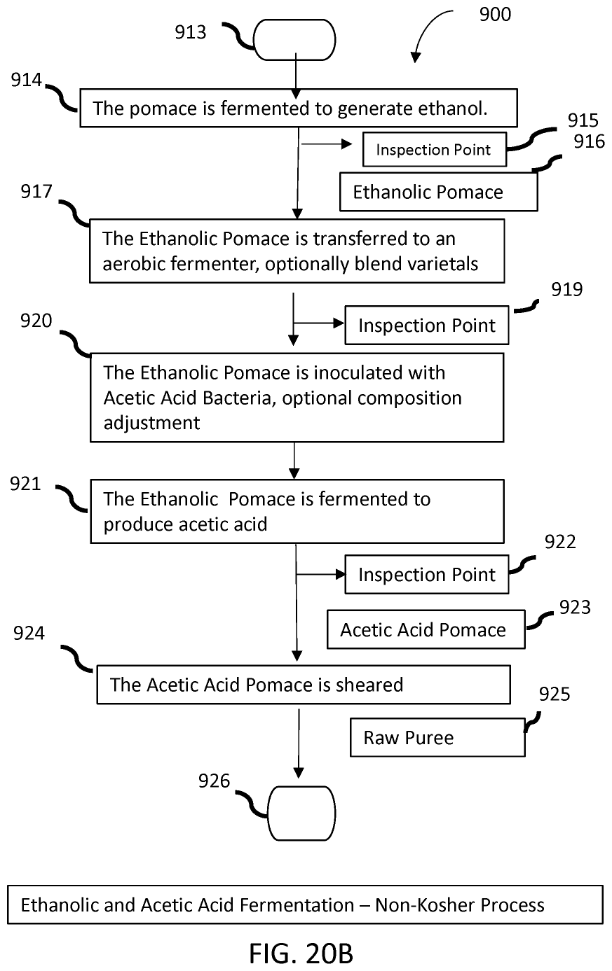

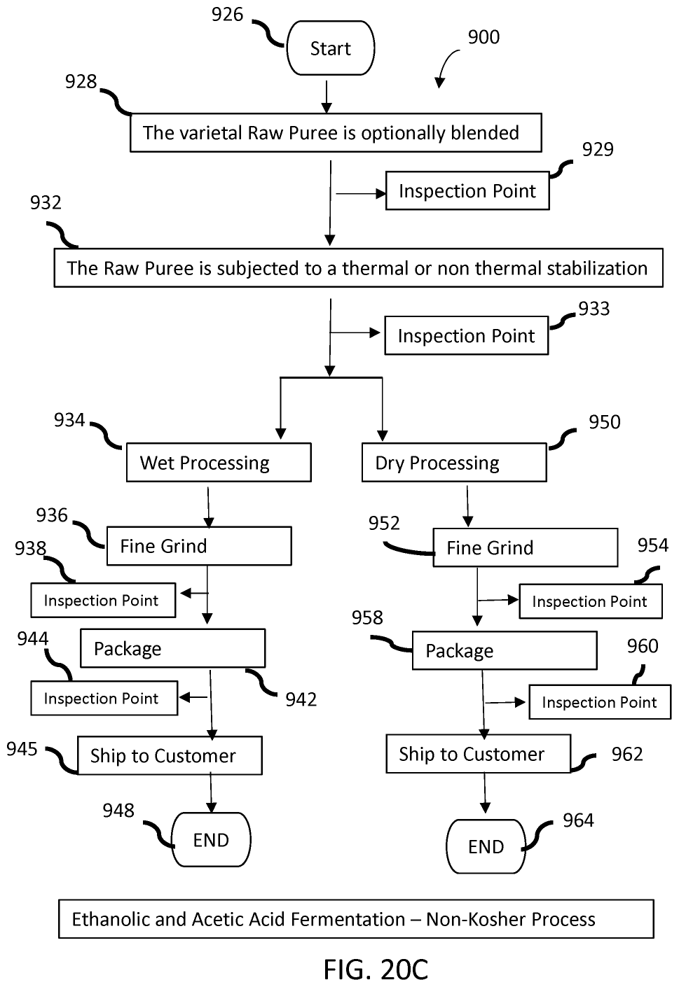

FIGS. 20A-C show a flow diagram for ethanolic and acetic acid fermentation without Kosher processing. As described in FIG. 20A, at step 902 a business delivers transport containers to a winery prior to crush. At step 904 the pomace is transferred to a transport container and at step 906, the container is shipped to a pomace processing facility.

Inspection Point 907 entails a visual inspection of the pomace, looking for pests, foreign matter and visible mold, etc. A sample (e.g., 200 ml) will be taken to conduct a laboratory analysis for moisture, total polyphenols, titratable acidity, ethanol, sugars, yeast and mold counts. On arrival the pomace tends to be in the pH range below 4.0, and the moisture is approximately 40%. A sample (e.g. 200 ml) will also be sent out to a third-party laboratory to analyze for pesticides according to the regulatory standards relevant to the jurisdiction in which the product will be produced (e.g., Health Canada Standards determine the tolerance levels for pesticides, which is currently on the order of 50 different pesticides). Analysis will also be conducted for pathogenic microorganisms, which will also be typically performed by DNA testing (PCR), rather than plating.

At step 908 the pomace is milled until at least 90% of the seeds are cracked, according to embodiments. A sample (e.g., 200 ml) will be collected 909 and inspected for broken seeds and moisture content. At step 910 the pomace, will be transferred to an anaerobic fermenter. The process continues at step 913 to 913 in FIG. 20B.

At step 912, the pomace is inoculated with yeast and optional adjustments to the chemical composition may be made for fermentable sugars and nutrients. In some embodiments, the inoculation will be conducted by adding approximately 200 mg yeast cells/L.

In some embodiments, the target for the Acetic Acid Pomace 923 is a titratable acidity of around 2.2%. If the Acetic Acid Pomace 923 is destined to be dried and become a powder product, the titratable acidity might be in the range of 2.2-5%. This can be controlled by measuring the input material (e.g., ethanol, sugars, and yeast nutrients) and adding enough fermentable sugar and yeast nutrients to produce sufficient ethanol to be converted during the acetic acid fermentation to result in a titratable acidity of 2.2-5% in the Acetic Acid Pomace 923. The acidity can be measured by titration, and a device such as an OenoFoss machine may be used to determine the amount of sugars and ethanol.

At 913, the process continues in FIG. 20B. At step 914, the pomace is fermented to generate ethanol. In general, a sample will be withdrawn the day after initiating the fermentation to ensure that the fermentation has started. If there is no activity, it might be necessary to re-inoculate the pomace.

At Inspection Point 915, a sample will be withdrawn and tested for yeast activity and ethanol to ensure that the fermentation is complete. This composition is referred to as Ethanolic Pomace 916.

At step 917 the Ethanolic Pomace 916 is transferred to an aerobic fermenter. It may be desirable to blend varietals of Ethanolic Pomace 916 to stay within the limits of composition standards to ensure the pH is below 4.0 and the titratable acidity is below 8 grams/L. At the Inspection Point 919 the most important parameter is the concentration of ethanol. Accordingly, the Ethanolic Pomace 916 will be analyzed to determine the amount of ethanol in addition to determine that the composition of the Ethanolic Pomace appropriate for Acetic Acid Bacteria. At step 921 the Ethanolic Pomace 916 is fermented to produce acetic acid.

In some embodiments, it may be desirable to calculate and meter the amount of oxygen delivered to the aerobic fermenter. For example, assuming that the efficiency of oxygen mass transfer between sparging air and pomace would depend on the air flow rate and bubble size. This transfer rate would have to be measured, but is on the order of 50%. Using the estimation that air comprises approximately 20% oxygen, the amount of air required for a 1,000 L fermentation tank would be calculated using an equation such as (liquid volume in the tank)×(% alcohol/weight/100)×250 Litres of air. The smaller the bubble size and the slower the rate of delivery, the greater the rate of conversion from ethanol to acetic acid.

In some embodiments, the fermentation can be monitored using in-line analyzers for Brix, ethanol, dissolved oxygen and temperature. At Inspection Point 922 analysis will be conducted in order to determine that the stoichiometric conversion of ethanol to acetic acid is complete, (i.e., that no ethanol remains), and optionally to measure the titratable acids to ensure that they are in the range of 2.2-5%. At that point the aerobic fermentation should be discontinued by ceasing the aeration. This composition is referred to as Acetic Acid Pomace 923.

At step 924 the Acetic Acid Pomace is sheared to create a puree, and the composition is termed Raw Puree 925.

At 926, the process continues in FIG. 20C.

In some embodiments, Raw Puree 925 will be analyzed to determine whether the composition meets the KPI for the Raw Puree 925 which in some embodiments would be a total polyphenol content of 50-60 mg. gallic acid equivalent/g dried mass and a particle size of 92-93% passing through an 80-mesh screen. In FIG. 20C, this analysis is indicated at Inspection Point 929, which follows from an optional blending step 928, only if the blending step is conducted at step 928. Otherwise, this Inspection Point would be conducted on the Acetic Acid Pomace 923 at Inspection Point 922

At step 932, the Raw Pomace 925 is subjected to a thermal or non-thermal stabilization step in order to reduce the count of viable microorganisms, according to embodiments. In some embodiments, the objective of the stabilization process is to lower the colony forming units (CFU) to under 2,000-3,000 CFU/gram, while minimizing the loss of volatile compounds and/or damaging some of the phenolic compounds. In some embodiments, the treated pomace will be under 1,000 CFU/gram.

Examples of non-thermal stabilization process could include ultrasonic radiation or ultraviolet radiation. Examples of a thermal process could include ultra-high temperature (UHT) for a time period such as 1 second or less, or high temperature short time (HTST) for a short time period, and could include heating the puree in industrial kettles. In some embodiments, the puree is heated at 90° C. for 30 minutes in an industrial kettle. In some embodiments, the puree is heated at 85° C. for one hour in an industrial kettle.

After the stabilization step 932, Inspection Point 933 will be conducted to determine if an appropriate CFU count has been attained in addition to measuring the pH, titratable acidity, total phenolics, and acetic acid. In some embodiments, a KPI for Inspection Point 933 is a particle size 95-99% passing through an 80-mesh screen.

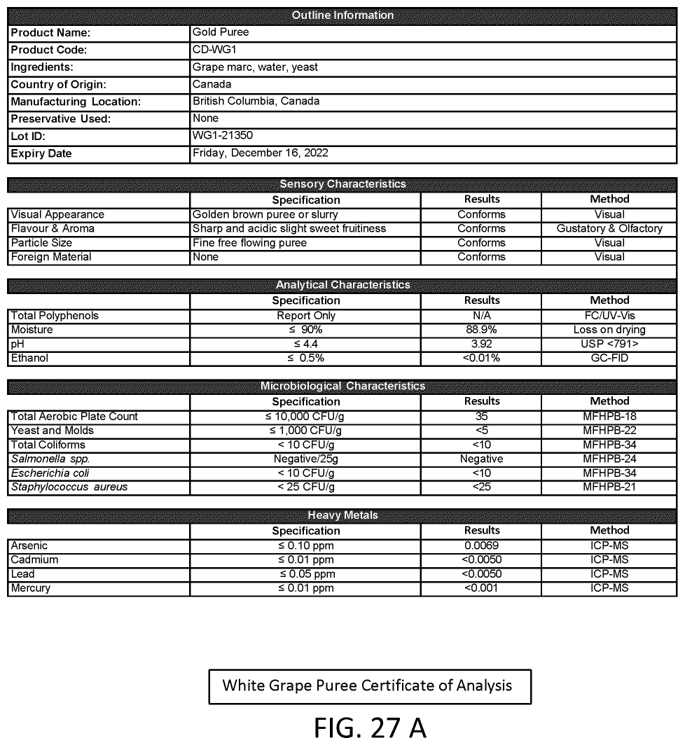

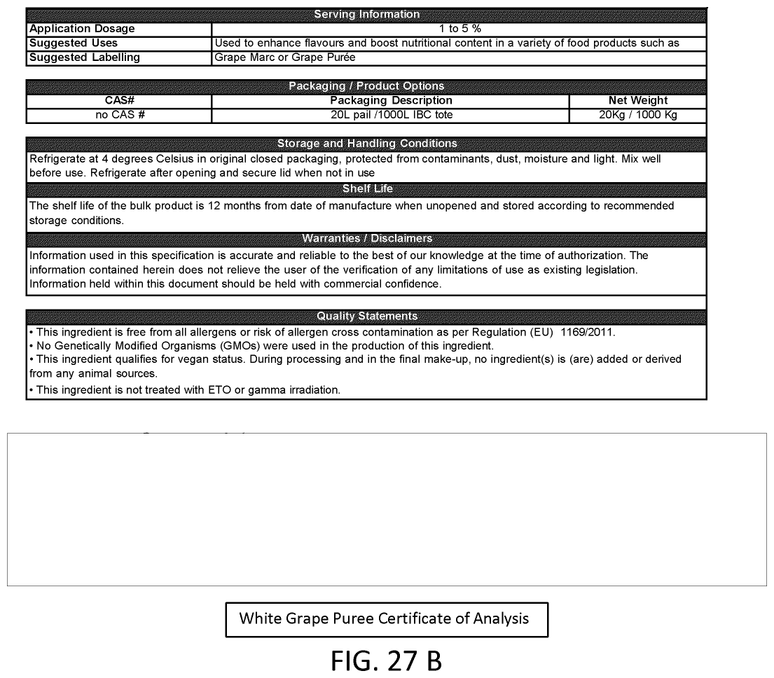

If the product is to be a puree, then the Raw Pomace 925 will be subjected to wet processing techniques 934, the first step of which will be a fine grind 936, in some embodiments. Inspection point, 937 could be performed in order to determine a particle size KPI, which could be 94%-100% of the particles passing through an 80-mesh screen, in some embodiments. Moreover, in order to determine whether the product meets product specifications, analysis will be conducted for final inspection, pre-packaging, and should include titratable acidity, pH, total phenolics, tartaric acid, malic acid, lactic acid, acetic acid. Moreover, appropriate analysis must be conducted to gather the information to be included in the Certificate of Analysis (CoA) for the product. An example of a CoA is presented in FIG. 27A and FIG. 27B for a white and red puree respectively.

In some embodiments the KPI for the puree product can be that the particle size is such that 95-99% of the product passes through an 80-mesh screen, the moisture content of the puree is 86-87%, the total polyphenols are 0.3% for the “gold puree” (based on a white grape blend) and 0.4% for the “ruby puree” (based on a red grape blend). In some embodiments, the quality safety requirements include that the aerobic plate count is <10,000 CFU/grams puree, the total coliforms are <10 CFU/grams puree, yeast and mold are <1,000 CFU/grams puree. Moreover, the puree product tests negative for E. coli, Listeria monocytogenes, Salmonella spp. and Staphylococcus aureus.

At step 942, the puree will be packaged. In some embodiments, the puree will be hot-packed, in which the product is heated, for example to a pasteurization temperature of 90° C. and dispensed into the package and sealed while the contents are still hot. The package comes in a sterile condition from the manufacturer.

At Inspection Point 944, packages will be drawn randomly from the batch, and analyzed to confirm that the CoA for the product is valid, pre-shipment. This sampling would be conducted on an appropriate periodic basis throughout the storage period, and likely within a short period of sending to a customer. At step 945, the product is shipped to the customer.

If the product is to be a dry product, then the Raw Pomace 925 will be subjected to drying processing techniques 950. Examples of drying processes include freeze drying, spray drying, microwave vacuum drying, etc. or immobilization onto a solid substrate. For example, immobilization onto a solid substrate entails adding a substrate such as agar, pectin, protein, etc. to create a solid complex, which can be powdered by conducting a fine grind.

In some embodiments, where a tall-form spray dryer is used, the puree is transferred into a holding tank, where it is introduced into the top of the spray tower via a high-pressure nozzle. The high-pressure nozzle produces droplets of puree that fall through the heated air in the nozzle tower (for example, a 50-foot drop). By the time the droplets reach the bottom of the dryer they are dry particles having a particle size (mean particle size) in the range of an 80-mesh screen, or 0.177 millimeters. In some such embodiments, it will not be necessary to conduct a fine grind (step 952) in order to reduce the particle size.

There are several parameters that determine what the final particle size will be including nozzle design/orifice size, height of spray dryer, pump pressure, puree solids content, and temperature. One objective is to ensure that the rate of evaporation is slow enough that damage to the active compounds within the puree (e.g., polyphenols) is minimized. These parameters are typically determined by simple trials which can help determine the right size/type of equipment along with proper puree characteristics to consistently produce product that has a desired particle size in a very narrow particle size distribution in addition to minimal damage to the polyphenols. There are several ways to atomize or spray puree into spray dryers.

In some embodiments, the puree which is to be spray dried has an approximately 87% moisture content and 13% solids content. In some embodiments, the target objective is to generate a powder, which has between 7%-less than 9% moisture content. In some embodiments, the moisture content of the final powder is 8.5%. The objective to remain below 9% is to be compliant with GRAS, to minimize the microbe activity in addition to the water activity. The moisture content is not to be lowered below 7% to retain the activity of the compounds within the powder. In some embodiments the polyphenol retention in the powder will be between 96% and 100%, the acids and volatiles retention will be between 50% and 80%, the water activity will be below 0.85 and the particle size will be such that 100% of the powder passes through an 80-mesh screen.

At step 952, the dried powder will be subjected to a fine grind. In some embodiments where the product will be incorporated into a food that is sensitive to particle size (e.g., a smooth chocolate), the particle size of the product will be smaller, such as similar to that of cocoa powder.

Inspection Point 934 will be to determine a particle size KPI, which could be 94%-100% of the particles passing through an 80-mesh screen. In some embodiments, in order to determine whether the product meets specifications, analysis will be conducted for final inspection, pre-packaging, must include titratable acidity, pH, total phenolics, tartaric acid, malic acid, lactic acid, acetic acid.

In some embodiments the KPI for the powder product can be that the powder yield is >95%, the particle size is such that 100% of the product passes through an 80-mesh screen, the moisture content of the powder is 7-9%, the total acidity is 15%, the total polyphenol retention is 96-98%. In some embodiments, the quality safety requirements are that the water activity is <0.85, the aerobic plate count is <10,000 CFU/grams powder, the total coliforms are <10 CFU/grams powder, yeast and mold are <100 CFU/grams powder. Moreover, the powder product tests negative for E. coli, Listeria monocytogenes, Salmonella spp. and Staphylococcus aureus.

Moreover, appropriate analysis must be conducted to gather the information to be included in the Certificate of Analysis (CoA). An example of a CoA is presented in FIG. 27A and FIG. 27B for a white and red puree respectively.

At step 958, the powder will be packaged, using ambient temperature packaging techniques. The package comes in a sterile condition from the manufacturer.

At Inspection Point 962, packages will be drawn randomly from the batch, and analyzed to confirm the CoA is valid, pre-shipment. This sampling would be conducted on an appropriate periodic basis throughout the storage period, and likely within a short period of sending to a customer. At step 952, the product is shipped to the customer.

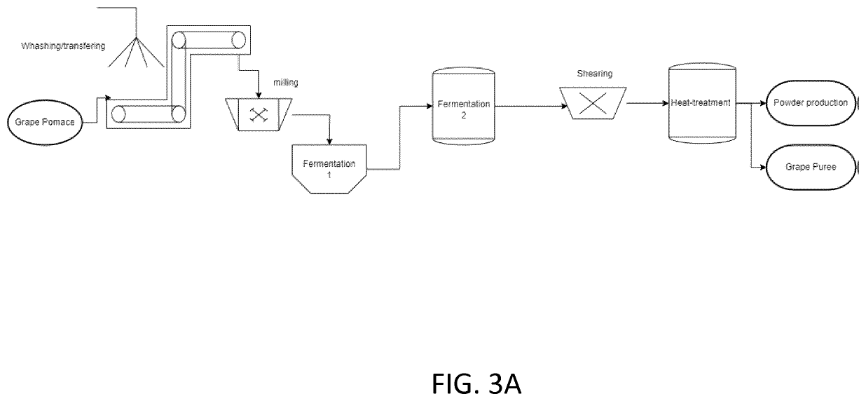

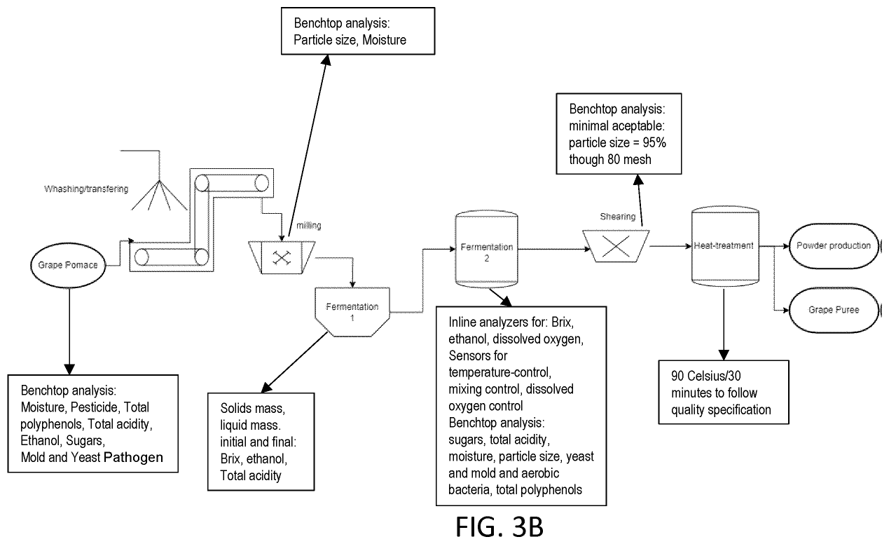

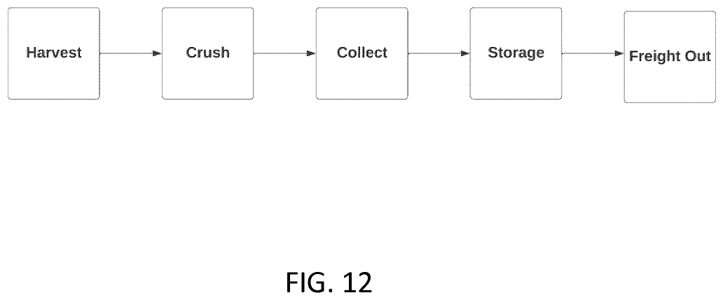

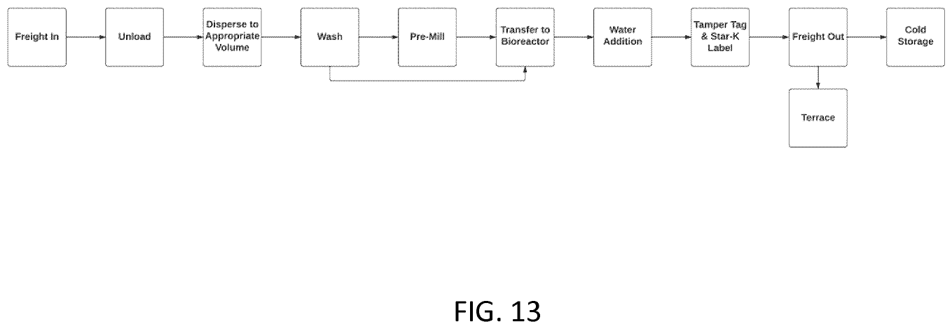

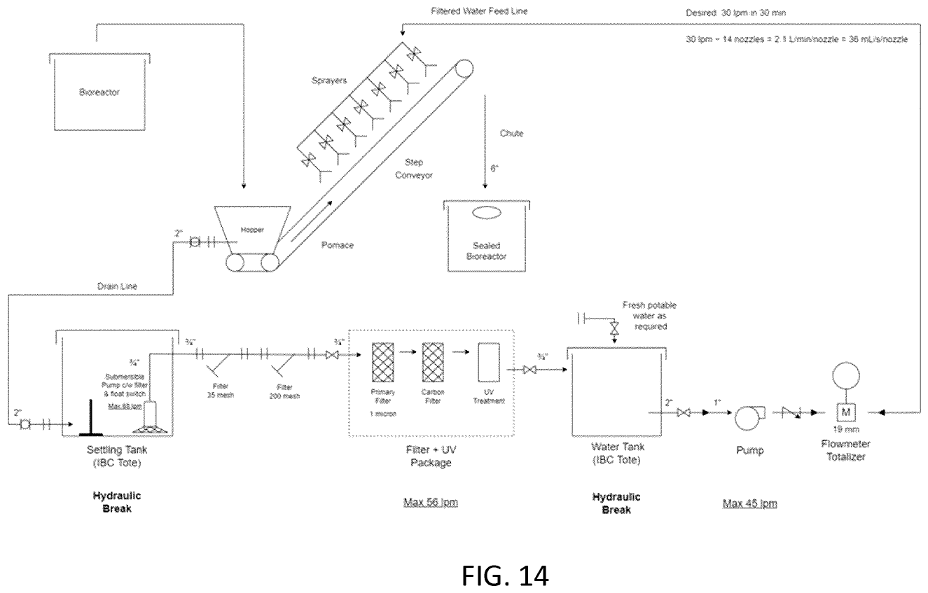

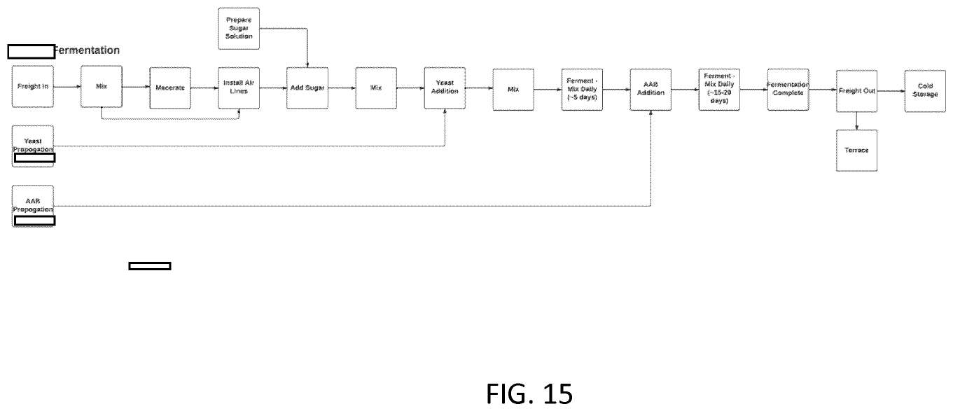

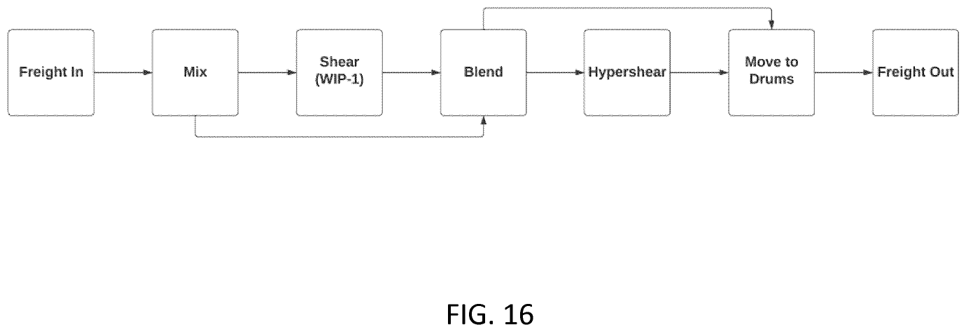

Referring to FIG. 3, this provides an simplified outline of the general commercial-scale process, as shown in FIGS. 20A-C, and described in more detail above; in particular, the ethanolic fermentation and acetic acid fermentation steps (which are preferably carried out in fermenters) are shown. FIGS. 12-19 also illustrate the commercial scale process processing steps shown in FIGS. 20A-C, and described above. FIG. 12 illustrates that the raw material collection steps of: harvest, crush, collect, storage and freight out (transport to processing facility). FIG. 13 illustrates the general processing steps for preparing the pomace for fermentation. FIG. 14 illustrates some of the raw material processing steps in greater detail. FIG. 15 is process diagram illustrating the ethanolic fermentation and acetic acid fermentation steps. FIG. 16 outlines the processing steps associated with blending the varietal raw puree.

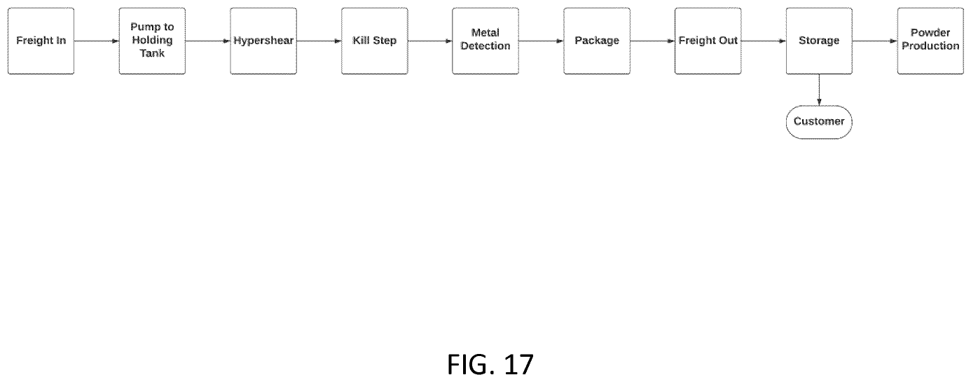

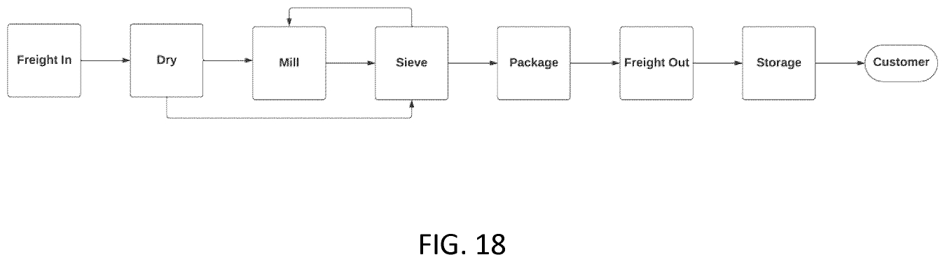

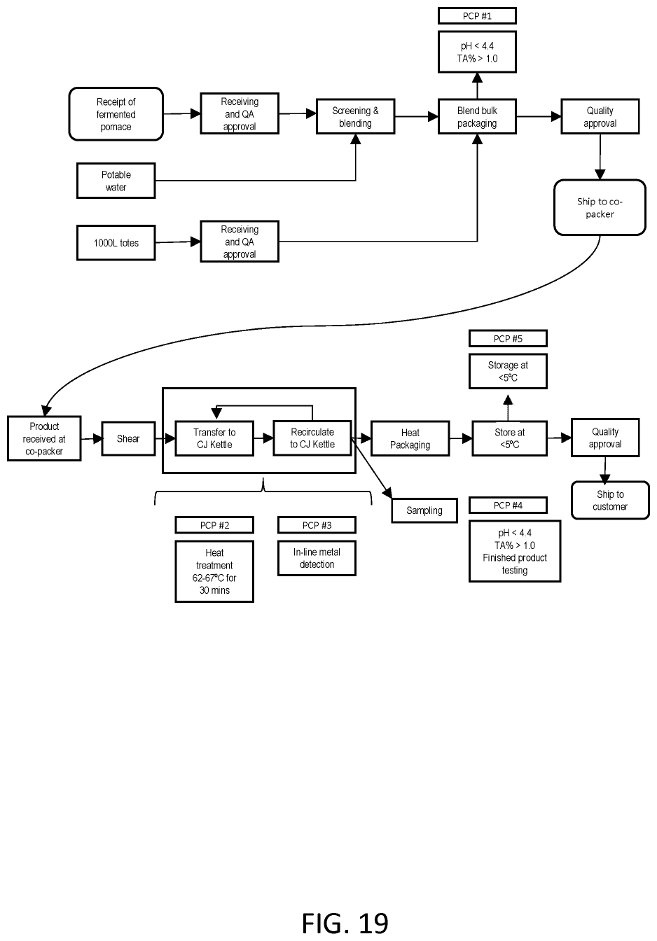

FIG. 17 shows the steps for producing the nutrient-rich product (as a puree) once the fermentation is complete. FIG. 18 shows the steps for producing the nutrient-rich product (as a powder). FIG. 19 shows some of the processing and quality control steps for the fermented pomace and the resultant puree or powder.

Ethanolic and Acetic Acid Fermentation with Kosher Processing

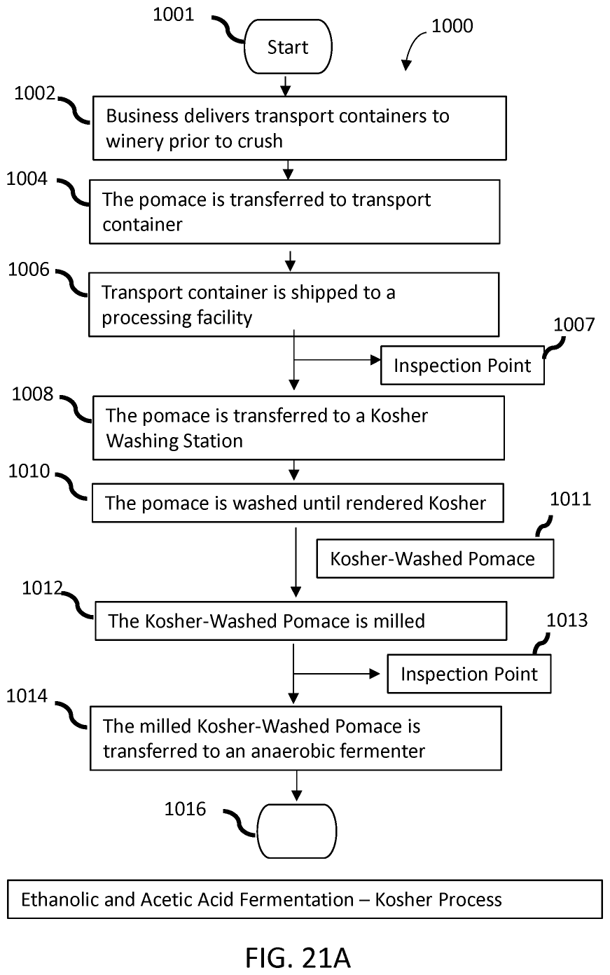

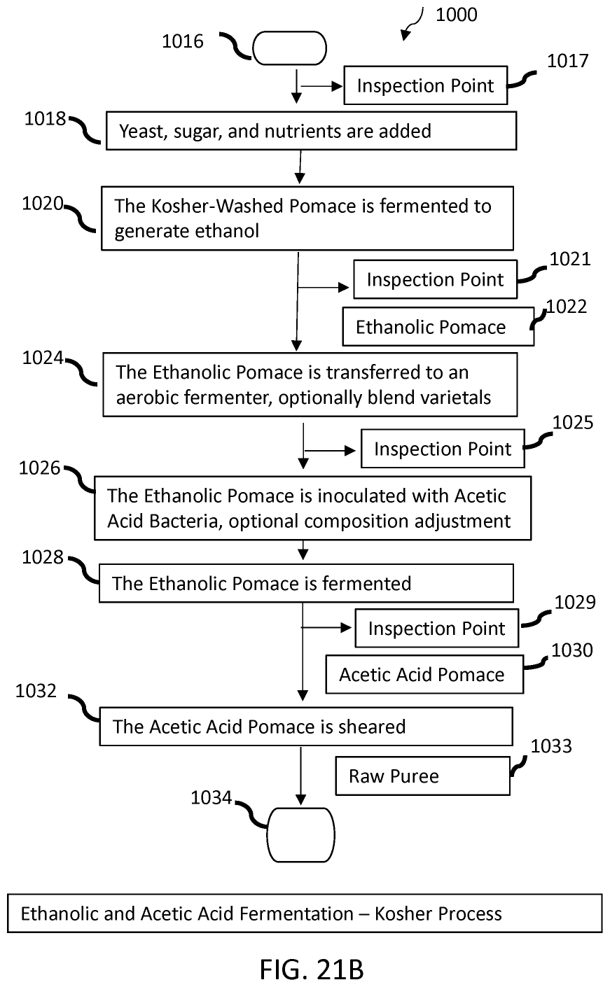

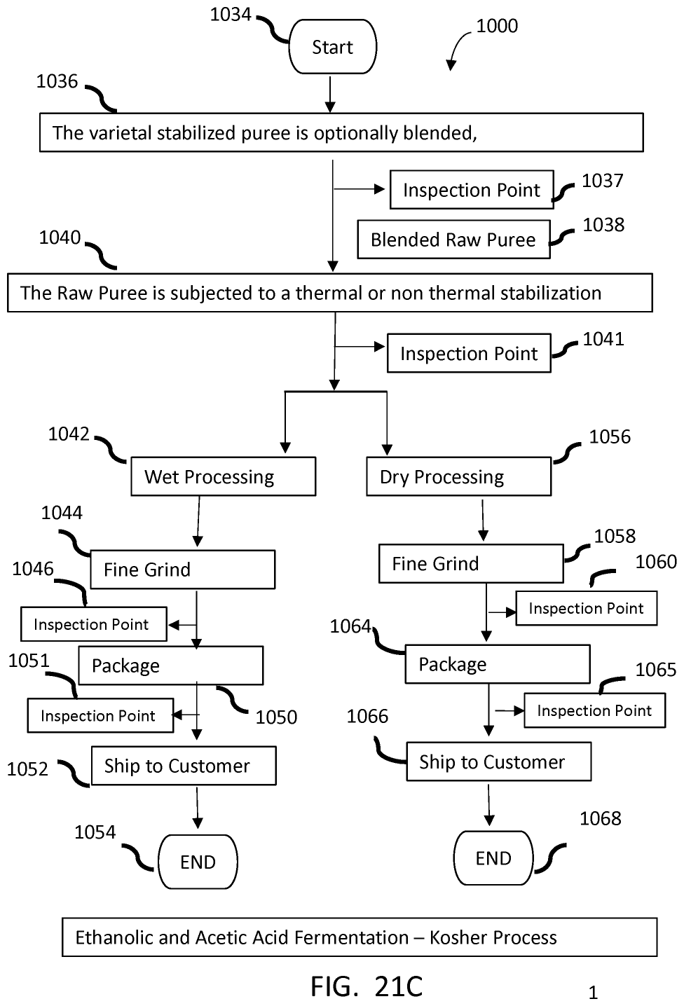

FIGS. 21A-C show a flow diagram for ethanolic and acetic acid fermentation with Kosher processing. As described in FIG. 21A, at step 1002 a business delivers transport containers to a winery prior to crush. At step 1004 the pomace is transferred to a transport container and at step 1006, the container is shipped to a pomace processing facility.

At the inspection point 1007 starts with a visual inspection looking for pests, foreign matter visible mold. A sample (e.g., 200 ml) will be taken to conduct laboratory analysis for moisture, total polyphenols, titratable acidity, ethanol, sugars, yeast and mold counts. On arrival the pomace tends to be in the pH range below 4.0, and the moisture is approximately 40%. A sample (e.g. 200 ml) will also be sent out to a third-party laboratory to analyze for pesticides according to the regulatory standards (e.g. Health Canada Standards which is currently on the order of 50), pathogenic microorganisms, typically done by DNA testing (PCR), rather than plating.

At step 1008, the pomace is transferred to a Kosher Washing Station under the supervision of a Rabbi, according to embodiments. In some embodiments, a Kosher certified facility may perform some and/or all of the steps.

In some embodiments the pomace must be washed within 24 hours of the juice being expressed from the whole berries. The pomace is washed several times (e.g. seven) at 1010 until rendered Kosher. In some embodiments the water may be re-used for some of the washes, and only fresh water can be used for the final wash. For example, see FIG. 14, which describes embodiments where the water can be cleaned and recycled. The pomace is Kosher-Washed Pomace 1011.

In some embodiments, it may be desirable to dry the Kosher-Washed Pomace 1011 below a threshold percentage such as less than 10% moisture content to be rendered Kosher throughout the rest of the processing without requiring supervision of a Rabbi.

In embodiments, where the Kosher-Washed Pomace 1011 has not been dried, the Kosher Washed Pomace 1011 is milled. In some embodiments, the result of the milling is such that at least 90% of the seeds are cracked. A sample (e.g., 200 ml) will be collected 1013—inspection for broken seeds and moisture. At step 1014, the Kosher Washed Pomace 1011, will be transferred to an anaerobic fermenter. The process continues at step 1016 to 1016 in FIG. 21B.

The Inspection Point at 1017 is conducted to assess the composition of the pomace. This requires analysis of pH, fermentable sugars, and yeast available nitrogen in order to determine the amount of fermentable sugars and nutrients to be added at step 1018.

At step 1012, the Kosher-Washed Pomace 1011 is inoculated with yeast and optional adjustments to the chemical composition may be made for fermentable sugars and nutrients. Inoculation (200 mg yeast cells/L).

The target for the Acetic Acid Pomace 1030 is a titratable acidity around 2.2%. If the Acetic Acid Pomace 1030 is destined to be dried and become a power product, the titratable acidity might be in the range of 2.2-5%. This can be controlled by measuring the input material (ethanol and sugars) and adding enough fermentable sugar and yeast nutrients to produce enough ethanol to be converted during the acetic acid fermentation to result in a titratable acidity of 2.2-5%. The acidity can be measured by titration, and a device such as an OenoFoss machine may be used to determine the amount of sugars and ethanol.

At step 1020, the Kosher-Washed Pomace 1030 is fermented to generate ethanol.

In some embodiments, it may be desirable to calculate and meter the amount of oxygen delivered to the aerobic fermenter. For example, assuming that the efficiency of oxygen mass transfer between sparging air and pomace would depend on the air flow rate and bubble size. This transfer rate would have to be measured, but is on the order of 50%. Using the estimation that air comprises approximately 20% oxygen, the amount of air required for a 1,000 L fermentation tank would be calculated using an equation such as (liquid volume in the tank)×(% alcohol/weight/100)×250 Litres of air. The smaller the bubble size and the slower the rate of delivery, the greater the rate of conversion from ethanol to acetic acid.

In general, a sample will be withdrawn the next day to ensure that the fermentation has started. If there is no activity, it might be necessary to re-inoculate the pomace.

At Inspection Point 1021, a sample will be withdrawn and tested for yeast activity and ethanol to ensure that the fermentation is complete. This is referred to as Ethanolic Pomace 1022.

At step 1024 the Ethanolic Pomace 1022 is transferred to an aerobic fermenter. It may be desirable to blend varietals of Ethanolic Pomace 1022 to stay within the limits of composition standards to ensure the pH is below 4.0 and the titratable acidity is below 8 grams/L. At the Inspection Point 1025 the most important parameter is the concentration of ethanol.

Accordingly, the Ethanolic Pomace 1022 will be analyzed to determine the amount of ethanol in addition to determine that the composition of the Ethanolic Pomace appropriate for Acetic Acid Bacteria. At step 1028 the Ethanolic Pomace 1022 is fermented to produce acetic acid. At Inspection Point 1029 analysis will be conducted in order to determine that the stoichiometric conversion of ethanol to acetic acid is complete, (i.e., that no ethanol remains), and optionally to measure the titratable acids to ensure that they are in the range of 2.2-5%. At that point the aerobic fermentation should be discontinued by ceasing the aeration. This is referred to as Acetic Acid Pomace 1030.

At step 1032 the Acetic Acid Pomace 1030 is sheared to create a puree, termed Raw Puree 1033.

At 1034, the process continues in FIG. 21C.

In some embodiments, Raw Puree 1033 will be analyzed to determine whether the composition meets the KPI for the Raw Puree 1033 which would be a total polyphenol content of 50-60 mg. gallic acid equivalent/g dried mass and a particle size of 92-93% passing through an 80-mesh screen. In FIG. 21C, this is indicated at Inspection Point 1027, which follows from an optional blending step 1036, only if the blending step is conducted. Otherwise, this Inspection Point would be conducted on the Acetic Acid Pomace 1033 at 1029.

At step 1040, the Raw Puree 1033 is subjected to a thermal or non-thermal stabilization step in order to reduce the count of viable microorganisms. In some embodiments, the puree is heated at 90° C. for 30 minutes. In some embodiments, the puree is heated at 85° C. for one hour. The objective of the stabilization process is to lower the colony forming units (CFU) to under 2,000-3,000 CFU/gram, while minimizing the loss of volatile compounds and/or damaging some of the phenolic compounds. In some embodiments, the treated pomace will be under 1,000 CFU/gram.

After the stabilization step 1040, Inspection Point 1041 will be conducted to determine if an appropriate CFU count has been attained, pH, titratable acidity, total phenolics, acetic acid. A KPI for Inspection Point 933 is a particle size 95-99% passing through an 80-mesh screen.

If the product is to be a puree, then the Raw Puree 1033 will be subjected to wet processing techniques 1042, the first step of which will be a fine grind 1044. Inspection point 1046 will be to determine a particle size KPI, which could be 94%-100% of the particles passing through an 80-mesh screen. Moreover, in order to determine whether the product meets specifications, analysis will be conducted for final inspection, pre-packaging, must include titratable acidity, pH, total phenolics, tartaric acid, malic acid, lactic acid, acetic acid. Moreover, appropriate analysis must be conducted to gather the information to be included in the Certificate of Analysis (CoA). An example of a CoA is presented in FIG. 27A and FIG. 27B for a white and red puree respectively.

In some embodiments the KPI for the puree product can be that the particle size is such that 95-99% of the product passes through an 80-mesh screen, the moisture content of the puree is 86-87%, the total polyphenols are 0.3% for the gold puree and 0.4% for the ruby puree. In some embodiments, the quality safety requirements include that the aerobic plate count is <10,000 CFU/grams puree, the total coliforms are <10 CFU/grams puree, yeast and mold are <1,000 CFU/grams puree. Moreover, the puree product tests negative for E. coli, Listeria monocytogenes, Salmonella spp. and Staphylococcus aureus.

At step 1051, the puree will be packaged. In some embodiments, the puree will be hot-packed, in which the product is heated such as a pasteurization temperature of 90° C. and is dispensed into the package and sealed while the contents are still hot. The package comes in a sterile condition from the manufacturer.

At Inspection Point 1050, packages will be drawn randomly from the batch, and analyzed to confirm the CoA is valid, pre-shipment. This sampling would be conducted on an appropriate periodic basis throughout the storage period, and likely within a short period of sending to a customer. At step 1052, the product is shipped to the customer.

If the product is to be a dry product, then the Raw Puree 1033 will be subjected to drying processing techniques 1056. (See above for the Ethanolic Acetic Acid Fermentation Non-Kosher section for examples and details)

In some embodiments, the target objective is to generate a powder, which has between 7%-less than 9% moisture content. In some embodiments, the moisture content of the final powder is 8.5%. The objective to remain below 9% is to be compliant with GRAS, to minimize the microbe activity in addition to the water activity. The moisture content is not to be lowered below 7% to retain the activity of the compounds within the powder. In some embodiments the polyphenol retention in the powder will be between 96% and 100%, the acids and volatiles retention will be between 50% and 80%, the water activity will be below 0.85 and the particle size will be such that 100% of the powder passes through an 80-mesh screen.

At step 1058, the dried powder will be subjected to a fine grind.

Inspection point 1060 will be to determine a particle size KPI, which could be 94%-100% of the particles passing through an 80-mesh screen. In some embodiments, in order to determine whether the product meets specifications, analysis will be conducted for final inspection, pre-packaging, must include titratable acidity, pH, total phenolics, tartaric acid, malic acid, lactic acid, acetic acid.

In some embodiments the KPI for the powder product can be that the powder vield is >) 5%, the particle size is such that 100% of the product passes through an 80-mesh screen, the moisture content of the powder is 7-9%, the total acidity is 15%, the total polyphenol retention is 96-98%. In some embodiments, the quality safety requirements are that the water activity is <0.85, the aerobic plate count is <10,000 CFU/grams powder, the total coliforms are <10 CFU/grams powder, yeast and mold are <100 CFU/grams powder. Moreover, the powder product tests negative for E. coli, Listeria monocytogenes, Salmonella spp. and Staphylococcus aureus.

Moreover, appropriate analysis must be conducted to gather the information to be included in the Certificate of Analysis (CoA). (for example see FIG. 27A and FIG. 27B).

At step 1064, the powder will be packaged, using ambient temperature packaging techniques. The package comes in a sterile condition from the manufacturer.

At Inspection Point 1065, packages will be drawn randomly from the batch, and analyzed to confirm the CoA is valid, pre-shipment. This sampling would be conducted on an appropriate periodic basis throughout the storage period, and likely within a short period of sending to a customer. At step 1066, the product is shipped to the customer.

Lactic Acid Fermentation with Kosher Washing Process

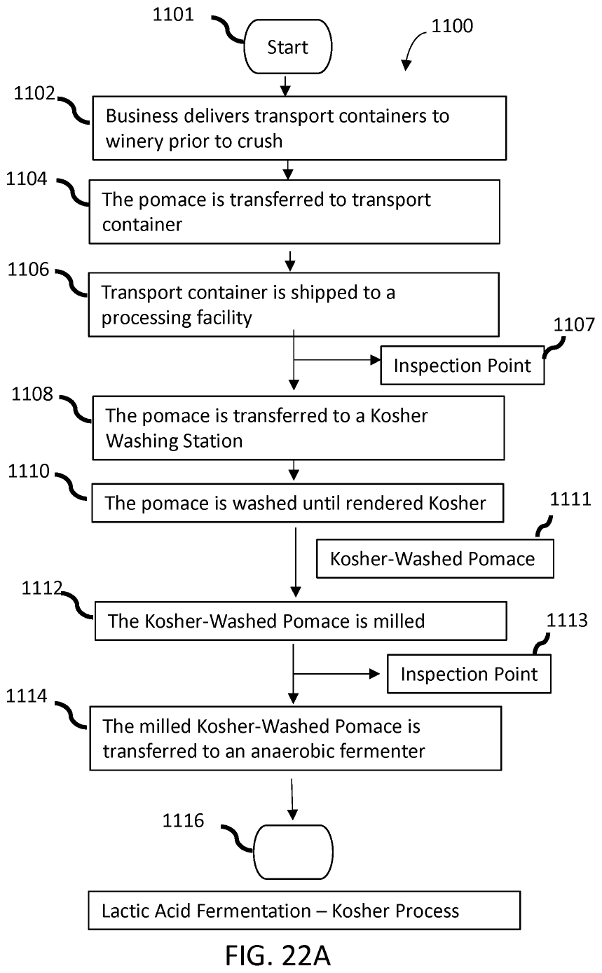

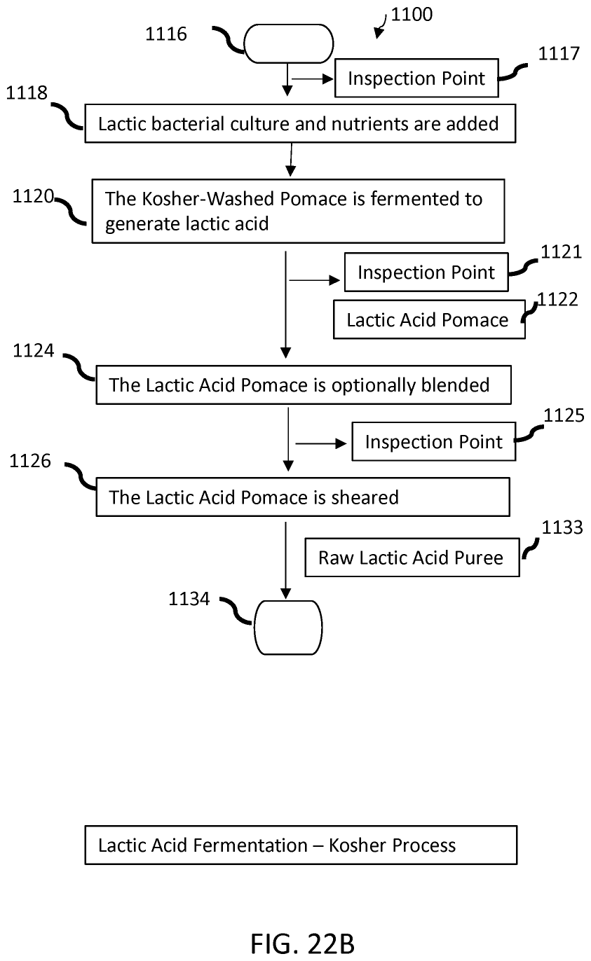

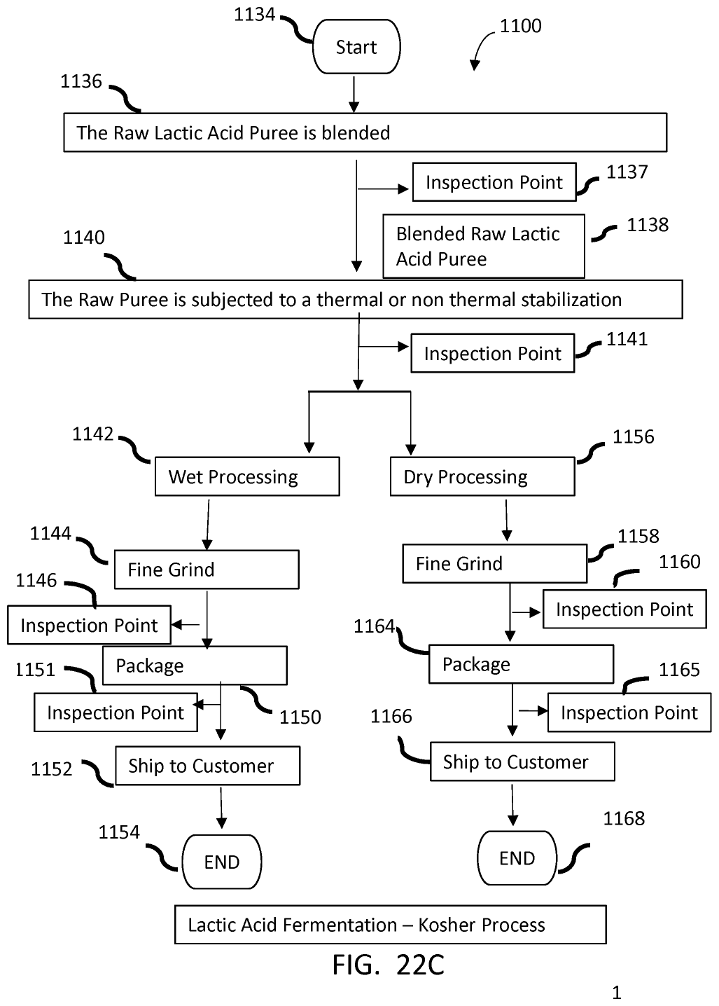

FIGS. 22A-C show a flow diagram for lactic acid fermentation with Kosher processing. As described in FIG. 22A, at step 1102 a business delivers transport containers to a winery prior to crush. At step 1404 the pomace is transferred to a transport container and at step 1106, the container is shipped to a pomace processing facility.

At the inspection point 1107, a visual inspection will be conducted looking for pests, foreign matter visible mold. In some embodiments, a sample (e.g., 200 ml) will be taken to conduct laboratory analysis for moisture, total polyphenols, titratable acidity, ethanol, sugars, yeast and mold counts. On arrival, the pomace tends to be in the pH range below 4.0, and the moisture is approximately 40%. In some embodiments, a sample (e.g. 200 ml) will also be sent out to a third-party laboratory to analyze for pesticides according to the regulatory standards (e.g. Health Canada Standards which is currently on the order of 50). Testing for pathogenic microorganisms, is typically performed by DNA testing (PCR), rather than plating.

At step 1108, the pomace is transferred to a Kosher-Washing Station under the supervision of a Rabbi, according to embodiments. In some embodiments, a Kosher certified facility may perform some and/or all of the steps.

In some embodiments the pomace must be washed within 24 hours of the juice being expressed from the whole berries. The pomace is washed several times (e.g. seven) at 1110 until rendered Kosher. In some embodiments the water may be re-used for some of the washes, and only fresh water can be used for the final wash. For example, see FIG. 14, which describes embodiments where the water can be cleaned and recycled. The pomace is Kosher-Washed Pomace 1111.

In some embodiments, it may be desirable to dry the Kosher-Washed Pomace 1111 below a threshold percentage such as less than 10% moisture content to be rendered Kosher throughout the rest of the processing without requiring supervision of a Rabbi.

In embodiments, where the Kosher-Washed Pomace 1111 has not been dried, the Kosher Washed Pomace 1111 is milled. In some embodiments, the result of the milling is such that at least 90% of the seeds are cracked. A sample (e.g., 200 ml) will be collected 1113—inspection for broken seeds and moisture. At step 1114, the Kosher Washed Pomace 1111, will be transferred to an anaerobic fermenter. The process continues at step 1116 in FIG. 22A to 1116 in FIG. 22B.

The Inspection Point at 1117 is conducted to assess the composition of the Kosher-Washed Pomace 1111. This requires analysis of pH, fermentable sugars, and titratable acidity in order to determine the amount of fermentable sugars and nutrients to be added at step 1118. In some embodiments, it may be desirable to perform a standard paper chromatography analysis to determine concentrations tartaric acid, malic acid and lactic acid.

At step 1118, lactic acid bacterial culture and nutrients are added. At step 1120, the Kosher-Washed Pomace 1111 is fermented to generate lactic acid. At Inspection Point 1121, analysis will be conducted to measure the increase in lactic acid from the fermentation, in addition to analysis of pH, fermentable sugars, and titratable acidity to determine whether the fermentation is correct. In some embodiments, it may be desirable to perform a standard paper chromatography analysis to determine concentrations tartaric acid, malic acid and lactic acid.

When the fermentation has been determined to have been complete, the Lactic Acid Pomace 1122 can be optionally blended at step 1124. If the Lactic Acid Pomace 1122 is blended at step 1124, analysis will be conducted to measure the levels of lactic acid, in addition to analysis of pH, fermentable sugars, and titratable acidity to determine conformity with production standards. In some embodiments, it may be desirable to perform a standard paper chromatography analysis to determine concentrations tartaric acid, malic acid and lactic acid. If the Lactic Acid Pomace is not blended at step 1124, then Inspection Point 1125 may not be required.

At step 1120, the Lactic Acid Pomace 1122 is sheared to form Raw Lactic Acid Puree 1133.

At 1134, the process continues in FIG. 22C.

In some embodiments, Raw Lactic Acid Puree 1133 will be analyzed to determine whether the composition meets the KPI for the Raw Lactic Acid Puree 1133 which would be a total polyphenol content of 50-60 mg. gallic acid equivalent/g dried mass and a particle size of 92-93% passing through an 80-mesh screen. In FIG. 22C, this is indicated at Inspection Point 1127, which follows from an optional blending step 1136, only if the blending step is conducted. Otherwise, this Inspection Point would be conducted on the Lactic Acid Pomace 1122 at 1125.

At step 1140, the Raw Lactic Acid Puree 1133 is subjected to a thermal or non-thermal stabilization step in order to reduce the count of viable microorganisms. In some embodiments, the puree is heated at 90° C. for 30 minutes in an industrial kettle. In some embodiments, the puree is heated at 85° C. for one hour in an industrial kettle. In some embodiments, the objective of the stabilization process is to lower the colony forming units (CFU) to under 2,000-3,000 CFU/gram, while minimizing the loss of volatile compounds and/or damaging some of the phenolic compounds. In some embodiments, the treated pomace will be under 1,000 CFU/gram.

After the stabilization step 1140, Inspection Point 1141 will be conducted to determine if an appropriate CFU count has been attained, pH, titratable acidity, total phenolics, acetic acid. A KPI for Inspection Point 933 is a particle size 95-99% passing through an 80-mesh screen.

If the product is to be a puree, then the Raw Lactic Acid Puree 1133 will be subjected to wet processing techniques 1142, the first step of which will be a fine grind 1144. Inspection point 1146 will be to determine a particle size KPI, which could be 94%-100% of the particles passing through an 80-mesh screen, according to embodiments. Moreover, in order to determine whether the product meets the product specifications, analysis will be conducted for final inspection, pre-packaging, must include titratable acidity, pH, total phenolics, tartaric acid, malic acid, lactic acid, acetic acid. Moreover, appropriate analysis must be conducted to gather the information to be included in the Certificate of Analysis (CoA). An example of a CoA is presented in FIG. 27A and FIG. 27B for a white and red grape puree respectively.

In some embodiments the KPI for the puree product can be that the particle size is such that 95-99% of the product passes through an 80-mesh screen, the moisture content of the puree is 86-87%, the total polyphenols are 0.3% for the gold puree and 0.4% for the ruby puree. In some embodiments, the quality safety requirements include that the aerobic plate count is <10,000 CFU/grams puree, the total coliforms are <10 CFU/grams puree, yeast and mold are <1,000 CFU/grams puree. Moreover, the puree product tests negative for E. coli, Listeria monocytogenes, Salmonella spp. and Staphylococcus aureus.

At step 1151, the puree will be packaged. In some embodiments, the puree will be hot-packed, in which the product is heated such as a pasteurization temperature of 90° C. and is dispensed into the package and sealed while the contents are still hot. The package comes in a sterile condition from the manufacturer.

At Inspection Point 1150, packages will be drawn randomly from the batch, and analyzed to confirm the CoA is valid, pre-shipment. This sampling would be conducted on an appropriate periodic basis throughout the storage period, and likely within a short period of sending to a customer. At step 1152, the product is shipped to the customer.

If the product is to be a dry product, then the Raw Lactic Acid Puree 1133 will be subjected to drying processing techniques 1156. (See above for the Ethanolic Acetic Acid Fermentation Non-Kosher section for examples and details)

In some embodiments, the target objective is to generate a powder, which has between 7%-less than 9% moisture content. In some embodiments, the moisture content of the final powder is 8.5%. The objective to remain below 9% is to be compliant with GRAS, to minimize the microbe activity in addition to the water activity. The moisture content is not to be lowered below 7% to retain the activity of the compounds within the powder. In some embodiments the polyphenol retention in the powder will be between 96% and 100%, the acids and volatiles retention will be between 50% and 80%, the water activity will be below 0.85 and the particle size will be such that 100% of the powder passes through an 80-mesh screen.

At step 1158, the dried powder will be subjected to a fine grind, according to some embodiments. If the powder was dried in a spray dryer, it might not be required to conduct a fine grind.

Inspection point 1160 will be to determine a particle size KPI, which could be 94%-100% of the particles passing through an 80-mesh screen. In some embodiments, in order to determine whether the product meets specifications, analysis will be conducted for final inspection, pre-packaging, must include titratable acidity, pH, total phenolics, tartaric acid, malic acid, lactic acid, acetic acid.

In some embodiments the KPI for the powder product can be that the powder yield is >) 5%, the particle size is such that 100% of the product passes through an 80-mesh screen, the moisture content of the powder is 7-9%, the total acidity is 15%, the total polyphenol retention is 96-98%. In some embodiments, the quality safety requirements are that the water activity is <0.85, the aerobic plate count is <10,000 CFU/grams powder, the total coliforms are <10 CFU/grams powder, yeast and mold are <100 CFU/grams powder. Moreover, the powder product tests negative for E. coli, Listeria monocytogenes, Salmonella spp. and Staphylococcus aureus.

Moreover, appropriate analysis must be conducted to gather the information to be included in the Certificate of Analysis (CoA). An example of a CoA is presented in FIG. 27A and FIG. 27B for a white and red grape puree respectively.

At step 1164, the powder will be packaged, using ambient temperature packaging techniques. The package comes in a sterile condition from the manufacturer.

At Inspection Point 1165, packages will be drawn randomly from the batch, and analyzed to confirm the CoA is valid, pre-shipment. This sampling would be conducted on an appropriate periodic basis throughout the storage period, and likely within a short period of sending to a customer. At step 1166, the product is shipped to the customer.

### Instrumental Analysis

According to embodiments, the analytical parameters used to monitor the performance of the fermentation process and the quality of the final products are analyzed by analytical methodologies such as gas chromatography for ethanol and UV-visible spectrometry for carbohydrates, nitrogen nutrients, organic and phenolic acids, and titration for the total acids content. However, a faster methodology has been developed to analyze all the parameters using a Fourier transform infra-red approach calibrated for wines and supplied by Foss company, for example an OenoFoss. This device analyzes for organic acids, (acetic acid, lactic acid, tartaric acid, citric acid, malic acid), reducing sugars. It calculates pH and titratable acid, etc. When testing for sugar, the typical test is for reducing sugar, either glucose or fructose. It can be corrected with sucrose, which is not a reducing sugar. The methodologies will be adjusted and validated for the products and processes to ensure a faster and accurate analytical control that can be used in small- or large-scale processes.

### Microbial Analysis

When surfaces become contaminated with bacteria, fungi, yeasts, viruses, or other microorganisms, or “microbes,” sickness (morbidity) and, sometimes, death (mortality) may result. This is particularly true when surfaces in food processing become contaminated with microorganisms.

In food processing plants, surfaces (e.g., solid surfaces, equipment surfaces, protective clothing, etc.) may become contaminated. Such contamination may be caused by or transferred to meat or other foods. Once a surface becomes contaminated with microbes, contact with the contaminated surface may easily and readily transfer microbes to other locations, such as another surface, an individual, equipment, food, or the like.

As is well known, microbial contamination and transfer in certain environments may pose significant health risks. For example, the food that leaves a contaminated food processing plant will subsequently be eaten, and may cause sickness and, possibly, death. Microorganisms such as Listeria monocytogenes, Salmonella enteritis, and Escherichia coli O157:H7 are of particular concern.

Conventionally, environmental microbial testing includes obtaining a sample from a surface. This is typically done by contacting (e.g., wiping, swiping, etc.) the surface with a sterile sampling appliance, such as a swab or a sponge. Surfaces that are tested in this manner are usually quite clean; thus, the number of microorganisms that are picked up by the sampling appliance is typically quite low. Due to the small number of microorganisms, any microbes that are on (e.g., picked up by) the sampling appliance typically must be reproduced, or “grown” or “cultured,” to provide a sufficient number of organisms for further analysis.

A number of “rapid techniques” for conducting microbiological analysis have been developed over the years and have been reviewed by H. M. Húngaro, et al., “Overview of Microbiological Methods for Food Analysis,” Encyclopedia of Agriculture and Food Systems, 2014, herein incorporated by reference.

The microbiological analysis has been conducted in-house using plating techniques and microscopy. it is the growth of the sample in a specific culture medium and selective conditions with subsequent colorimetric and morphological identification with the aid of an optical microscope. The final product is analyzed for pathogenic bacteria, in accredited third laboratories, regarding the limits and microorganisms stipulated in the current food law.

The genetic analysis are performed, when necessary, to characterize the proprietary inoculum. Such analysis are carried out in partnership with third laboratories and/or universities and research centers.

### Pesticide Analysis

Pesticide residues resulting from the use of plant protection products on crops that are used for food or feed production pose a risk factor for public health. A comprehensive legislative framework has been established in each country which defines rules for the approval of active substances used in plant protection products, like pesticides. These rules regulate the use of plant protection products and set maximum amounts of residues permitted in food. Residue definitions are set during the evaluation process of the active substance, which may include relevant metabolites and other transformation products. Food surveillance testing programs check for compliance with maximum residue limits (MRLs), assess dietary exposure, and check for use of unauthorized pesticides. The food industry also undertakes testing of ingredients and finished products for due diligence, or product release purposes.

Pesticide analysis are carried out by accredited external laboratories as required by food law. The quality of the raw material is ensured throughout the processing on a small, medium or large scale by the internal regulations provided by the quality management, thus a rigorous control of sampling of the raw material and sending the samples to accredited laboratories, to guarantee traceability and safety of the final product, is part of the production and development operations at the current scale and must be adjusted for future scales considering the legal requirements and other requirements demanded by the different current and future legislations and certifications.

In some embodiments, the process is provided in the form of software, wherein the user inputs information and data regarding the starting product and information and data regarding the commercial specification and the software provides an optimized process.

In some embodiments of a software implementation, machine learning would assist in optimizing the programming, using the information and results of earlier fermentations.

### Sensory Analysis

In general, professional taste panels usually comprise a small group of people who have been trained to recognize specific traits. Consumer taste panels are large groups of untrained participants. For example, the wine industry VQA panelists are both screened and trained. They juice prove that in a blind tasting they can each recognize common wine flaws. Further to that, many wines contain these flaws to some degree but the panelists juice make a judgement decision to accept or disqualify a wine as commercial quality in spite of the flaw they detect. The design for Sensory Analysis and process instruction can be found in one or more books/reference manuals, such as, for example, “The Sensory Analysis of Food, Statistical Methods and Procedures.” Michael Mahoney, Food Science and Technology, 16, 1986, ISBN 9780824773373: “Sensory Evaluation of Wines” Margaret Cliff & Marjorie King, Okanagan University College Winery Assistant Course, Revised Gary Strachan 2001.

### Fermentation Processes

In some embodiments, the fermentation process is shown as a single process (as in the General Process, for example). In some embodiments, the process may be configured so that the pomace is allowed to undergo at least partial fermentation (e.g. in transportable processing containers) outside of a processing facility, before it is transported to the processing facility for the main processing (and main fermentation process) to take place. In yet other embodiments, where the overall fermentation process is carried out in the processing facility (typically where processing is centralized and on a larger, commercial scale), the fermentation process actually comprises at least two separate fermentation steps: an ethanolic fermentation step and an acetic acid fermentation step. (In some instances, the fermentation process is sometimes referred to generally or depicted as one fermentation process, for ease of reference). In some embodiments, it may be desirable to also conduct a lactic-acid fermentation in order to convert sugar into lactic acid, and thereby lower the pH of the fermented pomace.

### Ethanolic Fermentation

When ethanolic fermentation is conducted, yeast is used to convert sugars, such as glucose, fructose and sucrose in the pomace into ethanol and carbon dioxide in an anaerobic process. This increases the level of ethanol present in the processing container. The ethanolic fermentation step can be particularly important, for example, where, according to some embodiments, the pomace has been washed in order to comply with Kosher certification requirement.

### Acetic Acid Fermentation

In the acetic acid fermentation step, acetic acid bacteria, (genus Acetobacter) is used to oxidize sugars and/or ethanol in the pomace into acetic acid (e.g., vinegar) in an aerobic process.

### Lactic Acid Fermentation

When a lactic acid fermentation is conducted, an appropriate bacteria, will convert sugars, such as glucose, fructose and sucrose in the pomace into lactic acid in an anaerobic or micro aerobic fermentation.

### Mixed Fermentation

When a mixed fermentation is conducted an appropriate bacterium such as members of the family Enterobacteriaceae will convert sugars, such as glucose, fructose and sucrose in the pomace the end products produced include lactate, acetate, succinate, formate, ethanol and the gases H₂ and CO₂ in an anaerobic fermentation.

### Solid-State Fungal Fermentation (SSF)

Optionally, SSF may be considered for some processes of microbe cultivation. SSF utilizes solid substrates, such as bran, bagasse, and paper pulp, for culturing microorganisms. One advantage to this method is that nutrient-rich waste materials can be easily recycled as substrates. Additionally, the substrates are utilized very slowly and steadily, so the same substrate can be used for long fermentation periods. Hence, this technique supports controlled release of nutrients.

### Terminating the Fermentation Process

According to some embodiments, the fermentation process may be terminated when the levels of acetic acid and/or lactic acid reach a pre-determined concentration, considering the predicted stoichiometric yields and the stability of the concentration of the produced acids, within the fermenter vessel. This can be accomplished by sealing the vessel in a manner such that no oxygen can enter the bioreactor vessel. In some embodiments, the process is terminated by additionally sparging with nitrogen, argon, carbon dioxide or a combination thereof.

### Microbial Inoculum

The microbial inoculum used for each fermentation can be a single species or a mixed culture (microbial consortium or microbial community), comprising two or more bacterial or microbial groups (e.g., yeast and bacteria). In an embodiment, a mixed culture inoculum comprises bacteria, fungi (including yeast). In an embodiment, a mixed culture inoculum comprises one or more strains of yeast (yeast are facultative aerobes, which means they can primarily grow in the presence of oxygen or survive using alternative metabolic pathway such as ethanolic fermentation in the absence of oxygen) and one or more strains of bacteria. In an embodiment, a mixed culture inoculum comprises one or more strains of yeast and one or more strains of bacteria and one or more strains of fungi.

These three types of fermentation may be conducted in separate phases using different microorganisms, or they may be conducted using a mixed culture in a more simultaneous fashion.

The design for fermentation and process instruction can be found in one or more books/reference manuals, such as, for example, “Wine Microbiology”. By Fugelsang and Gump, “Food Microbiology,” “Food Fermentations,” “Indigenous Fermented Foods,” or “Food Microbiology: Fundamentals and Frontiers”, edited by Michael P. Doyle, Larry R. Beuchat, and Thomas J. Montville.

### Commercial-Scale General Process

The General Process as shown in FIGS. 1 & 2 describes steps that may be performed in the conversion process, which may be applied to the pomace derived from fruit winemaking (e.g., grapes), according to some embodiments.

### Step I: Directly or Indirectly Transfer Pomace to the Processing Container

The first step in the winery derivative bioconversion process is to transfer pomace to a container 302.

In some embodiments, the pomace will be directly transferred to a transportable processing container 418. In some embodiments, the pomace will be transferred to a transport container 702, by means of which the pomace is delivered to a processing facility or site.

In some embodiments, the pomace will be inspected to check that it will be appropriate for use prior to transporting to the initial processing site/location. The pomace will be inspected by sensory analysis (e.g., visual, smell). If toxic spoilage is detected, the pomace will be refused. According to some embodiments, the transportable processing container 418 or the transport container 702 will be sealed. In some embodiments, an inert gas is supplied to inside of the covered container to delay oxidative deterioration (spoilage) of the pomace and extend the time in which it can be transported and processed.

One example of a process for transferring pomace to a processing container, described below with regard to Kosher certification, would be to collect pomace from a winery and rapidly transfer it (e.g., within 24 hours) to a processing location, where it could be rinsed a number of times (e.g., 7 times) with potable water.

### Storing the Pomace

In some embodiments, it may be desirable to store the pomace as it is being received at a central processing facility, as each varietal pomace becomes available on the day that the winery starts crushing their fruit.

Grape pomace will arrive at our facility according to the maturity date of individual grape varieties and the region in which the grapes are grown. This is a predictable progression in which at a given date most receipts will be of only one variety. For example, Pinot Gris is an early ripening grape variety and will be harvested prior to a mid-season variety such as Chardonnay, or a late season variety such Riesling. In North America the “crush season” typically begins mid-August and ends around mid-November.

Common techniques for storing the pomace, include cold or frozen storage, pasteurization and maintenance in a sanitary air tight container, and storage under an inert gas, etc. The design for appropriate pomace storage techniques and process instruction can be found in one or more books/reference manuals, such as, for example, “Handbook of Food Preservation,” edited by M. Shafiur Rahhman.

In some embodiments, the pomace is submerged in sufficient water such that the pomace will remain under water to deter the growth of mold as the pressed berries re-hydrate. The pomace may be fully hydrated or not fully hydrated at the end of this step.

### Step II: Prepare Pomace for Fermentation

In some embodiments, if the rehydrated (fully or partly) pomace is not in a fermentation vessel, it will be transferred to an appropriate vessel in which to conduct the fermentation. If not in a fermentation vessel—transfer to fermentation vessel.

In some embodiments where the pomace is from a white wine production or other kind of wine production that has not undergone a fermentation, a natural fermentable sugar and yeast may be added to create a certain level of ethanol in the container.

The material may be analyzed for pH, which might require an adjustment to an appropriate level. It may also be analyzed for yeast available nitrogen (fixed nitrogen). It may be desirable to add a commercial yeast nutrient and/or lees and/or a fermentable natural sugar. Other possible additives include one or more organic acids, for example, malic acid, tartaric acid, acetic acid or citric acid. In an embodiment the pomace is blended with other sources of pomace to optimize the conditions, for example to optimize color and the phenolic profile.

In some embodiments, lees are added to support the ethanolic fermentation. The lees (dead yeast cells) can be lysed and used as source of nutrients in the process of the ethanolic fermentation. In this manner, the cellular components of the lees are recycled to become intracellular nutrients for the yeast during the ethanolic fermentation.

It may be desirable to grind the pomace in order to increase the surface area of the pomace to the fermentation conditions.

In some embodiments, wherein the fermentation is conducted off-site, the grinding process might involve the use of a portable puréeing device that is inserted into the tank, which shreds the skins and pulp, and cuts up the seed, allowing the microbial “cocktail” to attack the grape skin particles, pulp, seed pulp and bruised husk. In some embodiments, a macerating pump, may be reversibly attached to the spigot that draws out the material, passing it though a grinder, and then pumping it back into the top of the container. In some embodiments, the grinding process is conducted after the acetic acid fermentation.

### Step III: Ferment the Pomace

One skilled in the art of fermentation would know which factors would be most relevant to the type of nutrient-rich product they are seeking to generate. The design for fermentation and process instruction can be found in one or more books/reference manuals, such as, for example, “Wine Microbiology”. By Fugelsang and Gump, “Food Microbiology,” “Food Fermentations,” “Indigenous Fermented Foods,” or “Food Microbiology: Fundamentals and Frontiers”, edited by Michael P. Doyle, Larry R. Beuchat, and Thomas J. Montville.

A microbial consortium is added to conduct the acetic acid fermentation, which is generally allowed to proceed until the pH reaches approximately pH 3.2 to pH 4.3. In an embodiment, the range for an acceptable pH is between pH 3.5 to pH 4.0.

### Step IV: Comminuting (Grinding, Shearing) Fermented Pomace

The fermented pomace is comminuted (ground, sheared, etc.) to attain a homogeneous, non-gritty texture. In some embodiments, the comminuting step will reduce the particle size to approximately 0.001 mm.

### Grinding in a Commercial Facility

Grinding could be conducted both prior to fermentation (coarse grind) and after fermentation (fine grind). There are many grinding techniques, which can be done on a continuous basis, such as when the pomace is being transferred into the fermenter. One could control the size of the particles and the flow rate in a continuous process. One would also typically use a screen to ensure the particle size is down to the pore size of the screen.

The pre-fermentation grind, releases the lipids and the phenolics and proteins.

In one embodiment, (although it takes a lot of time and energy) the fine grind could be conducted prior to the fermentation.

The pomace would be pumped into a grinder in a continuous flow. One could use, for example, a peristaltic pump, a progressive cavity pump, a centrifugal pump or a flexible impeller pump. A peristaltic pump is a tube with rollers that compress the tube. A progressive cavity pump is a long skinny with a screw in the middle.

There are a number of commercially available grinders that may be used, including a hammer mill or a colloid mill.

### Step V: Adjust to Commercial Specifications

There are a number of possible adjustments that can be performed at this stage in order to bring the characteristics of the commuted, fermented pomace in line with commercial specifications and/or desired characteristics. Ingredients can be combined with the commuted, fermented pomace in order to refine it in a manner to conform to commercial specifications. (Note that in general, it would be preferable to make adjustments by blending, but if that cannot be accomplished, then this could be done by adding ingredients).

One method for changing the flavor is changing the acidity and the astringency. Changing the acidity simply involves adding acid to it to make the fermented product more sour (acidity equates to sourness). Astringency relates to the phenolic compounds; to change astringency, one can add phenolics—or one could lower phenolics by using a fining agent such as gelatin or the vegan approach of using pea protein to bind some of the phenolics (protein-tannin binding)—a proteinaceous binding agent.

The material may be analyzed for pH, concentration of phenolics, color, acetic acid content, and/or other organic acids, optimized ratio of protein/phenolics, depending on the nature of the protein. It may be desirable to adjust the pH, for example by adding acetic acid.

In some embodiments, non-fermented comminuted pomace can be added and blended in order to achieve target composition, polyphenol, lactic acid and malic acid profile. It may also be desirable to blend the comminuted fermented pomace with another comminuted fermented pomace.

In some embodiments, it may be appropriate to apply product specific processing to conduct a controlled Maillard reaction. For example, it the product objective is to prepare a sauce such as a Worcestershire sauce, soy sauce, chocolate, or coffee, for example.

### Deglycosylation

In some embodiments, the fermented biomass is heated in order to deglycosylate the glycosylated polyphenolic molecules and thereby increase the amount of bioavailable phenolic compounds in the final product.

### Step VI: Prepare for Packaging

In order to prepare the product for packaging, it may be desirable to terminate the microbes using a process that minimizes damage to the phenolics.

There are applications for both a pasteurized purée (with no bioactive materials) and a probiotic purée. High-pressure pasteurization technology may optionally be used to create a pasteurized nutrient-rich product, other although current or future heat-treatment/pasteurization techniques may be employed. The bioactive purée will have been fermented to an approved pH level for sealed storage at room temperature, refrigerated temperature, and/or frozen.

In some embodiments, it may be desirable to change the state of the product from a slurry to a paste or a powder.

In some embodiments, it may be desirable to conduct a drying step to reduce the amount of water present in the final product. There are a number of methods of drying known in the art, which include, for example, vacuum drying, microwave-assisted drying, ultrasonic-assisted drying, spray-drying, drum drying, freeze drying, solar drying, etc. Another method that is used in winemaking to remove yeast and bacteria is tangential flow filtration. In some embodiments, if tangential flow filtration is conducted before drying to reduce the amount of water content, it will reduce the energy required to dry the product to a powder.

### Drying Technologies and Methodologies

### Vacuum Microwave Drying

Vacuum microwave drying, also known as radiant energy vacuum (REV), is a rapid method that can yield products with improved quality compared to air-dried and freeze-dried products. Because the drying is done under reduced pressure, the boiling point of water and the oxygen content of the atmosphere are lowered, so nutritional components sensitive to oxidation and thermal degradation can be retained to a high degree.

In general terms, dehydrating a food product using vacuum microwave drying is performed by exposing the food product to a selected vacuum pressure and to microwave radiation in a vacuum chamber for a selected residence time, thereby heating the product and reducing moisture to a desired level. In an embodiment, the process is done on a continuous-throughput basis, in which the product is fed into a vacuum chamber and conveyed through the vacuum chamber from an input end to an output end, for a selected residence time, during which microwave generators irradiate the product with microwave radiation. In another embodiment, the process is done on a batch basis, by loading the vacuum chamber, processing the product and then opening the vacuum chamber to remove the dried product.

Suitable microwave power densities are in the range of 100 to 3000 KW per kg of food product. Lower power densities will eventually dry the product but require too long a drying time to be commercially practical. Residence times in the vacuum chamber will range.

Examples in the patent literature include U.S. Pat. No. 6,312,745 (Durance et al.), which discloses the production of dehydrated berries. WO 2018/187851 (Durance et al.) discloses a vacuum microwave drying process in which a porous, crunchy, dehydrated food product is made by freezing a food product and exposing it to microwave radiation in a vacuum chamber at a vacuum pressure at which the boiling point of water is above 0° C., to thaw the frozen food product and evaporate liquid water from the thawed food product, resulting in a crunchy, dehydrated food product with a highly porous structure. It is also known in the food processing industry to dehydrate food products by freeze-drying, in which the process is conducted at very low pressures and temperatures and moisture is removed by sublimation. Freeze-drying can produce a high-quality product but it has the disadvantages of being slow and expensive.

Pulsed electric field (PEF) treatment can be used to increase cell permeability of food products and thereby enhance dehydration. It can be used as a pre-treatment prior to freeze-drying, to reduce the energy required by the freeze-drying process. See, for example, Henry Jaeger et al., “PEF Enhanced Drying of Plant Based Products,” Stewart Postharvest Review, September 2012; and Zhenyu Liu et al, “Influence of Pulsed Electric Field Pretreatment on Vacuum Freeze-dried Apples and Process parameter Optimization,” Advance Journal of Food Science and Technology, 13 (6): 224-235, 2017.

US Patent application No. 2021/021,2347 (Zhang) or Ser. No. 17/247,558 discloses how food products can be dehydrated by means of a process which includes pre-treatment with PEF, freezing, and drying in a vacuum microwave chamber under conditions in which the product is thawed in the vacuum chamber and liquid water is removed by evaporation, resulting in a product that is superior to a freeze-dried product. The process is much faster than freeze-drying and consumes less energy. The PEF in conjunction with vacuum microwave treatment does not result in structural damage to the product, despite the thawing of the frozen product during the drying process, which is believed to be due to the thawing being carried out under vacuum.

### Radio Frequency Drying

One low-energy solution heating method for heat assisted drying in the agricultural industry is to utilize radio frequency electromagnetic waves to heat agricultural biomass. Radio frequency heating lowers the amount of energy consumed during heating because radio frequency electromagnetic waves induce water molecule friction within the biomass itself. Water molecule friction within the biomass creates heat and, therefore, water evaporation. The frequencies generally used in heating can range between 3 kHz and 300 GHZ. Because the heat is created from within the biomass as opposed to externally applied heat that must travel from the exterior of the biomass to within the kernel, there is minimal heat losses to ambient air and the drying bin apparatus. Minimizing heat losses creates higher energy efficiency within the drying process.

There is yet an additional draw back to conventional heat assisted drying and that is heat damage. Heat damage is a significant issue within the agricultural harvest crops because of its high occurrence and impact on yield. Heat damages harvest crops by breaking/cracking, discoloring, and shrinking grains or kernels of the harvest crop. While radio-frequency type heat assisted drying improves energy efficiency, heat damage is still an issue. Because conventional radio frequency type heat assisted drying utilizes the heat created by water molecule friction to evaporate the water molecules, heat damage is still an issue.

U.S. Pat. No. 10,962,284 (Heine) provides a system to address both the issues of high energy consumption and heat damage in agricultural biomass drying, using radio frequency drying. In particular, systems and methods of drying biomass using radio frequency waves while maintaining low temperature, specifically, using radio frequencies falling on the lower end of heating type radio frequencies, for example 13.56 MHz. The system and method includes minimizing temperature increases caused by dielectric radio frequency heating while increasing intermolecular hydrogen bond disruption.

In some embodiments, a system for low end type radio frequency grain drying, e.g., 13.56 MHz, includes various apparatus for subjecting materials to electro-magnetic energy by using radio frequencies. The system includes a radio frequency generator capable of creating radio frequency electromagnetic waves around 13.56 MHz, a receptacle for the biomass, which can also be electrically conductive. The system also includes a plurality of metallic injectors, electrically coupled to the radio frequency generator through an automatic tuner and in direct contact with the biomass in the receptacle.

U.S. Pat. No. 11,243,027 (Eichhorn) provides a new method for removing moisture from a variety of materials including agricultural biomass products employ propagating transverse electromagnetic modes through a material to break its hydrogen bond with water and push the moisture content out of the material using gravity or forced air. Since the disclosed moisture-removal systems do not remove water from a material by evaporation, the drying can occur at low temperatures and any heat damage to the material can be avoided.

### A Non-Thermal Process for Generating a Powder

Another way to convert the pomace to a powder is by immobilizing it with an agent such as agar, protein or pectin. Once the solid has been created by the addition of one of these agents, the solid can be ground to a powder which then contains all the original aroma and acidity of the initial pomace puree.

### A Process Example

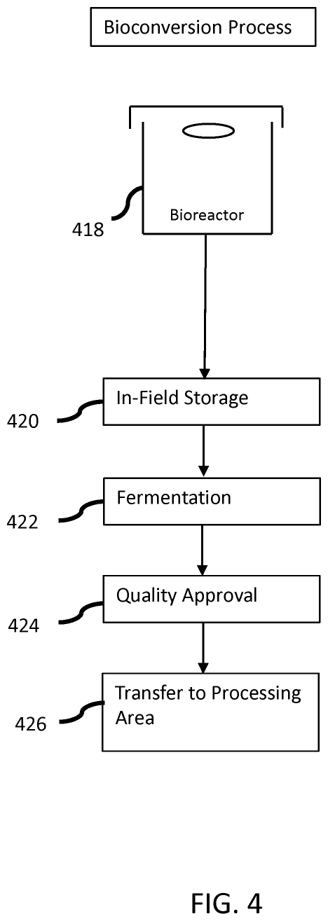

Another example of a process, according to some embodiments, is described with reference to FIGS. 4-7. In this embodiment, the fermentation of the pomace is carried out, at least in part, at a location outside of the processing facility (e.g. out in the field or at a winery); this is in contrast with other embodiments described herein, where the pomace processing is centralized and the fermentation steps are carried out in the processing facility (including the commercial scale general process, where the ethanolic and acetic acid fermentation steps are carried out in large-scale fermenters within the processing facility).

FIG. 4 illustrates an embodiment where the pomace is placed in a processing container 418, and transferred to a field 420 for the fermentation 422. When the fermentation has been completed, the fermented pomace will be tested for quality approval 424 and transferred to the processing area 426.

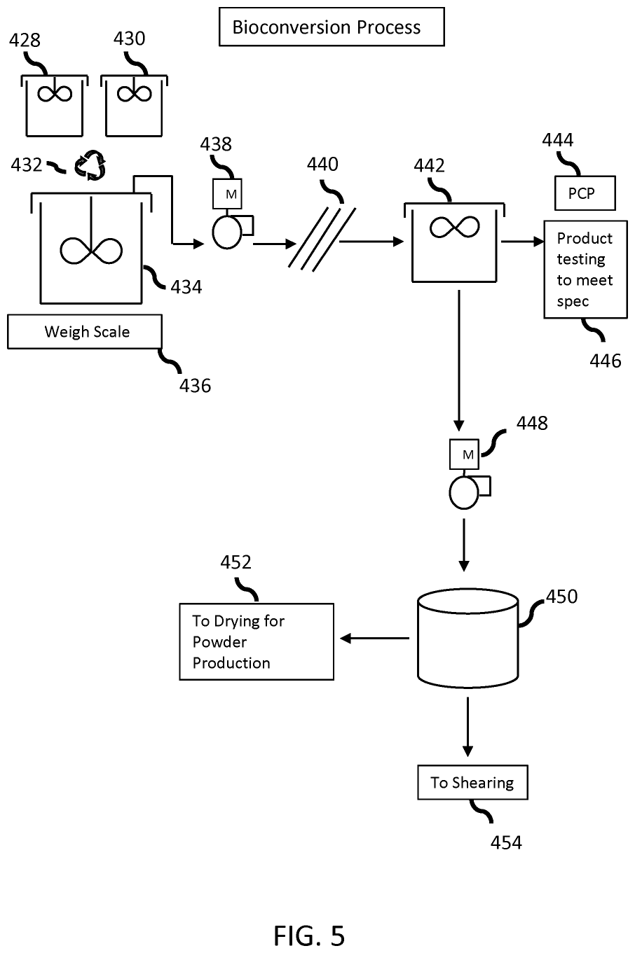

In some embodiments, the fermented pomace is blended according to varietal recipes. For example, as illustrated in FIG. 5, a portion of Varietal I 434 is weighed on a scale 436, pumped 438 through a screen 440 into a blending tank 442. This process is repeated with Varietal II 428 and Varietal III 430. When the fermented pomace in the blending tank 442 has been tested and meets the specifications required at this stage 444 & 446, it will be pumped into a tank 450, and either sent to be dried for production of a powder product 452 or sent to be comminuted (sheared) 454.

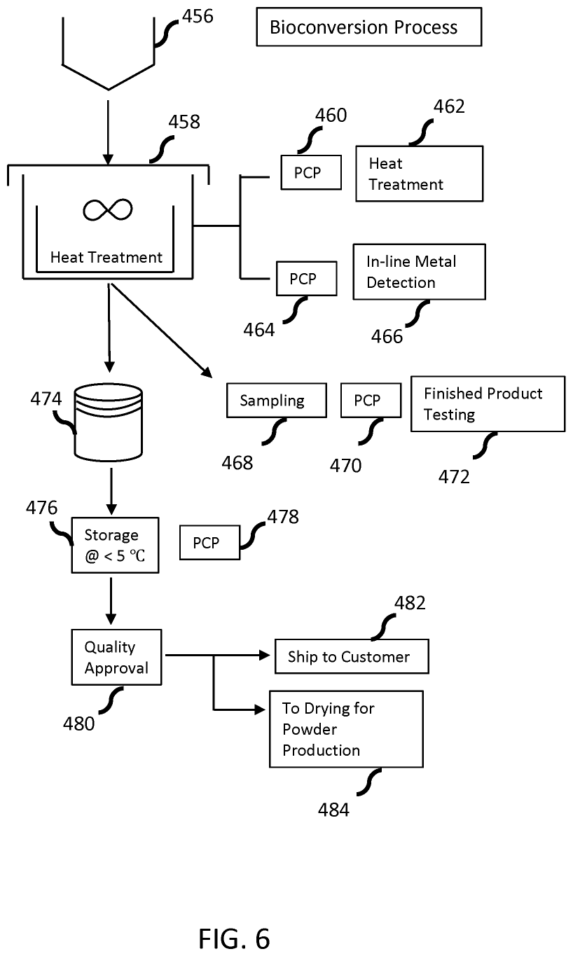

In some embodiments depicted in FIG. 6, the biomass is sheared 456 and subjected to a heat treatment 458, after which it may be packaged 474 and placed in cold storage 476. If the product has met the quality approval standards 480, it is either sent to a customer 483 or subjected to a drying process in order to convert the product to a powder.

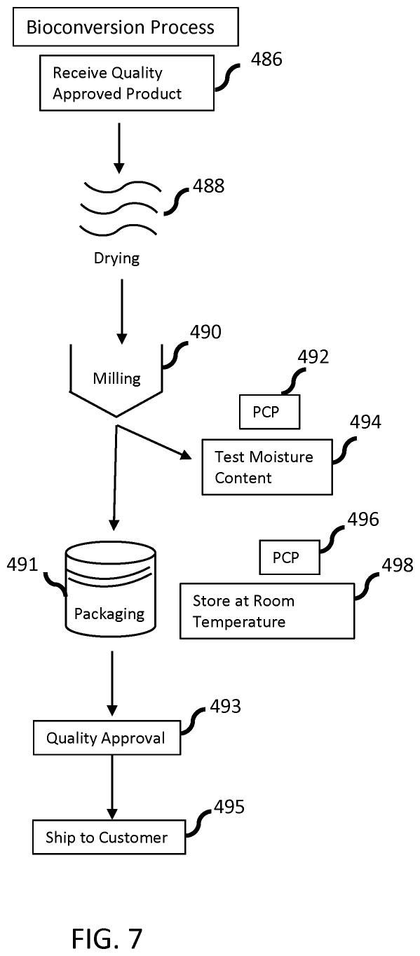

In some embodiments, depicted in FIG. 7, the product to be converted into a powder 486 is dried 488, milled 490, packaged 491, and stored at room temperature 498. After being tested for quality approval 493 is shipped to the customer 495.

### An Example of a Process for Kosher Certification

Kosher food is defined in accordance with Jewish religious law, which is set down in the Torah, the centerpiece of the Jewish faith. The word kosher signifies everything that has been produced or prepared according to Jewish law. Kosher diet follows the rules of kashrut (Jewish dietary laws). In accordance with kashrut, only four-footed animals that chew their cud and have cloven hooves may be eaten. This excludes pigs or hares, for example. Poultry, by contrast, is kosher. Of fish, only those that have fins and scales may be eaten. The rules also include using separate pots, cutlery and dishes for these foods.

Traditional rabbis prohibited any item of food that had been used in the service of an idol or had been consecrated to an idol. The kashrut laws state that if a wine might have been used for idolatry, it cannot be considered kosher. Yayin nesekh is the traditional term for the prohibition against drinking non-Jewish wine. Wine that has been heated, yayin mevushal, becomes unfit for idolatrous use so can be regarded as drinkable. Moreover, a number of wine producing countries now produce kosher wines, for example, Israel, the United States, France, Germany, Italy, South Africa, Chile, and Australia.

There are a number of methods for processing a foodstuff so that it will meet the requirements for Kosher Certification. The design for rendering the production equipment and processes ready for Kosher Certification can be found in one or more books/reference manuals, such as, for example. “Kosher Food Production (second edition). Zushe Yosef Blech. Wiley-Blackwell. A John Wiley & Sons Ltd. Publication. 2008. ISBN 978-0-8138-2093-4.

In some embodiments, the process will be performed in a manner such that the final product can be certified as being Kosher. Food ingredients can be classified into three groups with regard to Kosher products: ingredients that are considered to be inherently Kosher; ingredients which can be produced in a Kosher or non-Kosher manner; and ingredients which are not acceptable for use in Kosher products. If the process is followed to render the product as being Kosher certified, then all the processes and additives used in the process will be either certified as Kosher or not required to be certified Kosher, but will be verified as being appropriate for use in a Kosher product.

In some embodiments, the version of the process is designed so that the product can be certified as Kosher. Some examples of modifications to the process include: washing the pomace a minimum of seven times prior to commending the bioconversion process; kosherizing the processing equipment, supervision of the material handling by a Rabbi at various stages such as, for example, harvest, during the fermentation, finishing/processing; and drying the product to a moisture level that is less than 10%.

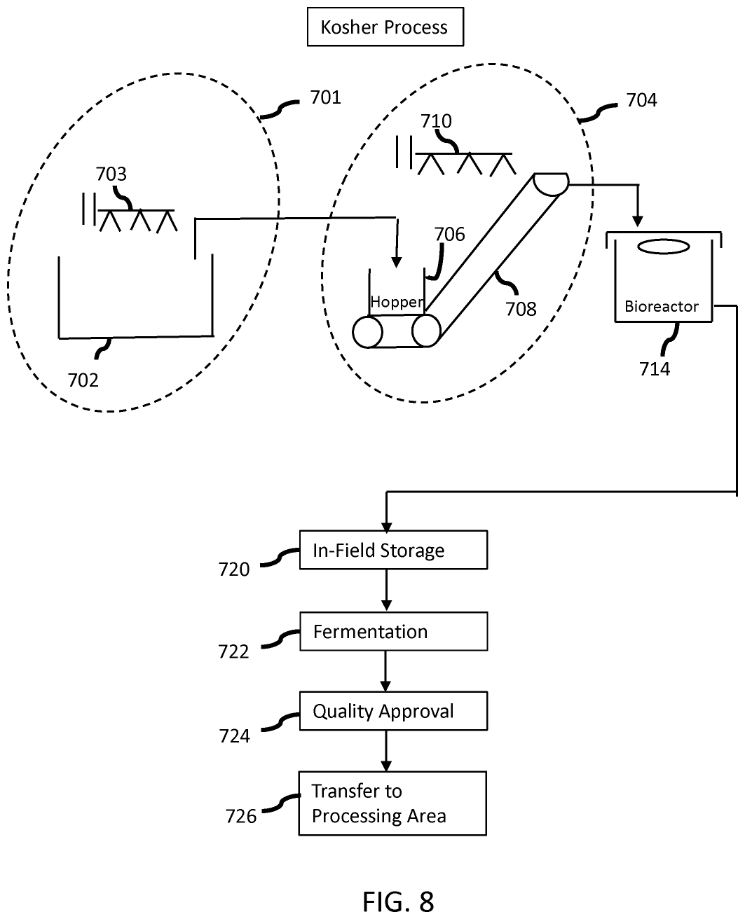

Embodiments of a process for bioconversion, wherein the final product may be certified as Kosher (e.g., quality for Kosher certification) is presented in FIGS. 8-11.

### The Kosher Washing Station

The initial steps of the process for Kosher certification is described with reference to FIG. 8, according to one embodiment.

In some embodiments, if non-Kosher grapes were used to generate the pomace, the pomace can be treated prior to fermentation by a Kosher Washing Station 701, comprising a washing container 702 and a wash bar 703 located above the container and configured so that the pomace is thoroughly washed during each wash cycle. In some embodiments, the pomace is washed with water, wherein the ratio of water:pomace is 7:1 by volume (for example, for 250 L of pomace, 500 L of water can be sprayed over the pomace. The wash bar 701 and wash container 702 have been designed so that when the pomace exits the wash container 702, it is suitable to be Kosher certified.

In some embodiments the wash must be conducted within 24 hours of pressing the fruit (i.e., crush).

In some embodiments, the water used in the Kosher Wash System 701 is potable water. In an embodiment, the water used in the Kosher Wash System 701 has been filtered. In some embodiments, the water used in the Kosher Wash system 701 has been pre-treated in some manner to render the pomace washing step sufficient to render the pomace Kosher certifiable upon exit of the Kosher Washing Station 701.

In some embodiments, the Kosher Washing Station 701 is located at a fermentation location. In some embodiments, the Kosher Washing Station 701 is positioned on a truck or other vehicle, such that it is a mobile Kosher Washing Station 701. In some embodiments, the Kosher Washing Station is located at a central processing facility.

In some embodiments, the water that has been washed over the pomace is collected from the washing container 702 and recycled for future use within the Kosher Washing Station 701. In some embodiments, the water used to wash the pomace must be drained from the pomace and can be recycled up to three times for the first 6 washes, but then clean water is used for the last wash (the 7^{th}), and is allowed to drain prior to transferring to a Kosher Transfer Station 704.

### The Kosher Transfer Station

In some embodiments, a Kosher Transfer Station 704 comprises a hopper 706 for receiving pomace, a conveyor 708, and a water-spray system 710. The Kosher Transfer Station 704 comprises suitable conveyor 708, for example, a screw conveyor/auger conveyor positioned within a trough. In an embodiment, the conveyor 708 is a screw conveyor/auger conveyor. In some embodiments, the conveyor 708 is inclined upwards so as to elevate and deliver the contents by gravity to another container located below the end of the conveyor 708 that is opposite to the hopper 706.

A water spray system 710 is located above the conveyor (e.g., trough), comprising a plurality of spray jets, linearly disposed and aligned with the conveyor trough so as to spray the pomace as it is transported along the conveyor 708.

In some embodiments, the washed pomace is delivered from the conveyor 708 into a kosher-process bioreactor 714, which has been kosherized, and transferred to a field 720 for the fermentation 722. When the fermentation has been completed, the fermented pomace will be tested for quality approval 724 and transferred to the processing area 726.

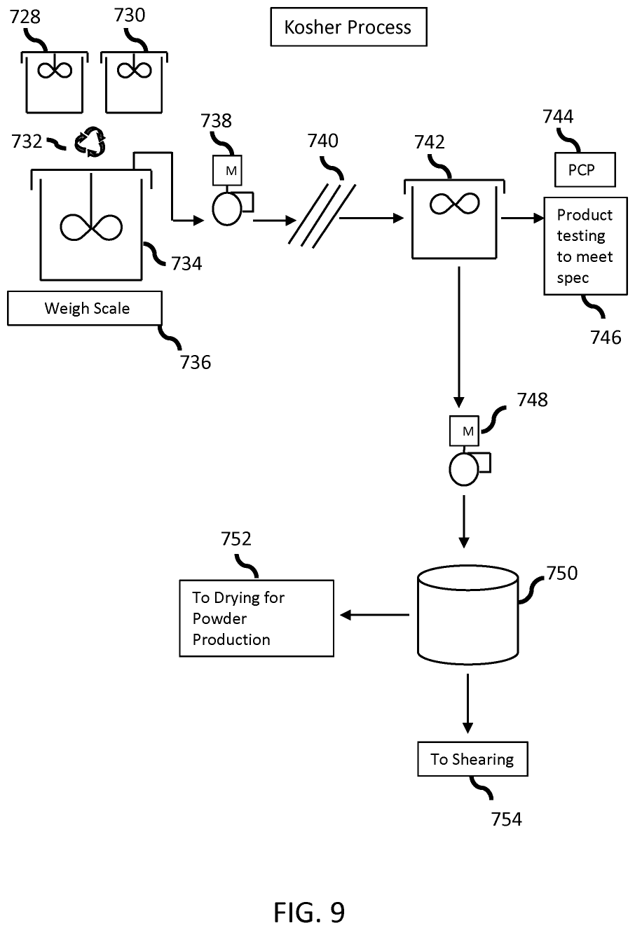

In some embodiments, the fermented pomace is blended according to varietal recipes. For example, as illustrated in FIG. 9, a portion of Varietal I 734 is weighed on a scale 736, pumped 738 through a screen 740 into a blending tank 742. This process is repeated with Varietal II 478 and Varietal III 730. When the fermented pomace in the blending tank 742 has been tested and meets the specifications required at this stage 744 & 746, it will be pumped into a tank 750, and either sent to be dried for production of a powder product 752 or sent to be comminuted (sheared) 754.

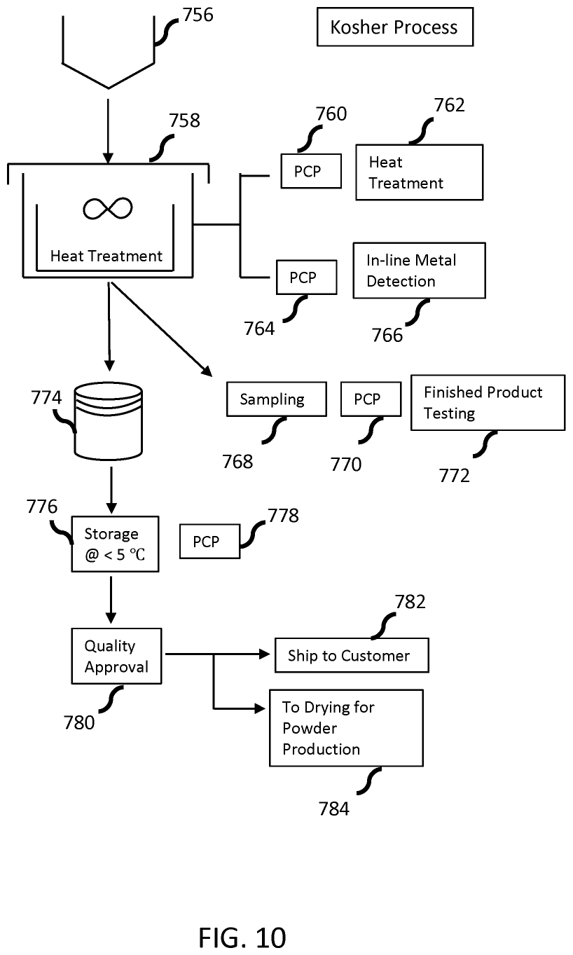

In some embodiments, as depicted in FIG. 10, the biomass is sheared 756 and subjected to a heat treatment 758, after which it may be packaged 774 and placed in cold storage 776. If the product has met the quality approval standards 780, it is either sent to a customer 783 or subjected to a drying process in order to convert the product to a powder.

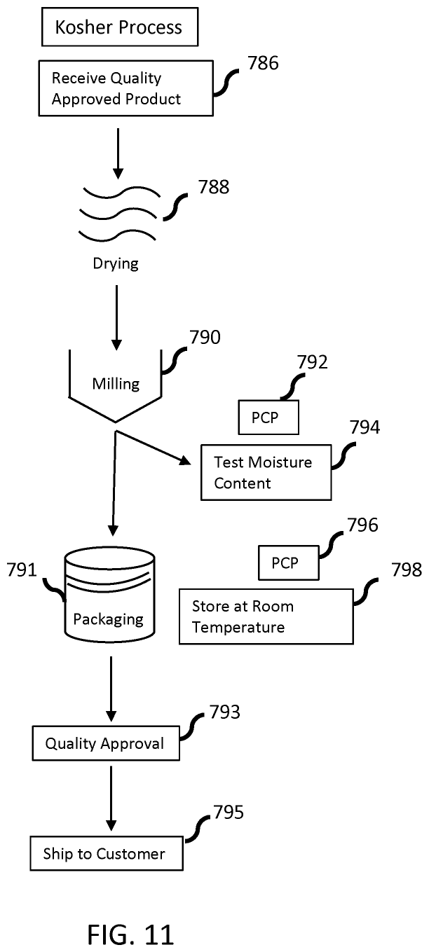

In some embodiments, as depicted in FIG. 11, the product to be converted into a powder 786 is dried 788, milled 790, packaged 791, and stored at room temperature 798. After being tested for quality approval 793 is shipped to the customer 795.

### The Nutrient-Rich Product

According to some embodiments, the nutrient-rich product can be used to improve the surface contact between the palatial sites of the tongue and food substances, thereby increasing the basic tastes: saltiness/sweetness/bitterness and sour, because they are sensed by the tongue. Without being bound by any theory, some of the polyphenols in the product form complexes with the proteins in the coating of the tongue, thereby “unmasking” the pellicle covering.

Thus, the nutrient-rich product can be used in food preparation, to, for example: a) reduce the amount of sodium in a food formula; b) reduce the amount of sugar in a food formula; c) preserve dairy, meat, condiment and cereal nutrient-rich products; d) enhance the flavour of fruits, vegetables, and spices within a food formula; e) provide significant nutrient value to a food formula; f) provide a source of yeast and other bacteria to cause the leavening of bread; g) provide a source of bacteria to cause the fermentation of dairy nutrient-rich products; and/or h) provide a source of bacteria to cause the fermentation of plant-based proteins.

The nutrient-rich product may also be used to provide a medium for extraction of nutrients for pharmaceutical use in addition to provide a medium for topical applications in cosmetics or skin therapy.

It is contemplated that the resulting nutrient-rich product may be used to address some of the key challenges in the food & beverage industry. Depending on the use case, some of the potential benefits include, for example: (a) significant sugar reduction (by 50%+); (b) substantial calorie reduction; (c) deep sodium reduction by as much as 80%; (d) natural shelf-life extension by 55%+; (e) effective masking of bitter notes and off flavors (e.g., pea protein); (f) improved texture and mouthfeel; (g) cost savings dependent on application; and (h) enriched nutritional value with phytonutrients and antioxidants.

Use of the nutrient-rich product (for example, in puree or powder form) as an ingredient in a number of different foods has demonstrated cross-functional impact across the board, such as: (a) flavor enhancement; (b) masking off notes; (c) deep sodium reduction; (d) significant sugar reduction; (e) moisture & lipid binding; (f) improved texture and mouthfeel; (g) lipid oxidation prevention; and (h) natural shelf-life extension. The addition of the nutrient-rich product (either in puree or powder form) as an ingredient to various food products has been validated in taste tests/sensory comparison tests, for a variety of use cases. Some examples of these test/studies are outlined below. The increased functionality is a result, in many cases, of the total phenolics (polyphenols) in the nutrient-rich product. It has been confirmed from testing of the red grape powder and white grape powder blends, for example, that polyphenols are present in high concentrations (resulting in increased antioxidant activity).

### Sugar Reduction

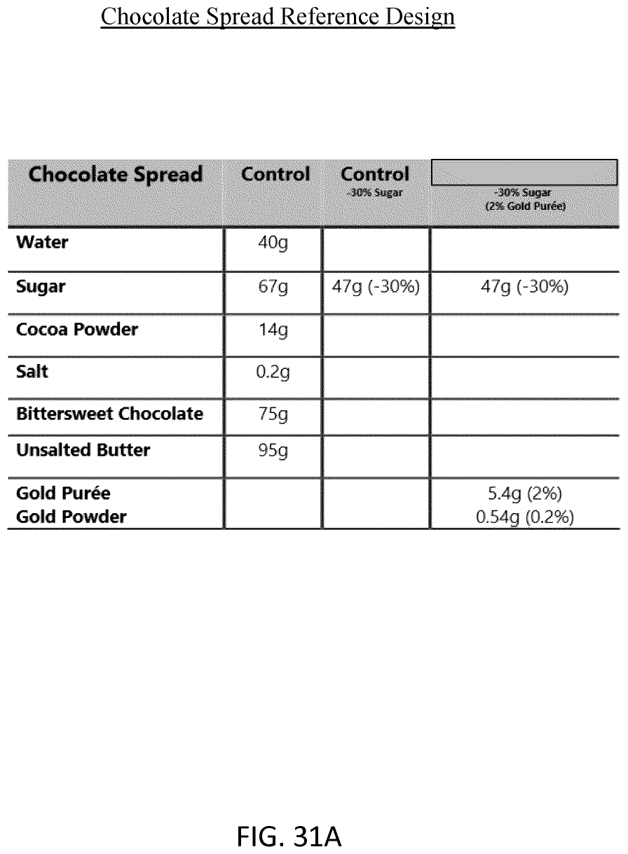

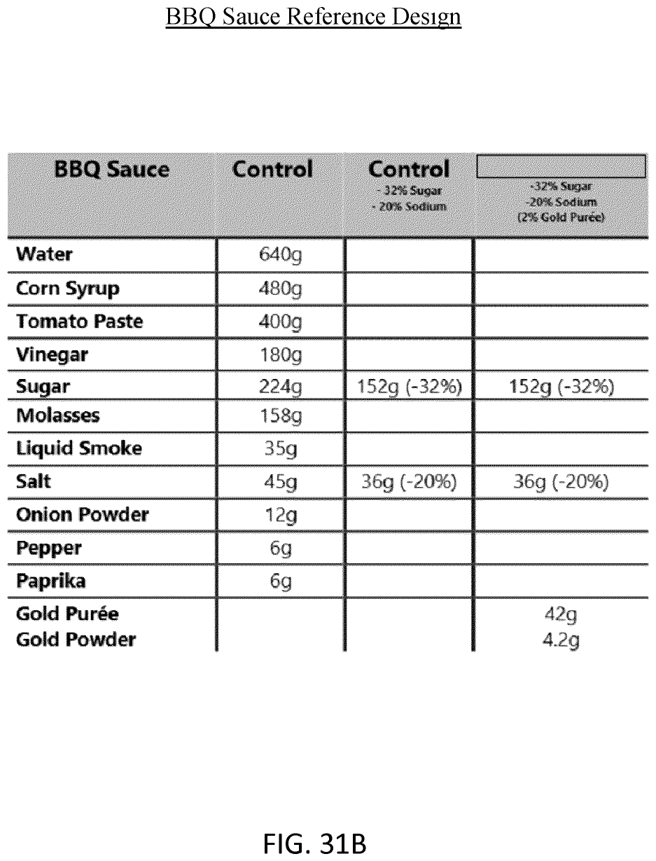

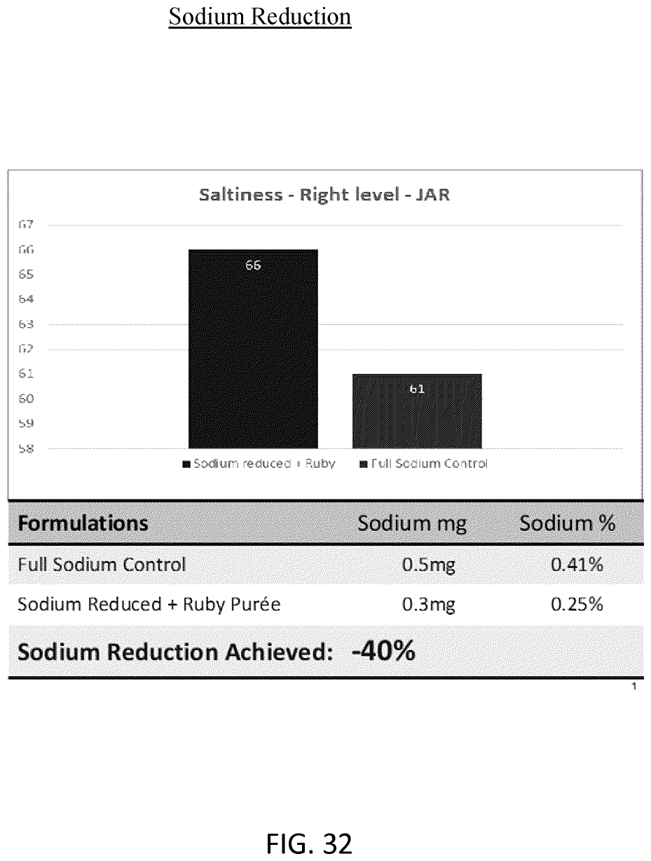

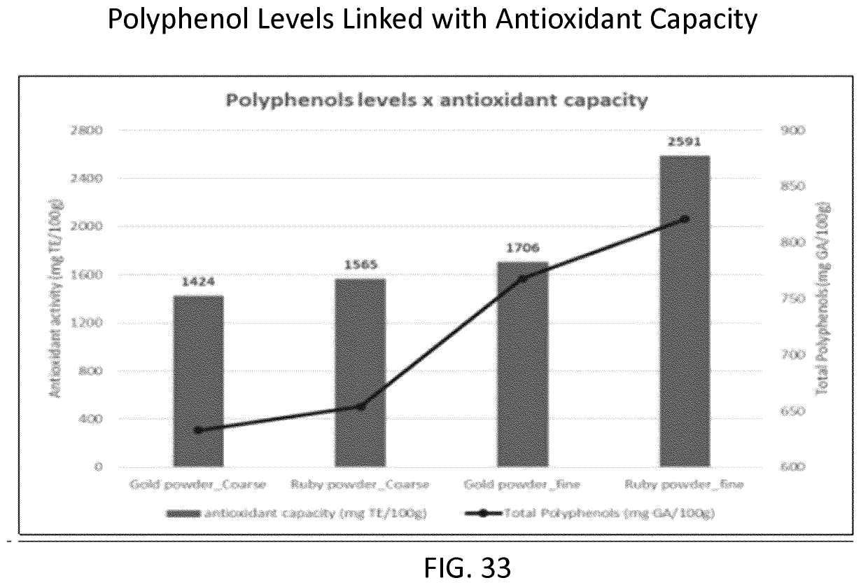

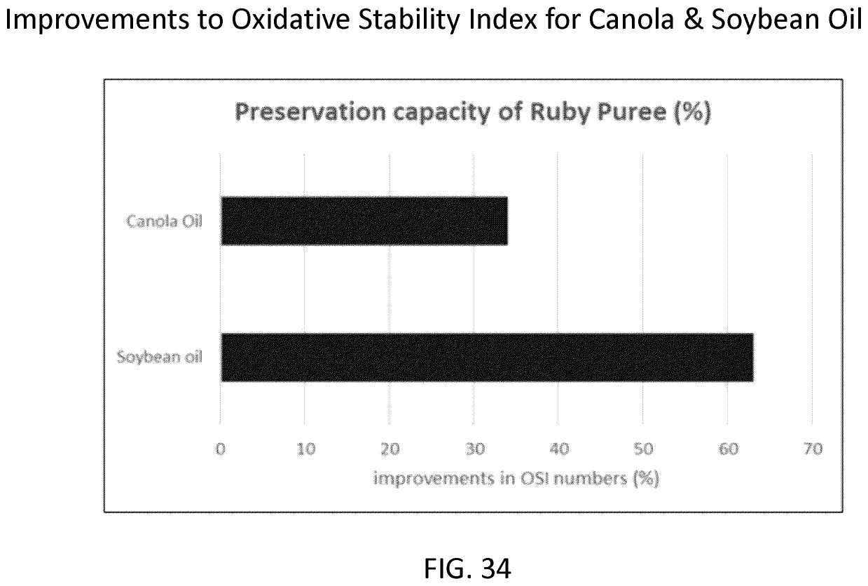

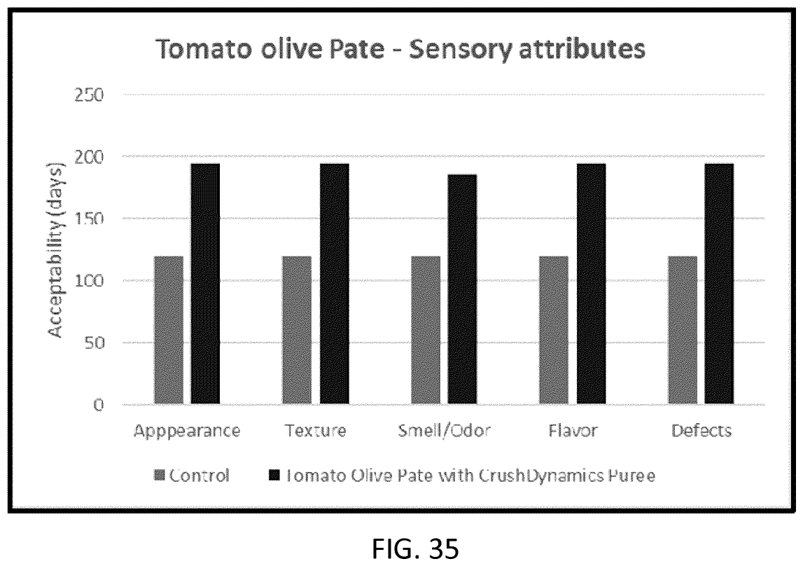

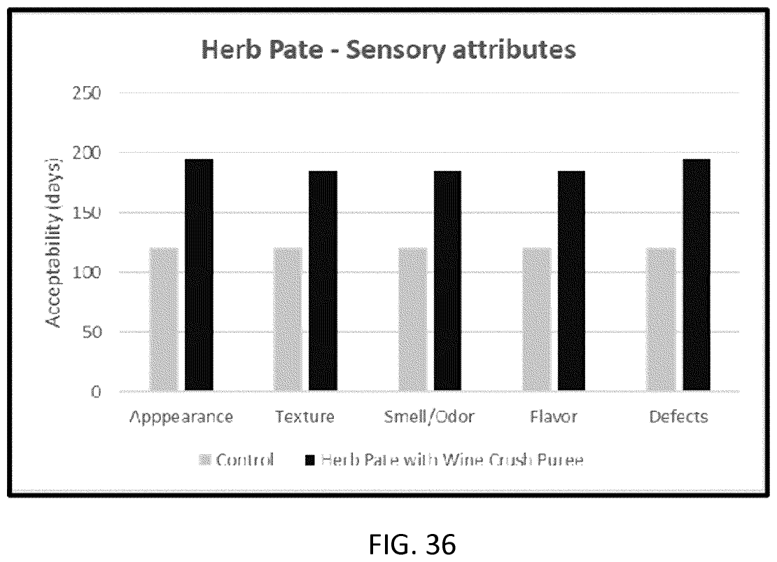

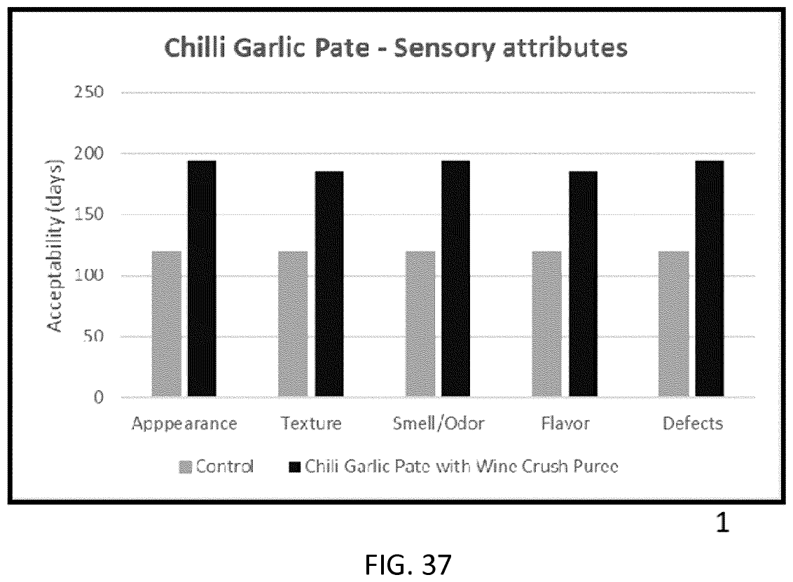

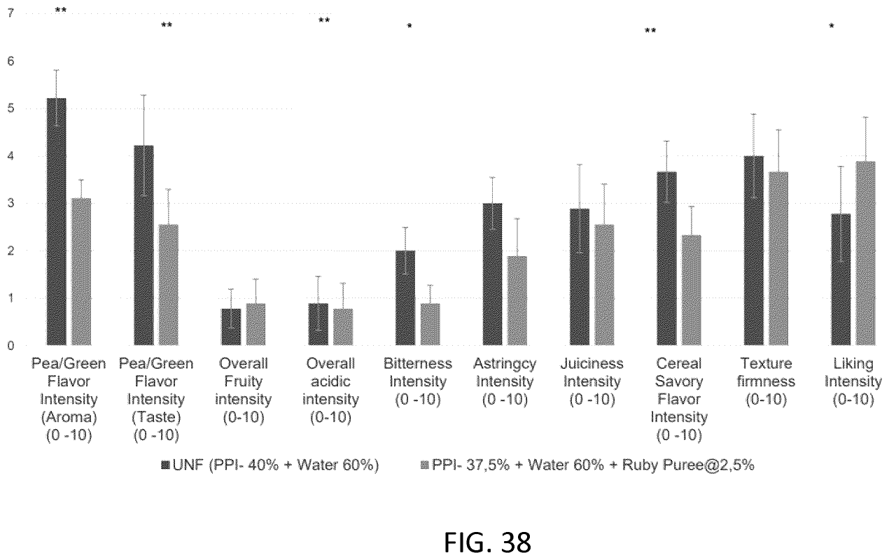

The addition of a white grape puree/white grape powder blend (2%) to chocolate spread demonstrated that the puree delivers on some of the most important attributes of flavor, while allowing for significant improvements in nutrition. The chocolate spread formulation allowed for a 30% reduction in added sugar and provided substantial enhancement to flavor. Other benefits included contributing a velvety appearance and texture. Formulation highlights included: 30% reduction in sugar; 20% reduction in carbohydrates; added polyphenols and antioxidants; and added calcium. (See also FIG. 31A).

A similar study on the use of the puree in condiments and sauces also showed that it delivers on some of the most important attributes of flavor, while allowing for significant improvements in nutrition. Adding the while grape puree/white grape powder to a barbeque sauce allowed for a 32% reduction in sugar, 20% reduction in salt and provided a substantial enhancement in both flavor and spice. Other benefits included contributing a velvety appearance. Formulation highlights included: 32% reduction in added sugar; 20% reduction in added salt; 33% increase in calcium; 9.5% reduction in calories; 9% reduction in carbohydrate; added fiber. (see also FIG. 31B).

### Flavor Enhancement

A study revealed that adding the puree to a plant-based burger patty resulted in a 2:1 preference over the standard patty and significantly improved the taste, profile, texture and appearance. A 2:1 preference was demonstrated.

### Off-Note Elimination

The polyphenols in the red grape puree are generally hydrophilic. By incorporating the purée or powder upstream with the addition of water, polyphenols become easier to absorb. Base proteins are positively charged while polyphenols are negatively charged. This causes the polyphenols to bind to the protein compounds creating a reaction which denatures a protein base material to a flavorless substrate, significantly enhancing the flavor of the ingredients added to the formulation after the hydration step. This allows formulators to lower their use of bitter blockers or maskers and presents an opportunity for cost saving.

### Sodium Reduction

In a study carried out using consumer panelists, this indicated that a patty with red grape puree added and sodium reduced (at 40% less sodium) achieved higher results than a full sodium control patty. In other words, addition of the nutrient-rich product (puree form) can provide for a sodium reduction of ˜40%.

### Increasing Sweetness

The puree contains a cocktail of acids with different sensory profiles & the result is a more complex sour than with use of industrial vinegars or citric acids. Fresh fruit and vegetables have a slightly tangy sensation that can disappear with age or cooking. The puree/powder is heavily concentrated with malic, lactic and tartaric acids, which work to bring fruit & vegetable ingredient flavors to the fore. The added sour freshness coupled with the additional Ionized Potassium based ‘Saltiness’ creates a strong and rounded sweetness which differs from artificial sweeteners. Applications tested have matched their controls level of perceived sweetness with sugar reduced by up to 50%.

### Retain Succulence

With a high concentration of functional phenolic compounds, the puree has also been shown to be an effective complementary ingredient for textured protein particularly due to its functionality in terms of water & fat retention. In addition to flavor enhancement, chew and succulence are also important attributes for meat-analogues to capture a meat like, fatty mouthfeel. Added fats escape plant-based products during production and once cooked. Phenolic compounds in the puree have been shown to work effectively for lipid binding & oils. This pulls and holds fats into the substrate to mimic real ground meat which adds to the additional “chew” that the puree brings to the textured protein. This improves texture & mouthfeel.

### Lipid Oxidation Prevention

Polyphenol levels are linked to Antioxidant Capacity. The use of the a red grape puree blend with canola oil & soybean oil has been found to improve the oxidative stability index thereof

Customer Validation. Natural Shelf Life Extension

A particular pâté formulations had a shelf life of 120 days. With the addition a white grape puree blend at a 2% application rate, resulted in the pâté having an increased shelf-life of 185 days with no food safety or quality concerns. There are several aspects of the product that are believed to contribute to shelf-life extension. One of these is the low pH, which generally suppresses oxidative degradation. Secondly, the phenolic compounds have a lot of double bonds in them, which are antioxidant-so the double bonds can be moved into single bonds and absorb the electrons that contribute to oxidation. Thirdly, phenolic compounds bind to protein, which can bind to critical proteins like contaminates-some of the binding sites on the cell surface or critical enzymes-if they have phenolics bound to them then they can stop the micro-organisms from doing their metabolism or from propagating. Thus, they can be antibacterial/antioxidant.

### Microbes

The microbial inoculum used for each fermentation can be a single species or a mixed culture (microbial consortium or microbial community), comprising is two or more bacterial or microbial groups (e.g., yeast and bacteria). In some embodiments, a mixed culture inoculum comprises bacteria, fungi (including yeast). In some embodiments, a mixed culture inoculum comprises one or more strains of yeast (yeast are facultative aerobes, which means they can grow in the presence or the absence of oxygen) and one or more strains of bacteria. In some embodiments, a mixed culture inoculum comprises one or more strains of yeast and one or more strains of bacteria and one or more strains of fungi.

### Acetic Acid Bacteria

The steps of the derivative-conversion require inoculation of microbial formulation, comprising acetic acid bacteria. One skilled in the art of fermentation would know which one(s) to select from the family of family Acetobacteraceae.

Acetic acid bacteria (AAB) are a group of rod-shaped, Gram-negative bacteria which aerobically oxidize sugars, sugar alcohols, or ethanol with the production of acetic acid as the major end nutrient-rich product. This special type of metabolism differentiates them from all other bacteria. The acetic acid bacteria consist of 10 genera in the family Acetobacteraceae, including Acetobacter. Species of Acetobacter include: A. aceti; A. cerevisiae; A. cibinongensis; A. estunensis; A. fabarum; A. farinalis; A. indonesiensis; A. lambici; A. liquefaciens; A. lovaniensis; A. malorum; A. musti; A. nitrogenifigens; A. oeni; A. okinawensis; A. orientalis; A. orleanensis; A. papaya; A. pasteurianus; A. peroxydans; A. persici; A. pomorum; A. senegalensis; A. sicerae; A. suratthaniensis; A. syzygii; A. thailandicus; A. tropicalis; and A. xylinus. Several species of acetic acid bacteria are used in industry for production of certain foods and chemicals.

The strains, which have been identified include: Acidibrevibacterium Acidicaldus Acidiphilium Acidisoma Acidisphaera Acidocella Acidomonas Ameyamaea Asaia Belnapia Commensalibacter Craurococcus Crenalkalicoccus; Dankookia Bombella Caldovatus Gluconacetobacter; Granulibacter Humitalea Elioraea Endobacter Gluconobacter Komagatabacter Komagataeibacter Kozakia Muricoccus Neoasaia Neokomagataea Nguyenibacter Paracraurococcus; Parasaccharibacter. Although a variety of bacteria can produce acetic acid, mostly members of Acetobacter, Gluconacetobacter, and Gluconobacter are used commercially. One skilled in the art would know which one(s) to choose for the fermentation processes depending on the final nutrient-rich product they desire to generate.

### Lactic Acid Bacteria

Lactic acid bacteria (LAB) are an order of gram-positive, acid-tolerant, generally nonsporulating, non-respiring, either rod-shaped (bacilli) or spherical (cocci) bacteria that belong to the order Lactobacillus and share common metabolic and physiological characteristics. Lactic acid bacteria are used in the food industry for a variety of reasons such as the production of cheese and yogurt nutrient-rich products. The genera that comprise the LAB are at its core Lactobacillus, Leuconostoc, Pediococcus, Lactococcus, and Streptococcus, as well as the more peripheral Aerococcus, Carnobacterium, Enterococcus, Oenococcus, Sporolactobacillus, Tetragenococcus, Vagococcus, and Weissella.

### Yeasts

Exemplary yeasts includes, but are not limited to Saccharomyces sp. (for example, from the genus Saccharomyces arboricolus, Saccharomyces eubayanus, Saccharomyces bayanus, Saccharomyces beticus, Saccharomyces cerevisiae, Saccharomyces fermentati, Saccharomyces kudriadzevii, Saccharomyces mikatae, Saccharomyces paradoxus, Saccharomyces pastorianus and Saccharomyces uvarum.), Brettanomyces sp. (Teleomorph Dekkera sp.), Candida (Teleomorphs for different species from several genera including Pichia sp., Metschnikowia sp., Issatchenkia sp., Torulaspora sp. and Kluyveromyces sp.), Kloeckera sp. (Teleomorph Hanseniaspora sp.), Saccharomycodes sp., Schizosaccharomyces sp. Yarrowia sp. (Yarrowia lipolytica) and Zygosaccharomyces sp. One exemplary strain is Saccharomyces cerevisiae, var. diastaticus.

In some embodiments, the yeast cells can be from Saccharomyces sp., Brettanomyces sp., Candida. Kloeckera sp., Saccharomycodes sp., Schizosaccharomyces sp., Yarrowia sp. or Zygosaccharomyces sp. In still embodiments, the yeast cells are selected from the group consisting of Saccharomyces sp., Brettanomyces sp., Candida. Kloeckera sp., Saccharomycodes sp., Schizosaccharomyces sp., Yarrowia sp. and Zygosaccharomyces sp.

In some embodiments, the yeast cells can be a Saccharomyces arboricolus, a Saccharomyces eubayanus, a Saccharomyces bayanus, a Saccharomyces beticus, a Saccharomyces cerevisiae, a Saccharomyces fermentati, a Saccharomyces kudriadzevii, a Saccharomyces mikatae, a Saccharomyces paradoxus, a Saccharomyces pastorianus or Saccharomyces uvarum. In further embodiments, the yeast cells are selected from the group consisting of Saccharomyces arboricolus, Saccharomyces eubayanus, Saccharomyces bayanus, Saccharomyces beticus, Saccharomyces cerevisiae, Saccharomyces fermentati, Saccharomyces kudriadzevii, Saccharomyces mikatae, Saccharomyces paradoxus, Saccharomyces pastorianus and Saccharomyces uvarum. In further embodiments, the yeast cells are a Saccharomyces cerevisiae.

In some embodiments, the yeast cells can be from Dekkera sp. In still embodiments, the yeast cells can be from Pichia sp., Metschnikowia sp., Issatchenkia sp., Torulaspora sp. or Kluyveromyces sp. In yet further embodiments, the yeast cells are selected from the group consisting of Pichia sp., Metschnikowia sp., Issatchenkia sp., Torulaspora sp. and Kluyveromyces sp. In embodiments, the yeast cells can be from Hanseniaspora sp. In further embodiments, the yeast cells can be from Yarrowia sp. In still a further embodiment, the yeast cells can be a Yarrowia lipolytica.

Fungi and/or Fungal Mycelium

Mycelium is the vegetative part of a fungus or fungus-like bacterial colony, consisting of a mass of branching, thread-like hyphae. Mushrooms, the fruit of Mycelium, have been revered for thousands of years by practitioners of traditional Asian medicine. Mycelium is the primary source of the beneficial properties of mushrooms. Classical fungi produce spore-bearing mushrooms and or vegetative mycelium which contain pharmacologically active metabolites including polysaccharides, glycoproteins, enzymes, triterpenes, phenols and sterols.

Fungi are adept at converting raw inputs into a range of components and compositions. Fungi are composed primarily of a cell wall that is constantly being extended at the tips of the hyphae. Unlike the cell wall of a plant, which is composed primarily of cellulose, or the structural component of an animal cell, which relies on collagen, the structural oligosaccharides of the cell wall of fungi relay primarily on chitin. Chitin is already used within multiple industries as a purified substance, including food additives for stabilization, binders in fabrics and adhesives, and medicinal applications.

The fungal mycelium can include fungi from Ascomycota and Zygomycota, including the genera Aspergillus, Fusarium, Neurospora, and Monascus. Other species include edible varieties of Basidiomycota and genera Lentinula. One genus is Neurospora, which is used in food production through solid fermentation. The genus of Neurospora are known for highly efficient biomass production as well as ability to break down complex carbohydrates. For certain species of Neurospora, no known allergies have been detected and no levels of mycotoxins are produced. In addition to monocultures of filamentous fungi, multiple strains can be cultivated at once to tune the protein, amino acid, mineral, texture, and flavor profiles of the final biomass.

In some embodiments, mycelium or spores of a selected fungal strain are added to the pomace, either before and/or after fermentation Base Substance in order improve the characteristics of the final product.

### Lees

In some embodiments, lees are added to support the ethanolic fermentation. The lees (dead yeast cells) can be lysed and used as source of nutrients in the process of the ethanolic fermentation. In this manner, the cellular components of the lees are recycled to become intracellular nutrients for the yeast during the ethanolic fermentation.

### Exogenous Phenolics

In an embodiment, one or more exogenous phenolics are added. These can be derived from one or more sources such as grape phenolic compounds extracted from seeds or skins, other fruit or vegetable phenolic compounds, or phenolic compounds extracted from wood, such as oak or acacia.

### Terminating the Fermentation Process

According to some embodiments, the fermentation process may be terminated when the levels of acetic acid and/lactic acid reach a pre-determined composition within the bioreactor vessel or fermenter. This can be accomplished by sealing the vessel in a manner such that no oxygen can enter the bioreactor vessel. In some embodiments, the process is terminated by additionally sparging with nitrogen, argon, carbon dioxide or a combination thereof.

### The Processing Container

The processing container is generally used herein to refer to a container or containers where the fermentation processes are carried out (also sometimes referred to as a bioreactor). In the commercial-scale process, where the processing and fermentation process are centralized at a processing facility, this refers to the large-scale fermentation tanks (or fermenters) where the ethanolic fermentation step and the acetic acid fermentation step are carried out.

According to some embodiments, however, the fermentation process may be carried out at least partially outside of the processing facility (e.g. at a winery or in the filed), instead of having the fermentation process centralized at the processing facility; in that context, processing container or transportable processing container is used to refer to the container(s) where such fermentation is carried out.

According to some embodiments, the design of a processing container should be designed such that it conforms to the minimal requirements for the food safety and quality regulations of the jurisdictions in which the ultimate products will be directly and/or indirectly sold (e.g., as a foodstuff, health supplement, and/or a food ingredient). For example, the system is designed such that mold and other microbial contamination does not infiltrate the system and cause toxic substances such as mycotoxins and microbial volatile organic compounds (mVOC's) to contaminate the ultimate products of the system. For example, when constructing the system and incorporating various elements therein attention needs to be provided to all aspects, especially those surfaces which are hard to clean, for example, weld joints, which are somewhat rough and sometimes may even have excessive pitting, resulting in a portion of the weld joint which is very hard to clean. Soil and other impurities get trapped in this area and attract microbial growth. This can become a huge problem if not taken care of in the early stage of the microbial growth. Thus, even the welding of the container need follow the standards for the practice known as sanitary welding, as provided for by example, the American Welding Society (AWS).

In general, food processing operations and retailers must comply with the various Hazard Analysis Critical Control Point (HACCP) sanitary standards and regulations promulgated by various state and local Health Departments. Food processing operations are certified by a third-party agency who will list the sampling points and provide safety certification. Examples of certifications comprise Good Manufacturing Practices (GMP), HACCP or the International Standards Organization (ISO).

The design and construction of the processing container could follow the recommendations of 3-A Sanitary Standards, Inc. This organization maintains a large inventory of design criteria for equipment and processing systems developed for the so-called sanitary market using a modern consensus process based on ANSI requirements to promote acceptance by USDA. FDA and state regulatory authorities. One example pertains to sanitary rotary positive displacement pump types, which are designed with certain common characteristics to facilitate sanitation. Among these are an ability to rapidly tear down or open the fluid flow pathway of the pump for easy and thorough inspection and cleaning, often without the need for tools; the extensive use of stainless steels to assure non-contaminating and non-corroding liquid pumpage contact surfaces; the use of simple sanitary seal structures; the minimization or elimination of areas within the interior of the pump which could cause contamination of the pumpage; low RPM operation for gentle liquid handling; ability to operate at elevated temperatures; an ability to pump liquids ranging from very low viscosity to very high viscosity; and conformance to generally recognized sanitary standards, particularly the Standards For Centrifugal and Positive Rotary Pumps For Milk and Milk Products, 02-09, as promulgated in the US by the 3-A Sanitary Standards Symbol Administrative Council. This standard applies not only to dairy uses but also is the de facto standard for most sanitary pump uses.

Batch and/or Fed-Batch Processing Container

In some embodiments, the processing container is configured for batch and/or fed-batch fermentation and processing of pomace. This system is designed to centralize the processing of the fruit biomass in a processing facility. Food-grade transport containers are used to collect the pomace and transport it to a centralized facility, where the pomace can be ground/macerated by a large colloid mill and/or a mill designed to remove fruit pits, skin, etc.) and blended with the other sources of pomace. In some instances, it may be favorable to conduct an initial anaerobic fermentation & collect the ethanol generated. Sophisticated monitoring equipment with probes inserted into the biomass can be used to measure the actual biochemistry of the fermentation.

In a central fed-batch processing facility the fermentation can be initiated with a partial fill of a large processing container. Additional pomace can be added to the process at any time within the fermentation cycle within the limits of handling and transporting pomace to the central processing facility, up to the maximum batch size for the fermenter.

### Retrofit Industrial Fermenters for Off-Season Use

In some embodiments, the system is designed to utilize the fermenters of the wineries during the off-season. The system will include transport containers to collect and store the pomace while the winery is conducting their crush and fermentation, in addition to devices that can be used to adapt the winery fermenters into a processing container 418 in order to conduct the appropriate fermentation for this bioconversion process.

### Transport Container

According to embodiments, a transport container may be constructed from a strong, sturdy material, so that it can withstand being lifted by a forklift multiple times. In an embodiment, a transport container will be made of stainless steel. In an embodiment, a transport container is made of HDPE. An embodiment of a transport container will be water tight, with no drain and a removable lid that exposes the complete contents.

### The Vinegar Fermenter

In some embodiments, it is contemplated that the acetic acid fermentation step may be carried out using a vinegar fermenter. These types of fermenters are commercially available, and are designed to facilitate the aerobic acetic acid fermentation that is to be carried out.

### Large-Scale Red Wine Fermentation Tanks

It is also contemplated that the acetic acid fermentation step may be carried out using a red wine fermenter/fermentation tank. It is contemplated that these may be well suited for large, commercial scale processing. A red wine fermenter typically has an angled floor and a door, where the pomace can be easily removed. Most such fermenters are custom made, and can be made as big as desired. Commercial scale tanks can go up to 100,000 liters or more. These can be sourced from companies such as Speidel and Prospero.

Red wine fermenters handle solids very well because they have racking valves, which remove the liquid-many of them are screened, so that you can remove the liquid without having to deal with a lot of solid. Once the liquid has been removed, there is a large door which opens outward, as opposed to most fermenters, where the door opens inward. The door that opens outward has a steeply sloping floor, which enables easy handling of the solids—so it can be removed to a conveyor—or whatever else you want to handle it, once the fermentation is complete.

Typically, in wine production, a red wine fermentation tank will be filled to 75% of capacity. The tank will then be inoculated by adding yeast to the surface. For the population to expand, it requires oxygen to grow. Once that has happened, the yeast will start to move downward through the material, just by gravity. The yeast releases heat and CO₂, so after the fermentation has started, convection currents will have formed.

In adapting such vinegar fermenters or red wine fermenters for use in the acetic acid fermentation step of the present process, the pomace slurry may optionally be pumped out from the bottom to the top in order to get the yeast to disburse.

The temperature would also be tightly controlled. Glycol jackets around the tank could used and a cooling solution could be pumped through the jacket to control the temperature. The fermentation would be sampled regularly.

Agitation of the pomace slurry will be provided by aeration, via the currents of the air moving through the slurry. If more agitation is desired, this can be done by pump-over, in which the material from the bottom of the fermenter is pumped into the top of the tank via a drain valve. Another option is to use an agitator, such as a Guthe Agitator.

The fermentation process can be stopped by ceasing the aeration, once all the ethanol has been depleted. Optionally, the fermentation process could be stopped by purging it with an inert gas.

### EXAMPLES

### Example I: Food Ingredient in Chocolate

In some embodiments, in order to demonstrate the powder product's impact upon sweetness in chocolate, three types of chocolate bars are created and then tested in a blind sensory panel test. Chocolate bars are prepared with the usual amount of sugar, which serves as the control. Reduced sugar bars are made using 30%-35% less sugar. The sweetness-enhanced bars are prepared with 35% less sugar and 0.3% powder product.

In some embodiments, 100% cocoa wafers are indirectly heated. For example, a pot of water is brought to a simmer at a medium to low temperature and a cage is placed over the pot. The cocoa wafers are placed in a steel bowl, which is placed over the cage to gently melt the cocoa wafers with stirring into a smooth chocolate liquor (a liquid state). Add the dry ingredients are added to a bowl and blended. This chocolate liquor is poured into a chocolate melanger and allowed to refine for 30 min. The dried ingredients (e.g. sugar, milk powder & optionally the powdered product) are added in small increments to ensure a good consistency and temperature is maintained before adding the next increment. The mixture is refined until the smooth texture, consistency and flavor are attained (for example, up to 8-12 hours). Once this process is complete, the mixture is poured into a silicon molds and allowed to temper to reform solid chocolate bars. This process is then repeated with 35% less sugar and again with 30%-35% less sugar with adding 0.3% powdered product.

For example, the control bars can be prepared using 130 g 100% cocoa wafers, 60 g sucrose and 10 g milk powder. For example, the 30% reduced sugar bar can be prepared using 130 g 100% cocoa wafers, 23 g sucrose and 10 g milk powder. For example, the sweetness-enhanced bars can be prepared using 130 g 100% cocoa wafers, 23 g sucrose, 10 g milk powder and 0.5 g powder product.

The sensory panel will select a score for the levels of sweetness for each of the three test bars. The control bars usually score quite high, the reduced sugar sample generally scores lower and the sweetness-enhanced bars generally score similar to the control bar.

A chocolate melanger is a machine, which comprises a drum, rotating stones and a granite grinding surface and is used to grind and refine chocolate ingredients to create a smooth texture and to achieve a desirable consistency and flavor.

In embodiments, where cocoa nibs are used, the stones within the chocolate melanger will crush the cocoa nibs, gradually transforming them into a chocolate liquor. Crushing the nibs in this manner helps release cocoa butter from the cells, contributing to the smoothness and richness of the final chocolate.

In some embodiments, adding the powder product to a higher percent dark chocolate will provide the ability to achieve the sweetness available in lower percent dark chocolate, without sacrificing the flavor for a higher cacao chocolate.

In some embodiments, a chocolate spread can be prepared with a 30% reduction in added sugar provided by a puree product. For example, 40 g of water, 67 g of sugar, 14 g of cocoa powder, 0.2 g salt, 75 g bittersweet chocolate, 95 g unsalted butter can be used to prepare a control sample. For example, 40 g of water, 47 g of sugar, 14 g of cocoa powder, 0.2 g salt, 75 g bittersweet chocolate, 95 g unsalted butter and 5.4 grams puree product can be used to prepare a chocolate spread with 30% reduction of sugar, but maintain the equivalent sweetness as the control sample. The ingredients will be weighed separately. The water, salt, sugar and cocoa powder will be added to a saucepan and cooked on medium heat until it simmers. Bittersweet chocolate and butter will be added. The container will be removed from the heat and whisked until a smooth consistency has been attained. The contents are then transferred into a container, which is placed in a refrigerator to set.

In some embodiments, chocolate bars can be formulated wherein the concentration of sugar ranges from 45% to 49% and the concentration of fat ranges from 20% to 26%. The ingredients are refined in a melanger for 24 hours. When 0.3% of the powder product was used, the chocolate bar exhibited a 33.6% reduction of added sugar and when 0.45% of the powder product was used, the chocolate bar exhibited a 50% reduction in sugar.

In some embodiments the puree product can be added to the ganache portion of a confectionary and thereby reduce the amount of added sugar by at least 30% to 100%. For example, a ganache may include a flavor such as a fruit component, chocolate, cream, sugar, other flavorings, etc. In some embodiments, the puree product can be added to a component such as the cream, which would then be added to the mixture. In some embodiments, the puree product can be added directly to the other ingredients and then subjected to the usual processing techniques (e.g., heating, emulsification) for that ganache formulation.

The puree product and/or the powder product can be used in deserts such as cheesecake to lower the amount of sugar added in addition to increasing the creaminess of the texture.

In some embodiments, the puree product and/or the powder product can increase the creaminess of the chocolate and or the ganache portion of the confectionary. Without being bound by any theory, it is proposed that one of the functional aspects of the products is that some of the compounds in the products binds to some of the fats and creates additional binding between the components of the mixture, thereby enhancing the creaminess of the food. In some embodiments, one or more of the phenolic acids binds to one or more of the fat compounds, thereby enhancing the mouthfeel and/or the creaminess of the food to which it is added.

### Example II: Cross-Functional Food Ingredient

In some embodiments the puree product and/or the powder product act as a multi-functional food ingredient that lowers the amount of salt required, mask bitter off notes and off-favors from some of the components, enhance flavors and spices, enrich the nutritional value with some of the phytonutrients, enhance the texture and mouthfeel, enhance the creaminess and increase the shelf-life of the food to which it is added, etc.

According to embodiments, the puree product and/or the powder product demonstrate multiple cross-functional capabilities, which are exhibited to differing degrees in the food into which they are incorporated. For example, in some embodiments the puree product and or the powder product demonstrates the capability of:
Significant added sugar reduction by 50%+
Substantial calorie reduction
Sodium reduction by as much as 80%.
Flavor enhancement
Moisture & lipid binding.
Lipid oxidation prevention
Natural shelf-life extension by 55%+
Effective masking of bitter notes and off flavors (e.g., pea protein).
Improved texture and mouthfeel
Cost savings dependent on application
Enriched nutritional value with phytonutrients and antioxidants
Labelled simply as “grape puree,” and/or “grape powder”

In some embodiments, the puree product and/or the powder product can lower the amount of added sugar.

In some embodiments, the puree product and/or the powder product can lower the amount of salt added to the food product to which it is added.

In some embodiments, the puree product and/or the powder product can de-bitter some of the components in the chocolate and/or other food product to which it is added.

In some embodiments, the puree product and/or the powder product can increase the shelf-life of the food to which it is added.

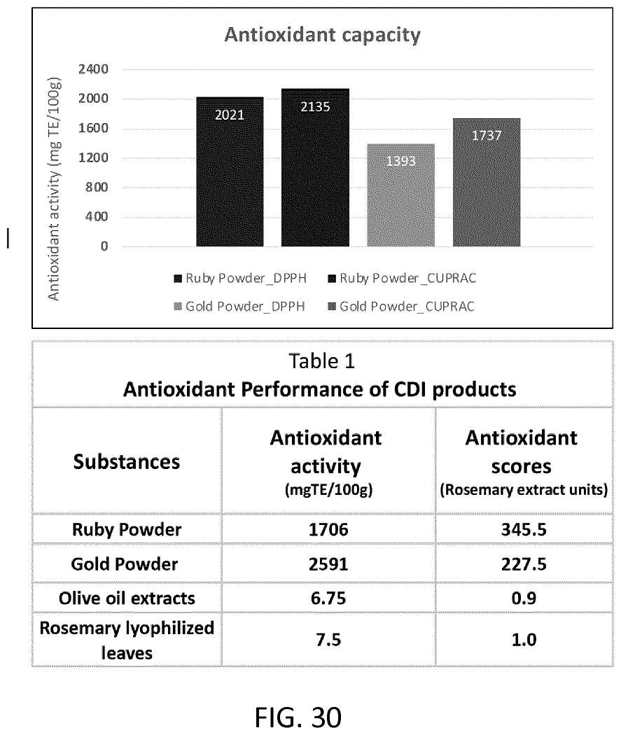

In some embodiments, the puree product and/or the powder product demonstrates the ability to function as a natural food ingredient effecting the shelf-life extension of the food to which it is added. When compared with the industry standard natural preservatives, (see FIG. 30) rosemary, olive oil and thyme extracts, the puree product and/or the powder product far exceeded the capabilities of the natural preservatives.

In some embodiments, when puree product and/or the powder product was added to a plant-based burger patty, taste sensory evaluations demonstrated that the burger patties with the food ingredient resulted in a 2:1 preference over the standard patty and dramatically improved the taste, profile, texture and appearance.

In some embodiments, the puree product and/or the powder product demonstrated the ability to eliminate off-notes in the foods to which they were added. This ability allowed food formulators to lower their use of bitter flavor blockers or maskers, presenting an opportunity for cost savings. Without being bound to any theory, the polyphenols in the puree product and/or the powder product are hydrophilic. By incorporating the puree product and/or the powder product upstream with the addition of water, the polyphenols become easier to absorb. Base proteins are positively charged while polyphenols are negatively charged. These charge differences cause the polyphenols to bind to the protein compounds creating a reaction which denatures a protein base material to a flavorless substrate, significantly enhancing the flavor of the ingredients added to the formulation after the hydration step.

In some embodiments, the puree product and/or the powder product demonstrated the ability to reduce added sodium by at least 40%. For example, when the puree product and/or the powder product was added to a hamburger patty, taste sensory tests demonstrated higher scores for the patty that incorporated the puree product and/or the powder product over the full-sodium control patty.

In some embodiments, the puree product and/or the powder product demonstrated the ability to increase the levels of perceived sweetness in food by up to 50% when compared to controls. For example, the puree contains a number of acids with different sensory profiles & the result is a more complex sour than with use of industrial vinegars or citric acids. Fresh fruit and vegetables have a slightly tangy sensation that can disappear with age or cooking. The puree product and/or the powder product is highly concentrated with malic, lactic and tartaric acids, which function to enhance fruit & vegetable ingredient flavors. The added sour freshness coupled with the additional ionized potassium based ‘saltiness’ creates a strong, wholesome and rounded sweetness which can't be obtained from artificial sweeteners.

In some embodiments, the puree product and/or the powder product demonstrates the ability to retain succulence in the food to which it has been added. With a high concentration of functional phenolic compounds, the puree product and/or the powder product has proven to be an effective complimentary ingredient for textured protein particularly due to its functionality in terms of water & fat retention. For example, in addition to flavor enhancement, chew and succulence are important attributes for meat-analogues to capture a meat like, fatty mouthfeel. Added fats escape plant-based products during production and when cooked.

Phenolic compounds in the puree product and/or the powder product have worked effectively for lipid binding & oils. The puree product and/or the powder product pulls and holds fats into the substrate to mimic real ground meat which adds to the additional chew the puree product and/or the powder product brings to the textured protein, which improves texture & mouthfeel. In particular, the puree product and/or the powder product has demonstrated improvements to the oxidative stability index for canola oil and soybean oil with the puree product and/or the powder product.

In some embodiments, sensory evaluations have demonstrated that the puree product and/or the powder product, a natural product, exhibits at least a 55% increase in self-life extension. For example, in pâté formulations incorporating the puree product and/or the powder product demonstrated a shelf life of 120 days. With the addition puree at a 2% application rate, another pâté was able to hold a shelf-life of 185 days with no food safety or quality concerns. Without being bound by any theory, the acetic/lactic are weak acids used as preservative for food. because they inhibit growth of microorganisms.

In some embodiments, the puree product and/or the powder product demonstrates increased bioavailability of the polyphenols due to the fermentation process. For example, the amount of quercetin is elevated. Polyphenols in plants are normally bound with other compounds, so they are not in the optimal condition to be used by the body. The fermentation process breaks these connections allowing them to be released, so they can be easily absorbed. Another effect of the fermentation process is to increase the polyphenolics ability to react with free radicals and microbials. The fermentation process also generates the weak acid profile, which is important for the flavor and preservation of the foods to which the puree product and/or the power product are added.

TABLE 1
DEMONSTRATED FUNCTIONALITY

| Application | Product | Dosage | Impact |
|---|---|---|---|
| Chocolate | Powder | 0.30% | Sugar reduction, |
| | | | bitter reduction, |
| | | | flavor enhancement, |
| | | | mouthfeel/creaminess |
| Chocolate | Puree | 3.00% | Sugar reduction, |
| Spread | | | bitter reduction, |
| | | | flavor enhancement, |
| | | | mouthfeel/creaminess |
| BBQ Sauce | Powder/Puree | .16%/1.6% | Sodium reduction, |
| | | | sugar reduction, |
| | | | flavor enhancement |
| Ketchup | Powder/Puree | .16%/1.6% | Sodium reduction, |
| | | | sugar reduction, |
| | | | flavor enhancement |
| Meat | Powder/Puree | .3%/3% | Sodium Reduction, |
| Analog | | | sugar reduction, |
| | | | flavor enhancement, |
| | | | bitter/green note |
| | | | (plant-based protein) |
| | | | reduction |
| Baked | Powder/Puree | .3%/3% | Sodium reduction, |
| Beans | | | sugar reduction, |
| | | | flavor enhancement |
| Sports | Powder | 0.30% | Sweetness enhancement, |
| Nutrition | | | bitter reduction, |
| | | | flavor enhancement, |
| | | | antioxidant contribution |
| Juice | Powder/Puree | .3%/3% | Sweetness enhancement, |
| Concentrates | | | bitter reduction, |
| | | | flavor enhancement, |
| Beverages | Puree | TBD | Sugar reduction, |
| | Extraction | | bitter reduction, |
| | | | flavor enhancement, |
| | | | mouthfeel/creaminess |

1. A process for converting pomace derived from fruit wine production into a nutrient-rich food product, comprising the steps of:
(a) receiving the pomace at a processing facility;
(b) milling the pomace to generate a milled pomace;
(c) transferring the milled pomace into an anaerobic fermenter;
(d) inoculating the milled pomace with yeast and optionally, making compositional adjustment for fermentable sugars and nutrients, to generate an inoculated milled pomace;
(e) carrying out an ethanolic fermentation step in the anaerobic fermenter by fermenting sugars in the inoculated milled pomace under anaerobic conditions into ethanol to generate an ethanolic pomace;
(f) transferring the ethanolic pomace into an aerobic fermenter;
(g) inoculating the ethanolic pomace with acetic acid bacteria, and optionally, making a compositional adjustment, to generate an inoculated ethanolic pomace;
(h) carrying out an acetic acid fermentation step in the aerobic fermenter by fermenting the inoculated ethanolic pomace under aerobic conditions into acetic acid to generate an acetic acid pomace;
(i) shearing the acetic acid pomace to generate a raw puree; and
(j) stabilizing the raw puree by subjecting the raw puree to a thermal or a non-thermal stabilization step to generate a stabilized raw puree.

2. The process of claim 1, additionally comprising the step of: following the step of stabilizing the raw puree, applying a wet processing step, comprising:
fine grinding the stabilized raw puree according to desired specifications in order to generate a puree product.

3. The process of claim 1, additionally comprising the step of: following the step of stabilizing the raw puree, applying a dry processing step, comprising:
fine grinding the stabilized raw puree according to desired specifications; and
drying the stabilized raw puree to a desired specification in order to generate a powder product.

4. The process of claim 2 or 3, wherein the step of fine grinding involves grinding the stabilized raw puree to a particle size where 94%-100% of the particles of the stabilized raw puree pass through an 80-mesh screen.

5. The process of claim 3, wherein the step of drying the stabilized raw puree is done by one or more of: freeze drying; spray drying; microwave vacuum drying; and
immobilization onto a solid substrate.

6. The process of claim 1, wherein the fruit wine is any one or more selected from the group consisting of: (grape wine; red wine; white wine; rose wine; champagne-style wine; sparkling wine; fortified wine; port; brandy; fruit wines; ciders; perry; and fruit brandy), and wherein the fruit may be any one or more of: (grapes; berries; blackberry; elderberry; strawberry; blueberry; raspberry; red currant; black currant; white currant; cranberry; mulberry; seaberry; apples; pears; cherries; plums; pineapples; rose hips; lychee; bananas cantaloupe; watermelon; mango; pumpkins, pomegranates, pumpkin and honeydew).

7. A process for extracting polyphenol compounds from pomace derived from fruit wine production, and incorporating such polyphenol compounds into a nutrient-rich food product, comprising:
(a) receiving the pomace at a processing facility;
(b) milling the pomace to generate a milled pomace;
(c) transferring the milled pomace into an anaerobic fermenter;
(d) inoculating the milled pomace with yeast and optionally, making compositional adjustment for fermentable sugars and nutrients, to generate an inoculated milled pomace;
(e) carrying out an ethanolic fermentation step in the anaerobic fermenter by fermenting sugars in the inoculated milled pomace under anaerobic conditions into ethanol to generate an ethanolic pomace;
(f) transferring the ethanolic pomace into an aerobic fermenter;
(g) inoculating the ethanolic pomace with acetic acid bacteria, and optionally, making a compositional adjustment, to generate an inoculated ethanolic pomace;
(h) carrying out an acetic acid fermentation step in the aerobic fermenter by fermenting the inoculated ethanolic pomace under aerobic conditions into acetic acid to generate an acetic acid pomace;
(i) shearing the acetic acid pomace to generate a raw puree; and
(j) stabilizing the raw puree by subjecting the raw puree to a thermal or a non-thermal stabilization step to generate a stabilized raw puree.

8. The process of claim 7, additionally comprising the step of: following the step of stabilizing the raw puree, applying a wet processing step, comprising:
fine grinding the stabilized raw puree according to desired specifications in order to generate a puree product.

9. The process of claim 7, additionally comprising the step of: following the step of stabilizing the raw puree, applying a dry processing step, comprising:
fine grinding the stabilized raw puree according to desired specifications; and
drying the stabilized raw puree to a desired specification in order to generate a powder product.

10. The process of claim 1, additionally comprising the step of: before step (a), delivering a transport container to a winery to collect the pomace and transport the pomace to the processing facility.

11. The process of claim 1, additionally comprising the step of: following step (a), washing the pomace until the pomace is rendered Kosher.

12. The process of claim 10, wherein the pomace is handled and processed at each step such that the nutrient-rich product qualifies for Kosher certification.

13. The process of claim 1, additionally comprising the step of, following step (c) and before step (d): blending the milled pomace with milled pomace from other varietals.

14. The process of claim 1, additionally comprising the step of, following step (f) and before step (g): blending the ethanolic pomace with ethanolic pomace from other varietals.

15. The process of claim 1, wherein at step (h), the acetic acid fermentation is carried out until the acetic acid pomace reaches a titratable acidity of 2.2%-5%.

16. A nutrient-rich food product produced by the process of any one of claims 1-15.

17. Use of the nutrient-rich food product of claim 16 as a natural flavour, texture and/or colour enhancer in food products.

18. Use of the nutrient-rich food product of claim 16 as a flavour enhancer in chocolate or other confectionery products, in order to allow for sugar reduction in recipes.

19. Use of the nutrient-rich food product of claim 16 as an ingredient for masking bitter flavours or off-notes in food products.

20. Use of the nutrient-rich food product of claim 16 as a preservative for meats, condiments, dairy products, cereal products or other foods.

21. Use of the nutrient-rich food product of claim 16 as an ingredient for fortifying processed foods.

22. Use of the nutrient-rich food product of claim 16 as an ingredient in food products, as a source of antioxidants.

23. A nutrient-rich product derived from processing pomace derived from fruit wine production, for use as a ingredient in a food product, wherein the nutrient-rich product is in the form of a puree or a powder, and wherein incorporating the nutrient-rich product in the amount of less than 5% by weight to the food product provides a plurality of cross-functional benefits in the food product selected from: flavor enhancement; masking of bitterness or off-notes; significant sodium reduction; significant sugar reduction; moisture and lipid binding; improved texture or mouthfeel; lipid oxidation prevention; and shelf-life extension.

24. A puree product and/or powder product, derived from the fermentation of pomace that is derived from fruit wine production, the puree and/or powder product, when incorporated into a food product, demonstrating one or more capabilities in a food product to which it is added, selected from the list of: reducing the amount of added sugar in the range of 30%-100%; providing a deeper level of sweetness, which also enhances confectionary related flavors in confectionary products; reducing sodium in the range of 20%-50%; extending the shelf-life extension by in the range of 20%-55%; enhancing the spices, umami flavor, and rounding of flavors; reducing the caloric content; binding the lipid and moisture content; reducing and/or preventing lipid oxidation; masking of bitter notes and off flavors on the order of 30%; improving the texture and mouthfeel; and enriching the nutritional value with phytonutrients and/or antioxidants.
